(19) United States
(12) Patent Application Publication
(10) Pub. No.: US 2023/0300815 A1
(43) Pub. Date: Sep. 21, 2023

(54) METHOD AND APPARATUS OF HANDLING SIDELINK FEEDBACK TRANSMISSION IN MULTIPLE CARRIERS IN A WIRELESS COMMUNICATION SYSTEM

(71) Applicant: ASUSTek Computer Inc., Taipei City (TW)

(72) Inventors: Ming-Che Li, Taipei City (TW); Chun-Wei Huang, Taipei City (TW)

(21) Appl. No.: 18/122,754

(22) Filed: Mar. 17, 2023

Related U.S. Application Data
(60) Provisional application No. 63/321,451, filed on Mar. 18, 2022.

(51) Int. Cl. H04W 72/044; H04W 72/40

(52) U.S. Cl. CPC H04W 72/0473; H04W 72/40

(57) ABSTRACT

A method and apparatus are disclosed. In an example from the perspective of a device configured with a set of carriers and/or cells including a first carrier and/or a first cell, the device determines a limited power value based on a maximum transmit power and a number of a set of sidelink feedback transmissions on the set of carriers and/or cells in a transmission time interval (TTI) and/or an occasion. The device determines a first power value based on a first downlink (DL) pathloss in the first carrier and/or the first cell. The device determines a first sidelink transmit power of a first sidelink feedback transmission based on the limited power value and the first power value. The set of sidelink feedback transmissions includes the first sidelink feedback transmission. The device performs the first sidelink feedback transmission, on the first carrier and/or the first cell, based on the first sidelink transmit power.

### CROSS-REFERENCE TO RELATED APPLICATIONS

The present application claims the benefit of U.S. Provisional Patent Application Ser. No. 63/321,451 filed on Mar. 18, 2022, the entire disclosure of which is incorporated herein in its entirety by reference.

### FIELD

This disclosure generally relates to wireless communication networks, and more particularly, to a method and apparatus of handling sidelink feedback transmission in multiple carriers in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

In accordance with the present disclosure, one or more devices and/or methods are provided. In an example from the perspective of a device configured with a set of carriers and/or cells comprising a first carrier and/or a first cell, the device determines a limited power value based on a maximum transmit power and a number of a set of sidelink feedback transmissions on the set of carriers and/or cells in a transmission time interval (TTI) and/or an occasion. The device determines a first power value based on a first downlink (DL) pathloss in the first carrier and/or the first cell. The device determines a first sidelink transmit power of a first sidelink feedback transmission based on the limited power value and the first power value. The set of sidelink feedback transmissions comprises the first sidelink feedback transmission. The device performs the first sidelink feedback transmission, on the first carrier and/or the first cell, based on the first sidelink transmit power.

In an example from the perspective of a device configured with a set of carriers and/or cells comprising a first carrier and/or a first cell, the device determines a set of sidelink feedback transmissions on the set of carriers and/or cells in a transmission time interval (TTI) and/or an occasion. The device determines a first power budget for at least one of the first carrier or the first cell. The device determines a first power value based on a first downlink (DL) pathloss in at least one of the first carrier or the first cell. The device determines a first sidelink transmit power of a first sidelink feedback transmission based on the first power budget and the first power value. The set of sidelink feedback transmissions comprises the first sidelink feedback transmission. The device performs the first sidelink feedback transmission, on at least one of the first carrier or the first cell, based on the first sidelink transmit power.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a diagram illustrating an exemplary scenario associated with Physical Sidelink Shared Channel (PSSCH) transmissions according to one exemplary embodiment.

FIG. 6 is a diagram illustrating an exemplary scenario associated with a UE having one or more sidelink feedback channels to be transmitted on one or more carriers and/or cells according to one exemplary embodiment.

FIG. 7 is a flow chart according to one exemplary embodiment.

FIG. 8 is a flow chart according to one exemplary embodiment.

FIG. 9 is a flow chart according to one exemplary embodiment.

FIG. 10 is a flow chart according to one exemplary embodiment.

FIG. 11 is a flow chart according to one exemplary embodiment.

FIG. 12 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3rd Generation Partnership Project (3GPP) LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio) wireless access for 5G, or some other modulation techniques.

In particular, the exemplary wireless communication systems devices described below may be designed to support one or more standards such as the standard offered by a consortium named “3rd Generation Partnership Project” referred to herein as 3GPP, including: 3GPP TS 38.214 V17.0.0 (2021 December), “3GPP TSG RAN; NR Physical layer procedures for data (Release 17)”; 3GPP TS 38.213 V17.0.0 (2021 December), “3GPP TSG RAN; NR Physical layer procedures for control (Release 17)”; 3GPP TS 38.212 V17.0.0 (2021 December), “3GPP TSG RAN; NR Multiplexing and channel coding (Release 17)”; 3GPP TS 38.211 V17.0.0 (2021 December), “3GPP TSG RAN; NR Physical channels and modulation (Release 17)”; 3GPP TS 38.331 V16.7.0 (2021 December), “3GPP TSG RAN; NR Radio Resource Control (RRC) protocol specification (Release 16)”; R1-2108692, Final Report of 3GPP TSG RAN WG1 #106-e v1.0.0 (Online meeting, 16-27 Aug. 2021); R1-2110751, Final Report of 3GPP TSG RAN WG1 #106bis-e v1.0.0 (Online meeting, 11-19 Oct. 2021); R1-2200002, Final Report of 3GPP TSG RAN WG1 #107-e v1.0.0 (Online meeting, 11-19 Nov. 2021); Draft Report of 3GPP TSG RAN WG1 #107bis-e v0.2.0 (Online meeting, 17-25 Jan. 2022); RP-213678, “New WID on NR sidelink evolution”. The standards and documents listed above are hereby expressly incorporated by reference in their entirety.

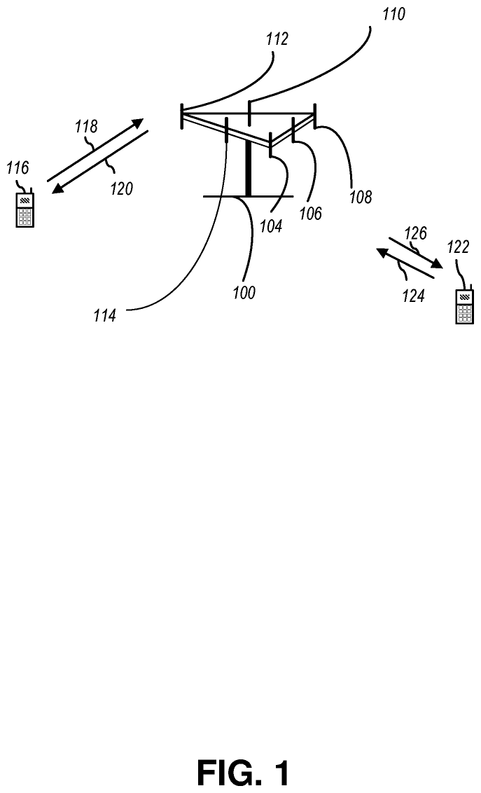

FIG. 1 presents a multiple access wireless communication system in accordance with one or more embodiments of the disclosure. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. AT 122 is in communication with antennas 106 and 108, where antennas 106 and 108 transmit information to AT 122 over forward link 126 and receive information from AT 122 over reverse link 124. In a frequency-division duplexing (FDD) system, communication links 118, 120, 124 and 126 may use different frequencies for communication. For example, forward link 120 may use a different frequency than that used by reverse link 118.

Each group of antennas and/or the area in which they are designed to communicate is often referred to as a sector of the access network. In the embodiment, antenna groups each may be designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage may normally cause less interference to access terminals in neighboring cells than an access network transmitting through a single antenna to its access terminals.

An access network (AN) may be a fixed station or base station used for communicating with the terminals and may also be referred to as an access point, a Node B, a base station, an enhanced base station, an eNodeB (eNB), a Next Generation NodeB (gNB), or some other terminology. An access terminal (AT) may also be called user equipment (UE), a wireless communication device, terminal, access terminal or some other terminology.

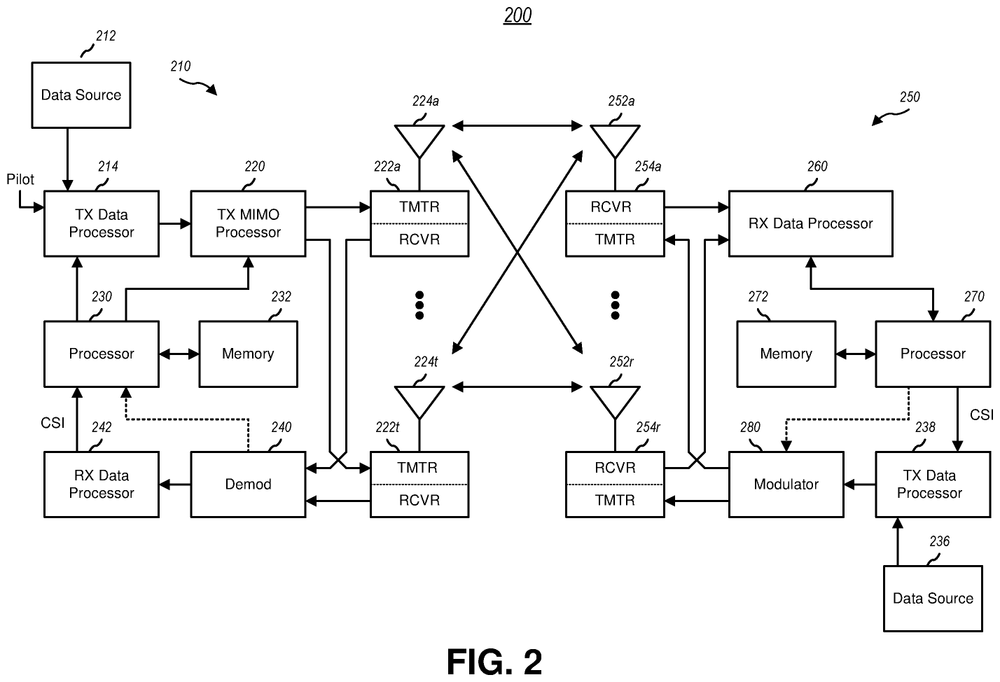

FIG. 2 presents an embodiment of a transmitter system 210 (also known as the access network) and a receiver system 250 (also known as access terminal (AT) or user equipment (UE)) in a multiple-input and multiple-output (MIMO) system 200. At the transmitter system 210, traffic data for a number of data streams may be provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using orthogonal frequency-division multiplexing (OFDM) techniques. The pilot data may typically be a known data pattern that is processed in a known manner and may be used at the receiver system to estimate the channel response. The multiplexed pilot and coded data for each data stream may then be modulated (i.e., symbol mapped) based on a particular modulation scheme (e.g., binary phase shift keying (BPSK), quadrature phase shift keying (QPSK), M-ary phase shift keying (M-PSK), or M-ary quadrature amplitude modulation (M-QAM)) selected for that data stream to provide modulation symbols. The data rate, coding, and/or modulation for each data stream may be determined by instructions performed by processor 230.

The modulation symbols for data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 may apply beamforming weights to the symbols of the data streams and to the antenna from which the symbol is being transmitted.

Each transmitter 222 receives and processes a respective symbol stream to provide one or more analog signals, and further conditions (e.g., amplifies, filters, and/or upconverts) the analog signals to provide a modulated signal suitable for transmission over the MIMO channel. N_{T} modulated signals from transmitters 222a through 222t may then be transmitted from N_{T} antennas 224a through 224t, respectively.

At receiver system 250, the transmitted modulated signals are received by NR antennas 252a through 252r and the received signal from each antenna 252 may be provided to a respective receiver (RCVR) 254a through 254r. Each receiver 254 may condition (e.g., filters, amplifies, and downconverts) a respective received signal, digitize the conditioned signal to provide samples, and/or further process the samples to provide a corresponding “received” symbol stream.

An RX data processor 260 then receives and/or processes the NR received symbol streams from NR receivers 254 based on a particular receiver processing technique to provide N_{T} “detected” symbol streams. The RX data processor 260 may then demodulate, deinterleave, and/or decode each detected symbol stream to recover the traffic data for the data stream. The processing by RX data processor 260 may be complementary to that performed by TX MIMO processor 220 and TX data processor 214 at transmitter system 210.

A processor 270 may periodically determine which pre-coding matrix to use (discussed below). Processor 270 formulates a reverse link message comprising a matrix index portion and a rank value portion.

The reverse link message may comprise various types of information regarding the communication link and/or the received data stream. The reverse link message may then be processed by a TX data processor 238, which may also receive traffic data for a number of data streams from a data source 236, modulated by a modulator 280, conditioned by transmitters 254a through 254r, and/or transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 may then determine which pre-coding matrix to use for determining the beamforming weights and may then process the extracted message.

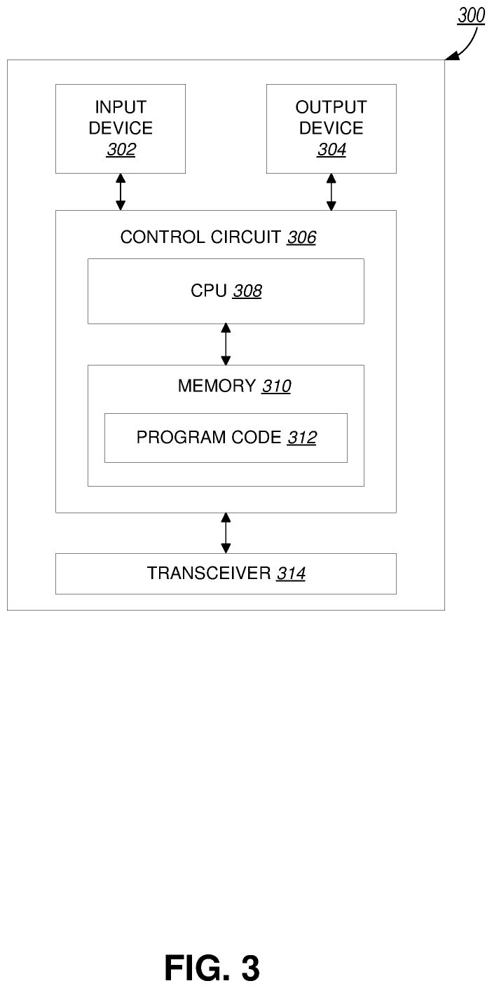

FIG. 3 presents an alternative simplified functional block diagram of a communication device according to one embodiment of the disclosed subject matter. As shown in FIG. 3, the communication device 300 in a wireless communication system can be utilized for realizing the UEs (or ATs) 116 and 122 in FIG. 1 or the base station (or AN) 100 in FIG. 1, and the wireless communications system may be the LTE system or the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

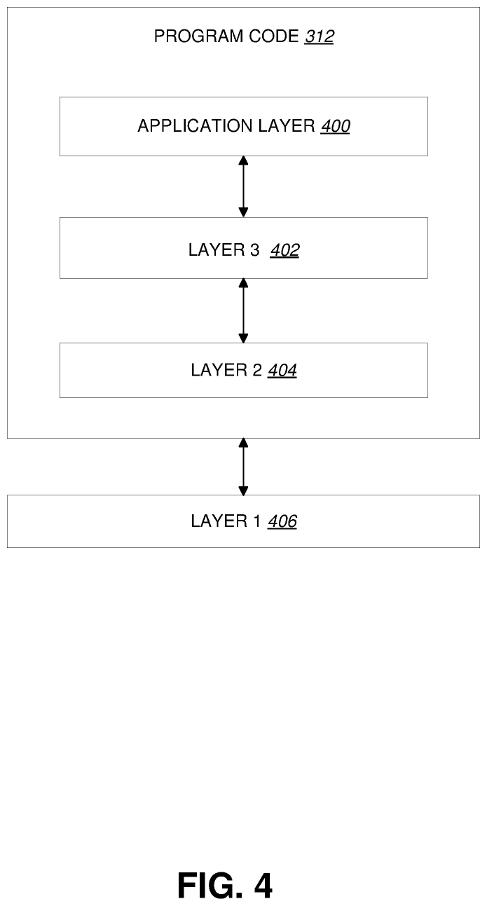

FIG. 4 is a simplified block diagram of the program code 312 shown in FIG. 3 in accordance with one embodiment of the disclosed subject matter. In this embodiment, the program code 312 includes an application layer 400, a Layer 3 portion 402, and a Layer 2 portion 404, and is coupled to a Layer 1 portion 406. The Layer 3 portion 402 may perform radio resource control. The Layer 2 portion 404 may perform link control. The Layer 1 portion 406 may perform and/or implement physical connections.

3GPP TS 38.214 V17.0.0 discusses Physical Sidelink Shared Channel (PSSCH)-related procedure in NR. Sidelink resource allocation mode 1 and sidelink resource allocation mode 2 for acquiring sidelink resources are discussed. One or more parts of 3GPP TS 38.214 V17.0.0 are quoted below:

### 8 Physical Sidelink Shared Channel Related Procedures

A UE can be configured by higher layers with one or more sidelink resource pools. A sidelink resource pool can be for transmission of PSSCH, as described in Clause 8.1, or for reception of PSSCH, as described in Clause 8.3 and can be associated with either sidelink resource allocation mode 1 or sidelink resource allocation mode 2.
In the frequency domain, a sidelink resource pool consists of sl-NumSubchannel contiguous sub-channels. A sub-channel consists of sl-SubchannelSize contiguous PRBs, where sl-NumSubchannel and sl-SubchannelSize are higher layer parameters.
The set of slots that may belong to a sidelink resource pool is denoted by (t₀^{SL}, t₁^{L}, . . . , t_{T}_{ₘₐₓ}₋₁^{SL}) where
0≤tᵢ^{SL}<10240×2^{μ}, 0≤i<Tₘₐₓ,
the slot index is relative to slot #0 of the radio frame corresponding to SFN 0 of the serving cell or DFN 0,
. . .
   . . .
The slots in the set are arranged in increasing order of slot index.

### 8.1 UE Procedure for Transmitting the Physical Sidelink Shared Channel

Each PSSCH transmission is associated with an PSCCH transmission.
That PSCCH transmission carries the 1^{st} stage of the SCI associated with the PSSCH transmission; the 2^{nd} stage of the associated SCI is carried within the resource of the PSSCH.
If the UE transmits SCI format 1-A on PSCCH according to a PSCCH resource configuration in slot n and PSCCH resource m, then for the associated PSSCH transmission in the same slot
one transport block is transmitted with up to two layers;
   . . .

### 8.1.2 Resource Allocation

In sidelink resource allocation mode 1:
for PSSCH and PSCCH transmission, dynamic grant, configured grant type 1 and configured grant type 2 are supported. The configured grant Type 2 sidelink transmission is semi-persistently scheduled by a SL grant in a valid activation DCI according to Clause 10.2A of [6, TS 38.213].

### 8.1.2.1 Resource Allocation in Time Domain

The UE shall transmit the PSSCH in the same slot as the associated PSCCH.
The minimum resource allocation unit in the time domain is a slot.
The UE shall transmit the PSSCH in consecutive symbols within the slot, subject to the following restrictions:
The UE shall not transmit PSSCH in symbols which are not configured for sidelink. A symbol is configured for sidelink, according to higher layer parameters sl-StartSymbol and sl-LengthSymbols, where sl-StartSymbol is the symbol index of the first symbol of sl-LengthSymbols consecutive symbols configured for sidelink.
Within the slot, PSSCH resource allocation starts at symbol sl-StartSymbol+1.
The UE shall not transmit PSSCH in symbols which are configured for use by PSFCH, if PSFCH is configured in this slot.
The UE shall not transmit PSSCH in the last symbol configured for sidelink.
The UE shall not transmit PSSCH in the symbol immediately preceding the symbols which are configured for use by PSFCH, if PSFCH is configured in this slot.
   In sidelink resource allocation mode 1:
For sidelink dynamic grant, the PSSCH transmission is scheduled by a DCI format 3_0.
For sidelink configured grant type 2, the configured grant is activated by a DCI format 3_0.
For sidelink dynamic grant and sidelink configured grant type 2:
   . . .

### 8.1.2.2 Resource Allocation in Frequency Domain

The resource allocation unit in the frequency domain is the sub-channel.
The sub-channel assignment for sidelink transmission is determined using the “Frequency resource assignment” field in the associated SCI.
The lowest sub-channel for sidelink transmission is the sub-channel on which the lowest PRB of the associated PSCCH is transmitted.
If a PSSCH scheduled by a PSCCH would overlap with resources containing the PSCCH, the resources corresponding to a union of the PSCCH that scheduled the PSSCH and associated PSCCH DM-RS are not available for the PSSCH.
[ . . . ]

### 8.1.4 UE Procedure for Determining the Subset of Resources to be Reported to Higher Layers in PSSCH Resource Selection in Sidelink Resource Allocation Mode 2

In resource allocation mode 2, the higher layer can request the UE to determine a subset of resources from which the higher layer will select resources for PSSCH/PSCCH transmission. To trigger this procedure, in slot n, the higher layer provides the following parameters for this PSSCH/PSCCH transmission:
. . .
   . . .

### 8.1.4B UE Procedure for Determining a Resource Conflict

A UE configured with the higher layer parameter interUECoordinationScheme2 enabling transmission of a resource conflict indication considers that a resource conflict occurs on a first reserved resource r₁ indicated by a first received SCI format if at least one of the following conditions is satisfied:
. . .
   . . . 8.1.5 UE Procedure for Determining Slots and Resource Blocks for PSSCH Transmission Associated with an SCI Format 1-A
   The set of slots and resource blocks for PSSCH transmission is determined by the resource used for the PSCCH transmission containing the associated SCI format 1-A, and fields ‘Frequency resource assignment’, ‘Time resource assignment’ of the associated SCI format 1-A as described below.
   [ . . . ]

### 8.1.7 UE Procedure for Determining the Number of Logical Slots for a Reservation Period

A given resource reservation period Pᵣₛᵥₚ in milliseconds is converted to a period Pᵣₛᵥₚ in logical slots as:

$${P}_{rsvp}^{′} = ⌈ \frac{{T}_{max}^{′}}{10240 ms} \times {P}_{rsvp} ⌉$$

where T′ₘₐₓ is the number of slots that belong to a resource pool as defined in Clause 8.
[ . . . ]

### 8.3 UE Procedure for Receiving the Physical Sidelink Shared Channel

For sidelink resource allocation mode 1, a UE upon detection of SCI format 1-A on PSCCH can decode PSSCH according to the detected SCI formats 2-A and 2-B, and associated PSSCH resource configuration configured by higher layers. The UE is not required to decode more than one PSCCH at each PSCCH resource candidate.
For sidelink resource allocation mode 2, a UE upon detection of SCI format 1-A on PSCCH can decode PSSCH according to the detected SCI formats 2-A and 2-B, and associated PSSCH resource configuration configured by higher layers. The UE is not required to decode more than one PSCCH at each PSCCH resource candidate.

3GPP TS 38.213 V17.0.0 discusses uplink (UL) power prioritization and/or reduction and sidelink control channel related procedure in NR and/or sidelink feedback channel related procedure in NR. One or more parts of 3GPP TS 38.213 V17.0.0 are quoted below:

### 7 Uplink Power Control

Uplink power control determines a power for PUSCH, PUCCH, SRS, and PRACH transmissions.
[ . . . ]

### 7.5 Prioritizations for Transmission Power Reductions

For single cell operation with two uplink carriers or for operation with carrier aggregation, if a total UE transmit power for PUSCH or PUCCH or PRACH or SRS transmissions on serving cells in a frequency range in a respective transmission occasion i would exceed \hat{P}_{CMAX}(i), where \hat{P}_{CMAX}(i) is the linear value of P_{CMAX} (i) in transmission occasion i as defined in [8-1, TS 38.101-1] for FR1 and [8-2, TS38.101-2] for FR2, the UE allocates power to PUSCH/PUCCH/PRACH/SRS transmissions according to the following priority order (in descending order) so that the total UE transmit power for transmissions on serving cells in the frequency range is smaller than or equal to \hat{P}_{CMAX} (i) for that frequency range in every symbol of transmission occasion i. When determining a total transmit power for serving cells in a frequency range in a symbol of transmission occasion i, the UE does not include power for transmissions starting after the symbol of transmission occasion i. The total UE transmit power in a symbol of a slot is defined as the sum of the linear values of UE transmit powers for PUSCH, PUCCH, PRACH, and SRS in the symbol of the slot.
PRACH transmission on the PCell
PUCCH or PUSCH transmissions with higher priority index according to clause 9
For PUCCH or PUSCH transmissions with same priority index
   PUCCH transmission with HARQ-ACK information, and/or SR, and/or LRR, or PUSCH transmission with HARQ-ACK information
   PUCCH transmission with CSI or PUSCH transmission with CSI
   PUSCH transmission without HARQ-ACK information or CSI and, for Type-2 random access procedure, PUSCH transmission on the PCell
   SRS transmission, with aperiodic SRS having higher priority than semi-persistent and/or periodic SRS, or PRACH transmission on a serving cell other than the PCell
      In case of same priority order and for operation with carrier aggregation, the UE prioritizes power allocation for transmissions on the primary cell of the MCG or the SCG over transmissions on a secondary cell. In case of same priority order and for operation with two UL carriers, the UE prioritizes power allocation for transmissions on the carrier where the UE is configured to transmit PUCCH. If PUCCH is not configured for any of the two UL carriers, the UE prioritizes power allocation for transmissions on the non-supplementary UL carrier.
. . .
   [ . . . ]

### 16 UE Procedures for Sidelink

A UE is provided by SL-BWP-Config a BWP for SL transmissions (SL BWP) with numerology and resource grid determined as described in [4, TS 38.211]. For a resource pool within the SL BWP, the UE is provided by sl-NumSubchannel a number of sub-channels where each sub-channel includes a number of contiguous RBs provided by sl-SubchannelSize. The first RB of the first sub-channel in the SL BWP is indicated by sl-StartRB-Subchannel. Available slots for a resource pool are provided by sl-TimeResource and occur with a periodicity of 10240 ms. For an available slot without S-SS/PSBCH blocks, SL transmissions can start from a first symbol indicated by sl-StartSymbol and be within a number of consecutive symbols indicated by sl-LengthSymbols. For an available slot with S-SS/PSBCH blocks, the first symbol and the number of consecutive symbols is predetermined.
The UE expects to use a same numerology in the SL BWP and in an active UL BWP in a same carrier of a same cell. If the active UL BWP numerology is different than the SL BWP numerology, the SL BWP is deactivated.
[ . . . ]

### 16.2 Power Control

[ . . . ]

### 16.2.3 PSFCH

A UE with N_{sch,Tx,PSFCH} scheduled PSFCH transmissions, and capable of transmitting a maximum of N_{max,PSFCH} PSFCHs, determines a number N_{Tx,PSFCH} of simultaneous PSFCH transmissions and a power P_{PSFCH,k}(i) for a PSFCH transmission k, 1≤k≤N_{Tx,PSFCH}, on a resource pool in PSFCH transmission occasion i on active SL BWP b of carrier f as
if dl-P0-PSFCH is provided,

P_{PSFCH,one}=P_{O,PSFCH}+10 log₁₀(2^{μ})+α_{PSFCH}·PL [dBm]
where
   P_{O,PSFCH} is a value of dl-P0-PSFCH
   α_{PFSCH} is a value of dl-Alpha-PSFCH, if provided; else, α_{PFSCH}=1
      PL=PL_{b,f,c}(g_{d}) when the active SL BWP is on a serving cell c, as described in clause 7.1.1 except that
         the RS resource is the one the UE uses for determining a power of a PUSCH transmission scheduled by a DCI format 0_0 in serving cell c when the UE is configured to monitor PDCCH for detection of DCI format 0_0 in serving cell c
         the RS resource is the one corresponding to the SS/PBCH block the UE uses to obtain MIB when the UE is not configured to monitor PDCCH for detection of DCI format 0_0 in serving cell c
   if N_{sch,Tx,PSFCH}≤N_{max,PSFCH}
      if P_{PSFCH,one}+10 log₁₀ (N_{sch,Tx,PSFCH})≤P_{CMAX}, where P_{CMAX} is determined for N_{sch,Tx,PSFCH} PSFCH transmissions according to [8-1, TS 38.101-1]

N_{Tx,PSFCH}=N_{sch,Tx,PSFCH} and P_{PSFCH,k}(i)=P_{PSFCH,one} [dBm]
else
   UE autonomously determines N_{Tx,PSFCH} PSFCH transmissions with ascending order of corresponding priority field values as described in clause 16.2.4.2 such that N_{Tx,PSFCH}≥max(1, Σᵢ₌₁^{K}Mᵢ) where Mᵢ is a number of PSFCHs with priority value i and K is defined as
   the largest value satisfying P_{PSFCH,one}+10 log₁₀ (max(1, Σᵢ₌₁^{K}Mᵢ))≤P_{CMAX} where P_{CMAX} is determined according to [8-1, TS 38.101-1] for transmission of all PSFCHs assigned with priority values 1, 2, . . . , K, if any
   zero, otherwise
and

P_{PSFCH,k}(i)=min(P_{CMAX}−10 log₁₀(N_{Tx,PSFCH}),P_{PSFCH,one}) [dBm]
where P_{CMAX} is defined in [8-1, TS 38.101-1] and is determined for the N_{Tx,PSFCH} PSFCH transmissions
else
   the UE autonomously selects N_{max,PSFCH} PSFCH transmissions with ascending order of corresponding priority field values as described in clause 16.2.4.2
      if P_{PSFCH,one}+10 log₁₀(N_{max,PSFCH})≤P_{CMAX}, where P_{CMAX} is determined for the N_{max,PSFCH} PSFCH transmissions according to [8-1, TS 38.101-1]

N_{Tx,PSFCH}=N_{max,PSFCH} and P_{PSFCH,k}(i)=P_{PSFCH,one}[dBm]
else
the UE autonomously selects N_{Tx,PSFCH} PSFCH transmissions in ascending order of corresponding priority field values as described in clause 16.2.4.2 such that N_{Tx,PSFCH}≥max(1, Σᵢ₌₁^{K} Mᵢ) where Mᵢ is a number of PSFCHs with priority value i and K is defined as
the largest value satisfying P_{PSFCH,one}+10 log₁₀(max(1, Σi=1^{K}Mᵢ))≤P_{CMAX} where P_{CMAX} is determined according to [8-1, TS 38.101-1] for transmission of all PSFCHs assigned with priority values 1, 2, . . . , K, if any
zero, otherwise
and

P_{PSFCH,k}(i)=min(P_{CMAX}−10 log₁₀(N_{Tx,PSFCH}),P_{PSFCH,one}) [dBm]
where P_{CMAX} is determined for the N_{Tx,PSFCH} simultaneous PSFCH transmissions according to [8-1, TS 38.101-1]
else

P_{PSFCH,k}(i)=P_{CMAX}−10 log₁₀(N_{Tx,PSFCH}) [dBm]
where the UE autonomously determines N_{Tx,PSFCH} PSFCH transmissions with ascending order of corresponding priority field values as described in clause 16.2.4.2 such that N_{Tx,PSFCH}≥1 and where P_{CMAX} is determined for the N_{Tx,PSFCH} PSFCH transmissions according to [8-1, TS 38.101-1].

### 16.2.4 Prioritization of Transmissions/Receptions

. . .

### 16.2.4.2 Simultaneous PSFCH Transmission/Reception

### If a UE

would transmit N_{sch,Tx,PSFCH} PSFCHs and receive N_{sch,Rx,PSFCH}PSFCHs, and
transmissions of the N_{sch,Tx,PSFCH} PSFCHs would overlap in time with receptions of the N_{sch,Rx,PSFCH} PSFCHs
   the UE transmits or receives only a set of PSFCHs corresponding to the smallest priority field value, as determined by a first set of SCI format 1-A and a second set of SCI format 1-A [5, TS 38.212] that are respectively associated with the N_{sch,Tx,PSFCH} PSFCHs and the N_{sch,Rx,PSFCH} PSFCHs.
   If a UE would transmit N_{sch,Tx,PSFCH} PSFCHs in a PSFCH transmission occasion, the UE transmits N_{Tx,PSFCH} PSFCHs corresponding to the smallest N_{Tx,PSFCH} priority field values indicated in all SCI formats 1-A associated with the PSFCH transmission occasion.
   . . .

### 16.3 UE Procedure for Reporting and Obtaining Control Information in PSFCH

Control information provided by a PSFCH transmission includes HARQ-ACK information or conflict information.
16.3.0 UE Procedure for Transmitting PSFCH with Control Information
A UE can be indicated by an SCI format scheduling a PSSCH reception to transmit a PSFCH with HARQ-ACK information in response to the PSSCH reception. The UE provides HARQ-ACK information that includes ACK or NACK, or only NACK.
A UE can be provided, by sl-PSFCH-Period, a number of slots in a resource pool for a period of PSFCH transmission occasion resources. If the number is zero, PSFCH transmissions from the UE in the resource pool are disabled.
A UE can be enabled, by inter-UECoordinationScheme2, to transmit a PSFCH with conflict information in a resource pool. The UE can determine, based on an indication by a SCI format 1-A, a set of resources that includes one or more slots and resource blocks that are reserved for PSSCH transmission. If the UE determines a conflict for a reserved resource for PSSCH transmission, the UE provides conflict information in a PSFCH.
A UE expects that a slot t′ₖ^{SL} (0≤k<T′ₘₐₓ) has a PSFCH transmission occasion resource if k mod N_{PSCCH}^{PSFCH}=0, where t′ₖ^{SL} L is defined in [6, TS 38.214], and T′ₘₐₓ is a number of slots that belong to the resource pool within 10240 msec according to [6, TS 38.214], and N_{PSSCH}^{PSFCH} is provided by sl-PSFCH-Period.
A UE may be indicated by higher layers to not transmit a PSFCH that includes HARQ-ACK information in response to a PSSCH reception [11, TS 38.321].
If a UE receives a PSSCH in a resource pool and the HARQ feedback enabled/disabled indicator field in an associated SCI format 2-A or a SCI format 2-B has value 1 [5, TS 38.212], the UE provides the HARQ-ACK information in a PSFCH transmission in the resource pool. The UE transmits the PSFCH in a first slot that includes PSFCH resources and is at least a number of slots, provided by sl-MinTimeGapPSFCH, of the resource pool after a last slot of the PSSCH reception.
A UE is provided by sl-PSFCH-RB-Set a set of M_{PRB,set}^{PSFCH} et PRBs in a resource pool for PSFCH transmission with HARQ-ACK information in a PRB of the resource pool. A UE can be provided by sl-PSFCH-Conflict-RB-Set a set of M_{PRB,set}^{PSFCH} Het PRBs in a resource pool for PSFCH transmission with conflict information in a PRB of the resource pool. For a number of N_{subch} sub-channels for the resource pool, provided by sl-NumSubchannel, and a number of PSSCH slots associated with a PSFCH slot that is less than or equal to N_{PSSCH}^{PSFCH}, the UE allocates the [(i+j·N_{PSSCH}^{PSFCH})·M_{subsch,slot}^{PSFCH}, (i+1+j·N_{PSSCH}^{PSFCH})·M_{subch,slot}^{PSFCH}−1] PRBs from the M_{PRB,set}^{PSFCH} PRBs to slot i among the PSSCH slots associated with the PSFCH slot and sub-channel j, where M_{subch,slot}^{PSFCH}=M_{PRB,set}^{PSFCH}/(N_{subch}·N_{PSSCH}^{PSFCH}), 0≤i<N_{PSSCH}^{PSFCH}, 0≤j<N_{subch}, and the allocation starts in an ascending order of i and continues in an ascending order of j. The UE expects that M_{PRB,set}^{PSFCH} is a multiple of N_{subch}·N_{PSSCH}^{PSFCH}.
The second OFDM symbol l′ of PSFCH transmission in a slot is defined as l′=sl-StartSymbol+sl-LengthSymbols−2.
A UE determines a number of PSFCH resources available for multiplexing HARQ-ACK or conflict information in a PSFCH transmission as R_{PRB,CS}^{PSFCH}=N_{type}^{PSFCH}·M_{subch,slot}^{PSFCH}·N_{CS}^{PSFCH} where N_{CS}^{PSFCH} is a number of cyclic shift pairs for the resource pool provided by sl-NumMuxCS-Pair and, based on an indication by sl-PSFCH-CandidateResourceType,
if sl-PSFCH-CandidateResourceType is configured as startSubCH, N_{type}^{PSFCH}=1 and the M_{subch,slot}^{PSFCH} PRBs are associated with the starting sub-channel of the corresponding PSSCH;
if sl-PSFCH-CandidateResourceType is configured as allocSubCH, N_{type}^{PSFCH}=N_{subch}^{PSSCH} and the N_{subch}^{PSSCH}·M_{subch,slot}^{PSFCH} PRBs are associated with the N_{subch}^{PSSCH} sub-channels of the corresponding PSSCH.
   The PSFCH resources are first indexed according to an ascending order of the PRB index, from the N_{type}^{PSFCH}·M_{subsch,slot}^{PSFCH} PRBs, and then according to an ascending order of the cyclic shift pair index from the N_{CS}^{PSFCH} cyclic shift pairs.
   A UE determines an index of a PSFCH resource for a PSFCH transmission with HARQ-ACK information in response to a PSSCH reception or with conflict information corresponding to a reserved resource as (P_{ID}+M_{ID})modR_{PRB,CS}^{PSFCH} where P_{ID} is a physical layer source ID provided by SCI format 2-A or 2-B [5, TS 38.212] scheduling the PSSCH reception, or by SCI format 2-A or 2-B with corresponding SCI format 1-A reserving the resource from another UE to be provided with the conflict information and for HARQ-ACK information, M_{ID} is the identity of the UE receiving the PSSCH as indicated by higher layers if the UE detects a SCI format 2-A with Cast type indicator field value of “01”; otherwise, M_{ID} is zero. For conflict information, M_{ID} is zero.
   . . .
   If a UE transmits a PSFCH with conflict information corresponding to a reserved resource indicated in an SCI format 1-A, the UE transmits the PSFCH in the resource pool in a slot determined based on PSFCHOccasionScheme2
If PSFCHOccasionScheme2=‘followSCI’, the UE transmits the PSFCH in a first slot that includes PSFCH resources and is at least a number of slots, provided by sl-MinTimeGapPSFCH, of the resource pool after a slot of a PSCCH reception that provides the SCI format 1-A. The PSFCH resource is in a slot that is at least T₃ slots [6, TS 38.214] before the resource associated with the conflict information.
If PSFCHOccasionScheme2=‘followReservedResource’, the UE transmits the PSFCH in a latest slot that includes PSFCH resources and is at least T₃ slots before a slot of the resource associated with conflict information. The PSFCH resource is in a slot that is at least X slots after a slot of a PSCCH reception that provides the SCI format 1-A
   16.3.1 UE Procedure for Receiving PSFCH with Control Information
   A UE that transmitted a PSSCH scheduled by a SCI format 2-A or a SCI format 2-B that indicates HARQ feedback enabled, attempts to receive associated PSFCHs with HARQ-ACK information according to PSFCH resources determined as described in clause 16.3.0. The UE determines an ACK or a NACK value for HARQ-ACK information provided in each PSFCH resource as described in [8-4, TS 38.101-4]. The UE does not determine both an ACK value and a NACK value at a same time for a PSFCH resource.
   For each PSFCH reception occasion, from a number of PSFCH reception occasions, the UE generates HARQ-ACK information to report to higher layers. For generating the HARQ-ACK information, the UE can be indicated by a SCI format to perform one of the following
if the UE receives a PSFCH associated with a SCI format 2-A with Cast type indicator field value of “10”
   report to higher layers HARQ-ACK information with same value as a value of HARQ-ACK information that the UE determines from the PSFCH reception
if the UE receives a PSFCH associated with a SCI format 2-A with Cast type indicator field value of “01”
   report an ACK value to higher layers if the UE determines an ACK value from at least one PSFCH reception occasion from the number of PSFCH reception occasions in PSFCH resources corresponding to every identity M_{ID} of UEs that the UE expects to receive corresponding PSSCHs as described in clause 16.3; otherwise, report a NACK value to higher layers
if the UE receives a PSFCH associated with a SCI format 2-B or a SCI format 2-A with Cast type indicator field value of “11”
   report to higher layers an ACK value if the UE determines absence of PSFCH reception for the PSFCH reception occasion; otherwise, report a NACK value to higher layers
      A UE that transmitted SCI format 1-A, indicating one or more reserved resources, and enabled by inter-UECoordinationScheme2, attempts to receive associated PSFCH with conflict information in a resource pool in PSFCH resources that the UE determines as described in clause 16.3.0. If the UE determines presence of a resource conflict based on conflict information in a PSFCH reception, the UE reports the resource conflict to higher layers.

### 16.4 UE Procedure for Transmitting PSCCH

A UE can be provided a number of symbols in a resource pool, by sl-TimeResourcePSCCH, starting from a second symbol that is available for SL transmissions in a slot, and a number of PRBs in the resource pool, by sl-FreqResourcePSCCH, starting from the lowest PRB of the lowest sub-channel of the associated PSSCH, for a PSCCH transmission with a SCI format 1-A.

3GPP TS 38.212 V17.0.0 discusses sidelink control information and Downlink Control Information (DCI) as Sidelink (SL) grant in NR. One or more parts of 3GPP TS 38.212 V17.0.0 are quoted below:

### 7.3.1.4 DCI Formats for Scheduling of Sidelink

### 7.3.1.4.1 Format 3_0

DCI format 3_0 is used for scheduling of NR PSCCH and NR PSSCH in one cell.
The following information is transmitted by means of the DCI format 3_0 with CRC scrambled by SL-RNTI or SL-CS-RNTI:
Resource pool index—┌log₂ I┐ bits, where I is the number of resource pools for transmission configured by the higher layer parameter sl-TxPoolScheduling.
Time gap—3 bits . . . , as defined in clause 8.1.2.1 of [6, TS 38.214]
HARQ process number—4 bits.
New data indicator—1 bit.
Lowest index of the subchannel allocation to the initial transmission—┌log₂(N_{subChannel}^{SL})┐ bits as defined in clause 8.1.2.2 of [6, TS 38.214]
SCI format 1-A fields according to clause 8.3.1.1:
   Frequency resource assignment.
   Time resource assignment.
PSFCH-to-HARQ feedback timing indicator—└log₂ N_{fb_timing}┐ bits, . . . as defined in clause 16.5 of [5, TS 38.213]
PUCCH resource indicator—3 bits as defined in clause 16.5 of [5, TS 38.213].
. . .
   [ . . . ]

### 8.3 Sidelink Control Information on PSCCH

SCI carried on PSCCH is a 1^{st}-stage SCI, which transports sidelink scheduling information.

### . . . 8.3.1.1 SCI Format 1-A

SCI format 1-A is used for the scheduling of PSSCH and 2^{nd}-stage-SCI on PSSCH
The following information is transmitted by means of the SCI format 1-A:
Priority—3 bits as specified in clause 5.4.3.3 of [12, TS 23.287] and clause 5.22.1.3.1 of [8, TS 38.321]. Value ‘000’ of Priority field corresponds to priority value ‘1’, value ‘001’ of Priority field corresponds to priority value ‘2’, and so on.
Frequency resource assignment— . . . , as defined in clause 8.1.5 of [6, TS 38.214].
Time resource assignment— . . . , as defined in clause 8.1.5 of [6, TS 38.214].
Resource reservation period—┌log₂ N_{rsv_period}┐ bits as defined in clause 16.4 of [5, TS 38.213], . . .
DMRS pattern—┌log₂ N_pattern┐ bits as defined in clause 8.4.1.1.2 of [4, TS 38.211], . . .
2^{nd}-stage SCI format—2 bits as defined in Table 8.3.1.1-1.
Beta_offset indicator—2 bits as provided by higher layer parameter . . .
Number of DMRS port—1 bit as defined in Table 8.3.1.1-3.
Modulation and coding scheme—5 bits as defined in clause 8.1.3 of [6, TS 38.214].
Additional MCS table indicator—as defined in clause 8.1.3.1 of [6, TS 38.214]: . . .
PSFCH overhead indication—1 bit as defined clause 8.1.3.2 of [6, TS 38.214] if higher layer parameter sl-PSFCH-Period=2 or 4; 0 bit otherwise.
Reserved—a number of bits as determined by higher layer parameter sl-NumReservedBits, with value set to zero.

TABLE 8.3.1.1-1
2^{nd}-stage SCI formats

| Value of 2nd-stage | |
|---|---|
| SCI format field | 2nd-stage SCI format |
| 00 | SCI format 2-A |
| 01 | SCI format 2-B |
| 10 | SCI format 2-C |
| 11 | Reserved |

### 8.4 Sidelink Control Information on PSSCH

SCI carried on PSSCH is a 2^{nd}-stage SCI, which transports sidelink scheduling information.
. . .

### 8.4.1.1 SCI Format 2-A

SCI format 2-A is used for the decoding of PSSCH, with HARQ operation when HARQ-ACK information includes ACK or NACK, when HARQ-ACK information includes only NACK, or when there is no feedback of HARQ-ACK information.
The following information is transmitted by means of the SCI format 2-A:
HARQ process number—4 bits.
New data indicator—1 bit.
Redundancy version—2 bits as defined in Table 7.3.1.1.1-2.
Source ID—8 bits as defined in clause 8.1 of [6, TS 38.214].
Destination ID—16 bits as defined in clause 8.1 of [6, TS 38.214].
HARQ feedback enabled/disabled indicator—1 bit as defined in clause 16.3 of [5, TS 38.213].
Cast type indicator—2 bits as defined in Table 8.4.1.1-1 and in clause 8.1 of [6, TS 38.214].
CSI request—1 bit as defined in clause 8.2.1 of [6, TS 38.214] and in clause 8.1 of [6, TS 38.214].

TABLE 8.4.1.1-1
Cast type indicator

| Value of Cast type | |
|---|---|
| indicator | Cast type |
| 00 | Broadcast |
| 01 | Groupcast |
| | when HARQ-ACK information includes |
| | ACK or NACK |
| 10 | Unicast |
| 11 | Groupcast |
| | when HARQ-ACK information includes |
| | only NACK |

### 8.4.1.2 SCI Format 2-B

SCI format 2-B is used for the decoding of PSSCH, with HARQ operation when HARQ-ACK information includes only NACK, or when there is no feedback of HARQ-ACK information.
The following information is transmitted by means of the SCI format 2-B:
HARQ process number—4 bits.
New data indicator—1 bit.
Redundancy version—2 bits as defined in Table 7.3.1.1.1-2.
Source ID—8 bits as defined in clause 8.1 of [6, TS 38.214].
Destination ID—16 bits as defined in clause 8.1 of [6, TS 38.214].
HARQ feedback enabled/disabled indicator—1 bit as defined in clause 16.3 of [5, TS 38.213].
Zone ID—12 bits as defined in clause 5.8.11 of [9, TS 38.331].
Communication range requirement—4 bits determined by higher layer parameter sl-ZoneConfigMCR-Index.

### 8.4.1.3 SCI Format 2-C

SCI format 2-C is used for the decoding of PSSCH and providing inter-UE coordination information.
The following information is transmitted by means of the SCI format 2-C:
Resource combination(s)—x bits as defined in Clause 8.1.5A of [6, TS 38.214].
   First resource location(s)—x bits as defined in Clause 8.1.5A of [6, TS 38.214].
      8.4.5 Multiplexing of Coded 2^{nd}-Stage SCI Bits to PSSCH
      The coded 2^{nd}-stage SCI bits are multiplexed onto PSSCH according to the procedures in Clause 8.2.1.

3GPP TS 38.211 V17.0.0 discusses physical sidelink feedback channel (PSFCH) in NR. One or more parts of 3GPP TS 38.211 V17.0.0 are quoted below:

8.3.4 Physical sidelink feedback channel

### 8.3.4.1 General

8.3.4.2 PSFCH format 0
8.3.4.2.1 Sequence generation
The sequence x(n) shall be generated according to

x(n)=r_{u,v}^{α,δ}(n)

n=0,1, . . . , N_{sc}^{RB}−1,

where r_{u,v}^{(α,δ)}(n) is given by clause 6.3.2.2 with the following exceptions:
. . .
l=0;
l′ is the index of the OFDM symbol in the slot that corresponds to the second OFDM symbol of the PSFCH transmission in the slot given by [5, TS 38.213];
. . .

### 8.3.4.2.2 Mapping to Physical Resources

The sequence x(n) shall be multiplied with the amplitude scaling factor β_{PSFCH} in order to conform to the transmit power specified in [5, TS 38.213] and mapped in sequence starting with x(0) to resource elements (k, l)_{p,u} assigned for transmission of the second PSFCH symbol according to clause 16.3 of [5, TS 38.213] in increasing order of the index k over the assigned physical resources on antenna port p=5000.
The resource elements used for the PSFCH in the OFDM symbol in the mapping operation above shall be duplicated in the immediately preceding OFDM symbol.

3GPP TS 38.331 V16.7.0 discusses sidelink in NR and/or one or more configurations associated with sidelink in NR. One or more parts of 3GPP TS 38.331 V16.7.0 are quoted below:

### 6.3.5 Sidelink Information Elements

SL-BWP-Config
   The IE SL-BWP-Config is used to configure the UE specific NR sidelink communication on one particular sidelink bandwidth part.

### SL-BWP-Config Information Element

-- ASN1START
-- TAG-SL-BWP-CONFIG-START

| | |
|---|---|
| SL-BWP-Config-r16 ::= | SEQUENCE { |
| sl-BWP-Id | BWP-Id, |
| sl-BWP-Generic-r16 | SL-BWP-Generic-r16 |

OPTIONAL, -- Need M

| | |
|---|---|
| sl-BWP-PoolConfig-r16 | SL-BWP-PoolConfig-r16 |

OPTIONAL, -- Need M
...
}

| | |
|---|---|
| SL-BWP-Generic-r16 ::= | SEQUENCE { |
| sl-BWP-r16 | BWP |

OPTIONAL, -- Need M

| | |
|---|---|
| sl-LengthSymbols-r16 | ENUMERATED {sym7, sym8, |
| sym9, sym10, sym11, sym12, sym13, sym14} | OPTIONAL, -- Need M |
| sl-StartSymbol-r16 | ENUMERATED {sym0, sym1, |
| sym2, sym3, sym4, sym5, sym6, sym7} | OPTIONAL, -- Need M |
| sl-PSBCH-Config-r16 | SetupRelease {SL-PSBCH- |
| Config-r16} | OPTIONAL, -- Need M |
| sl-TxDirectCurrentLocation-r16 | INTEGER (0..3301) |

OPTIONAL, -- Need M
...
}
-- TAG-SL-BWP-CONFIG-STOP
-- ASN1STOP

SL-BWP-PoolConfig
   The IE SL-BWP-PoolConfig is used to configure NR sidelink communication resource pool.

### SL-BWP-PoolConfig Information Element

-- ASN1START
-- TAG-SL-BWP-POOLCONFIG-START

| | |
|---|---|
| SL-BWP-PoolConfig-r16 ::= | SEQUENCE { |
| sl-RxPool-r16 | SEQUENCE (SIZE (1..maxNrofTXPool- |
| r16)) OF SL-ResourcePool-r16 | OPTIONAL, -- Cond HO |
| sl-TxPoolSelectedNormal-r16 | SL-TxPoolDedicated-r16 |

OPTIONAL -- Need M

| | |
|---|---|
| sl-TxPoolScheduling-r16 | SL-TxPoolDedicated-r16 |

OPTIONAL -- Need M

| | |
|---|---|
| sl-TxPoolExceptional-r16 | SL-ResourcePoolConfig-r16 |

OPTIONAL -- Need M
}

| | |
|---|---|
| SL-TxPoolDedicated-r16 ::= | SEQUENCE { |
| sl-PoolToReleaseList-r16 | SEQUENCE (SIZE (1..maxNrofTXPool- |
| r16)) OF SL-ResourcePoolID-r16 | OPTIONAL, -- Need N |
| sl-PoolToAddModList-r16 | SEQUENCE (SIZE (1..maxNrofTXPool- |
| r16)) OF SL-ResourcePoolConfig-r16 | OPTIONAL, -- Need N |

}

| | |
|---|---|
| SL-ResourcePoolConfig-r16 ::= | SEQUENCE { |
| sl-ResourcePoolID-r16 | SL-ResourcePoolID-r16, |
| sl-ResourcePool-r16 | SL-ResourcePool-r16 |

OPTIONAL -- Need M
}

| | |
|---|---|
| SL-ResourcePoolID-r16 ::= | INTEGER (1..maxNrofPoolID-r16) |

-- TAG-SL-BWP-POOLCONFIG-STOP
-- ASN1STOP

SL-BWP-PoolConfig field descriptions

sl-RxPool
Indicates the receiving resource pool on the configured BWP. For
the PSFCH related configuration, if configured, will be used for
PSFCH transmission/reception. If the field is included, it replaces
any previous list, i.e. all the entries of the list are replaced
and each of the SL-ResourcePool entries is considered to be newly
created.
sl-TxPoolExceptional
Indicates the resources by which the UE is allowed to transmit NR
sidelink communication in exceptional conditions on the configured
BWP. For the PSFCH related configuration, if configured, will be used
for PSFCH transmission/reception.
sl-TxPoolScheduling
Indicates the resources by which the UE is allowed to transmit NR
sidelink communication based on network scheduling on the configured
BWP. For the PSFCH related configuration, if configured, will be used
for PSFCH transmission/reception.
sl-TxPoolSelectedNormal
Indicates the resources by which the UE is allowed to transmit NR sidelink
communication by UE autonomous resource selection on the configured
BWP. For the PSFCH related configuration, if configured, will be used
for PSFCH transmission/reception.

[ . . . ]
SL-ConfigDedicatedNR
   The IE SL-ConfigDedicatedNR specifies the dedicated configuration information for NR sidelink communication.

### SL-ConfigDedicatedNR Information Element

-- ASN1START
-- TAG-SL-CONFIGDEDICATEDNR-START

| | |
|---|---|
| SL-ConfigDedicatedNR-r16 ::= | SEQUENCE { |
| sl-PHY-MAC-RLC-Config-r16 | SL-PHY-MAC-RLC-Config-r16 |

OPTIONAL, -- Need M

| | |
|---|---|
| sl-RadioBearerToReleaseList-r16 | SEQUENCE (SIZE |
| (1..maxNrofSLRB-r16)) OF SLRB-Uu-ConfigIndex-r16 | OPTIONAL, - |

- Need N

| | |
|---|---|
| sl-RadioBearerToAddModList-r16 | SEQUENCE (SIZE |
| (1..maxNrofSLRB-r16)) OF SL-RadioBearerConfig-r16 | OPTIONAL, - |

- Need N

| | |
|---|---|
| sl-MeasConfigInfoToReleaseList-r16 | SEQUENCE (SIZE (1..maxNrofSL- |
| Dest-r16)) OF SL-DestinationIndex-r16 | OPTIONAL, -- Need N |
| sl-MeasConfigInfoToAddModList-r16 | SEQUENCE (SIZE (1..maxNrofSL- |
| Dest-r16)) OF SL-MeasConfigInfo-r16 | OPTIONAL, -- Need N |
| t400-r16 | ENUMERATED {ms100, ms200, |

ms300, ms400, ms600, ms1000, ms1500, ms2000} OPTIONAL, -- Need M
...
}

| | |
|---|---|
| SL-DestinationIndex-r16 ::= | INTEGER (0..maxNrofSL-Dest-1- |

r16)

| | |
|---|---|
| SL-PHY-MAC-RLC-Config-r16::= | SEQUENCE { |
| sl-ScheduledConfig-r16 | SetupRelease { SL- |
| ScheduledConfig-r16 } | OPTIONAL, -- |

Need M

| | |
|---|---|
| sl-UE-SelectedConfig-r16 | SetupRelease { SL-UE- |
| SelectedConfig-r16 } | OPTIONAL, -- Need |

M

| | |
|---|---|
| sl-FreqInfoToReleaseList-r16 | SEQUENCE (SIZE |
| (1..maxNrofFreqSL-r16)) OF SL-Freq-Id-r16 | OPTIONAL, - |

- Need N

| | |
|---|---|
| sl-FreqInfoToAddModList-r16 | SEQUENCE (SIZE |
| (1..maxNrofFreqSL-r16)) OF SL-FreqConfig-r16 | OPTIONAL, - |

- Need N

| | |
|---|---|
| sl-RLC-BearerToReleaseList-r16 | SEQUENCE (SIZE (1..maxSL- |
| LCID-r16)) OF SL-RLC-BearerConfigIndex-r16 | OPTIONAL, -- Need N |
| sl-RLC-BearerToAddModList-r16 | SEQUENCE (SIZE (1..maxSL- |
| LCID-r16)) OF SL-RLC-BearerConfig-r16 | OPTIONAL, -- Need N |
| sl-MaxNumConsecutiveDTX-r16 | ENUMERATED {n1, n2, n3, n4, |
| n6, n8, n16, n32} | OPTIONAL, -- Need M |
| sl-CSI-Acquisition-r16 | ENUMERATED {enabled} |
| OPTIONAL, -- Need R | |
| sl-CSI-SchedulingRequestId-r16 | SetupRelease |
| {SchedulingRequestId} | OPTIONAL, |

-- Need M

| | |
|---|---|
| sl-SSB-PriorityNR-r16 | INTEGER (1..8) |

OPTIONAL, -- Need R

| | |
|---|---|
| networkControlledSyncTx-r16 | ENUMERATED {on, off} |

OPTIONAL -- Need M
}
-- TAG-SL-CONFIGDEDICATEDNR-STOP
-- ASN1STOP

SL-PHY-MAC-RLC-Config field descriptions

. . .
sl-ScheduledConfig
Indicates the configuration for UE to transmit NR sidelink
communication based on network scheduling. This field is not
configured simultaneously with sl-UE-SelectedConfig.
sl-UE-SelectedConfig
Indicates the configuration used for UE autonomous resource
selection. This field is not configured simultaneously with
sl-ScheduledConfig.

[ . . . ]
SL-FreqConfig
   The IE SL-FreqConfig specifies the dedicated configuration information on one particular carrier frequency for NR sidelink communication.

### SL-FreqConfig Information Element

-- ASN1START
-- TAG-SL-FREQCONFIG-START

| | |
|---|---|
| SL-FreqConfig-r16 ::= | SEQUENCE { |
| sl-Freq-Id-r16 | SL-Freq-Id-r16, |
| sl-SCS-SpecificCarrierList-r16 | SEQUENCE (SIZE (1..maxSCSs)) OF |

SCS-SpecificCarrier,

| | |
|---|---|
| sl-AbsoluteFrequencyPointA-r16 | ARFCN-ValueNR |

OPTIONAL, -- Need M

| | |
|---|---|
| sl-AbsoluteFrequencySSB-r16 | ARFCN-ValueNR |

OPTIONAL, -- Need R

| | |
|---|---|
| frequencyShift7p5khzSL-r16 | ENUMERATED {true} |

OPTIONAL, -- Cond V2X-SL-Shared

| | |
|---|---|
| valueN-r16 | INTEGER (−1..1), |
| sl-BWP-ToReleaseList-r16 | SEQUENCE (SIZE (1..maxNrofSL- |
| BWPs-r16)) OF BWP-Id | OPTIONAL, -- Need N |
| sl-BWP-ToAddModList-r16 | SEQUENCE (SIZE (1..maxNrofSL- |
| BWPs-r16)) OF SL-BWP-Config-r16 | OPTIONAL, -- Need N |
| sl-SyncConfigList-r16 | SL-SyncConfigList-r16 |

OPTIONAL, -- Need M

| | |
|---|---|
| sl-SyncPriority-r16 | ENUMERATED {gnss, gnbEnb} |

OPTIONAL, -- Need M
}

| | |
|---|---|
| SL-Freq-Id-r16 ::= | INTEGER (1.. maxNrofFreqSL-r16) |

-- TAG-SL-FREQCONFIG-STOP
-- ASN1STOP

SL-FreqConfig field descriptions

frequencyShift7p5khzSL
Enable the NR SL transmission with a 7.5 kHz shift to the LTE raster.
If the field is absent, the frequency shift is disabled.
sl-AbsoluteFrequencyPointA
Absolute frequency of the reference resource block (Common RB 0).
Its lowest subcarrier is also known as Point A.
sl-AbsoluteFrequencySSB
Indicates the frequency location of sidelink SSB. The transmission
bandwidth for sidelink SSB is within the bandwidth of this sidelink BWP.
sl-BWP-ToAddModList
This field indicates the list of sidelink BWP(s) on which the NR
sidelink communication configuration is to be added or reconfigured.
In this release, only one BWP is allowed to be configured for NR sidelink
communication.
sl-BWP-ToReleaseList
This field indicates the list of sidelink BWP(s) on which the NR
sidelink communication configuration is to be released.
sl-Freq-Id
This field indicates the identity of the dedicated configuration
information on the carrier frequency for NR sidelink communication.
sl-SCS-SpecificCarrierList
A set of UE specific channel bandwidth and location configurations for
different subcarrier spacings (numerologies). Defined in relation to Point
A. The UE uses the configuration provided in this field only for the
purpose of channel bandwidth and location determination. In this release,
only one SCS-SpecificCarrier is allowed to be configured for NR sidelink
communication.
sl-SyncPriority
This field indicates synchronization priority order, as specified
in sub-clause 5.8.6.
valueN
Indicate the NR SL transmission with a valueN *5 kHz shift to the LTE
raster. (see TS 38.101-1 [15], clause 5.4E.2).

| Conditional | |
|---|---|
| Presence | Explanation |
| V2X-SL-Shared | This field is mandatory present if the carrier frequency |
| | configured for NR sidelink communication is shared |
| | by V2X sidelink communication. It is absent, Need |
| | R, otherwise. |

[ . . . ]
SL-ResourcePool
   The IE SL-ResourcePool specifies the configuration information for NR sidelink communication resource pool.

### SL-ResourcePool Information Element

-- ASN1START
-- TAG-SL-RESOURCEPOOL-START

| | |
|---|---|
| SL-ResourcePool-r16 ::= | SEQUENCE { |
| sl-PSCCH-Config-r16 | SetupRelease { SL-PSCCH-Config- |
| r16 } | OPTIONAL, -- Need M |
| sl-PSSCH-Config-r16 | SetupRelease { SL-PSSCH-Config- |
| r16 } | OPTIONAL, -- Need M |
| sl-PSFCH-Config-r16 | SetupRelease { SL-PSFCH-Config- |
| r16 } | OPTIONAL, -- Need M |
| sl-SyncAllowed-r16 | SL-SyncAllowed-r16 |

OPTIONAL, -- Need M

| | |
|---|---|
| sl-SubchannelSize-r16 | ENUMERATED {n10, n12, n15, n20, |
| n25, n50, n75, n100} | OPTIONAL, -- Need M |
| dummy | INTEGER (10..160) |

OPTIONAL, -- Need M

| | |
|---|---|
| sl-StartRB-Subchannel-r16 | INTEGER (0..265) |

OPTIONAL, -- Need M

| | |
|---|---|
| sl-NumSubchannel-r16 | INTEGER (1..27) |

OPTIONAL, -- Need M

| | |
|---|---|
| sl-Additional-MCS-Table-r16 | ENUMERATED {qam256, qam64LowSE, |
| qam256-qam64LowSE } | OPTIONAL, -- Need M |
| sl-ThreshS-RSSI-CBR-r16 | INTEGER (0..45) |

OPTIONAL, -- Need M

| | |
|---|---|
| sl-TimeWindowSizeCBR-r16 | ENUMERATED {ms100, slot100} |

OPTIONAL, -- Need M

| | |
|---|---|
| sl-TimeWindowSizeCR-r16 | ENUMERATED {ms1000, slot1000} |

OPTIONAL, -- Need M

| | |
|---|---|
| sl-PTRS-Config-r16 | SL-PTRS-Config-r16 |

OPTIONAL, -- Need M

| | |
|---|---|
| sl-UE-SelectedConfigRP-r16 | SL-UE-SelectedConfigRP-r16 |

OPTIONAL, -- Need M

| | |
|---|---|
| sl-RxParametersNcell-r16 | SEQUENCE { |
| sl-TDD-Configuration-r16 | TDD-UL-DL-ConfigCommon |

OPTIONAL, -- Need M

| | |
|---|---|
| sl-SyncConfigIndex-r16 | INTEGER (0..15) |

}
OPTIONAL, -- Need M

| | |
|---|---|
| sl-ZoneConfigMCR-List-r16 | SEQUENCE (SIZE (16)) OF SL- |
| ZoneConfigMCR-r16 | OPTIONAL, -- Need M |
| sl-FilterCoefficient-r16 | FilterCoefficient |

OPTIONAL, -- Need M

| | |
|---|---|
| sl-RB-Number-r16 | INTEGER (10..275) |

OPTIONAL, -- Need M

| | |
|---|---|
| sl-PreemptionEnable-r16 | ENUMERATED {enabled, pl1, pl2, |
| pl3, pl4, pl5, pl6, pl7, pl8} | OPTIONAL, -- Need R |
| sl-PriorityThreshold-UL-URLLC-r16 | INTEGER (1..9) |

OPTIONAL, -- Need M

| | |
|---|---|
| sl-PriorityThreshold-r16 | INTEGER (1..9) |

OPTIONAL, -- Need M

| | |
|---|---|
| sl-X-Overhead-r16 | ENUMERATED {n0, n3, n6, n9} |

OPTIONAL, -- Need S

| | |
|---|---|
| sl-PowerControl-r16 | SL-PowerControl-r16 |

OPTIONAL, -- Need M

| | |
|---|---|
| sl-TxPercentageList-r16 | SL-TxPercentageList-r16 |

OPTIONAL, -- Need M

| | |
|---|---|
| sl-MinMaxMCS-List-r16 | SL-MinMaxMCS-List-r16 |

```
OPTIONAL, -- Need M
  ...,
  [[
```

| | |
|---|---|
| sl-TimeResource-r16 | BIT STRING (SIZE (10..160)) |

OPTIONAL -- Need M
]]
}
...

| | |
|---|---|
| SL-PSFCH-Config-r16 ::= | SEQUENCE { |
| sl-PSFCH-Period-r16 | ENUMERATED { sl0, sl1, sl2, |
| s14} | OPTIONAL, -- Need M |
| sl-PSFCH-RB-Set-r16 | BIT STRING (SIZE (10..275)) |

OPTIONAL, -- Need M

| | |
|---|---|
| sl-NumMuxCS-Pair-r16 | ENUMERATED {n1, n2, n3, n6} |

OPTIONAL, -- Need M

| | |
|---|---|
| sl-MinTimeGapPSFCH-r16 | ENUMERATED {sl2, sl3} |

OPTIONAL, -- Need M

| | |
|---|---|
| sl-PSFCH-HopID-r16 | INTEGER (0..1023) |

OPTIONAL, -- Need M

| | |
|---|---|
| sl-PSFCH-CandidateResourceType-r16 | ENUMERATED {startSubCH, |
| allocSubCH} | OPTIONAL, -- Need M |

...
}
...

| | |
|---|---|
| SL-PowerControl-r16 ::= | SEQUENCE { |
| sl-MaxTransPower-r16 | INTEGER (−30..33), |
| sl-Alpha-PSSCH-PSCCH-r16 | ENUMERATED {alpha0, alpha04, alpha05, |

alpha06, alpha07, alpha08, alpha09, alpha1} OPTIONAL, -- Need M

| | |
|---|---|
| dl-Alpha-PSSCH-PSCCH-r16 | ENUMERATED {alpha0, alpha04, alpha05, |

alpha06, alpha07, alpha08, alpha09, alpha1} OPTIONAL, -- Need S

| | |
|---|---|
| sl-P0-PSSCH-PSCCH-r16 | INTEGER (−16..15) |

OPTIONAL, -- Need S

| | |
|---|---|
| dl-P0-PSSCH-PSCCH-r16 | INTEGER (−16..15) |

OPTIONAL, -- Need M

| | |
|---|---|
| dl-Alpha-PSFCH-r16 | ENUMERATED {alpha0, alpha04, alpha05, |

alpha06, alpha07, alpha08, alpha09, alpha1} OPTIONAL, -- Need S

| | |
|---|---|
| dl-P0-PSFCH-r16 | INTEGER (−16..15) |

OPTIONAL, -- Need M
...
}
-- TAG-SL-RESOURCEPOOL-STOP
-- ASN1STOP

SL-ResourcePool field descriptions

. . .
sl-NumSubchannel
Indicates the number of subchannels in the corresponding resource pool,
which consists of contiguous PRBs only.
. . .
sl-RB-Number
Indicates the number of PRBs in the corresponding resource pool, which
consists of contiguous PRBs only. The remaining RB cannot be used (See
TS 38.214[19], clause 8).
sl-StartRB-Subchannel
Indicates the lowest RB index of the subchannel with the lowest index
in the resource pool with respect to the lowest RB index of a SL BWP.
sl-SubchannelSize
Indicates the minimum granularity in frequency domain for the sensing
for PSSCH resource selection in the unit of PRB.
sl-SyncAllowed
Indicates the allowed synchronization reference(s) which is (are) allowed
to use the configured resource pool.
sl-SyncConfigIndex
Indicates the synchronisation configuration that is associated with a
reception pool, by means of an index to the corresponding entry
SL-SyncConfigList of in SIB12 for NR sidelink communication.
sl-TDD-Configuration
Indicates the TDD configuration associated with the reception pool
of the cell indicated by sl-SyncConfigIndex.
. . .
sl-TimeResource
Indicates the bitmap of the resource pool, which is defined by
repeating the bitmap with a periodicity during a SFN or DFN cycle.
. . .

SL-PSFCH-Config field descriptions

sl-MinTimeGapPSFCH
The minimum time gap between PSFCH and the associated PSSCH in the
unit of slots.
sl-NumMuxCS-Pair
Indicates the number of cyclic shift pairs used for a PSFCH
transmission that can be multiplexed in a PRB.
sl-PSFCH-CandidateResourceType
Indicates the number of PSFCH resources available for multiplexing
HARQ-ACK information in a PSFCH transmission (see TS 38.213
[13], clause 16.3).
sl-PSFCH-HopID
Scrambling ID for sequence hopping of the PSFCH used in the resource
pool.
sl-PSFCH-Period
Indicates the period of PSFCH resource in the unit of slots within
this resource pool. If set to sl0, no resource for PSFCH, and HARQ
feedback for all transmissions in the resource pool is disabled.
sl-PSFCH-RB-Set
Indicates the set of PRBs that are actually used for PSFCH transmission
and reception. The leftmost bit of the bitmap refers to the lowest RB
index in the resource pool, and so on. Value 0 in the bitmap indicates
that the corresponding PRB is not used for PSFCH transmission and
reception while value 1 indicates that the corresponding PRB is
used for PSFCH transmission and reception (see TS 38.213 [13]).

SL-PowerControl field descriptions

sl-MaxTransPower
Indicates the maximum value of the UE's sidelink transmission power
on this resource pool. The unit is dBm.
sl-Alpha-PSSCH-PSCCH
Indicates alpha value for sidelink pathloss based power control for
PSCCH/PSSCH when sl-P0-PSSCH is configured. When the field is
absent the UE applies the value 1.
sl-P0-PSSCH-PSCCH
Indicates P0 value for sidelink pathloss based power control for
PSCCH/PSSCH. If not configured, sidelink pathloss based power control
is disabled for PSCCH/PSSCH.
dl-Alpha-PSSCH-PSCCH
Indicates alpha value for downlink pathloss based power control for
PSCCH/PSSCH when dl-P0-PSSCH is configured. When the field is
absent the UE applies the value 1.
dl-P0-PSSCH-PSCCH
Indicates P0 value for downlink pathloss based power control for
PSCCH/PSSCH. If not configured, downlink pathloss based power
control is disabled for PSCCH/PSSCH.
dl-Alpha-PSFCH
Indicates alpha value for downlink pathloss based power control for
PSFCH when dl-P0-PSFCH is configured. When the field is absent the
UE applies the value 1.
dl-P0-PSFCH
Indicates P0 value for downlink pathloss based power control for
PSFCH. If not configured, downlink pathloss based power control
is disabled for PSFCH.

In RAN1 #106-e meeting associated with R1-2108692, RAN1 has some agreements about NR V2X. One or more parts of R1-2108692 are quoted below:

### Agreement

For scheme 2, the following inter-UE coordination information signalling from UE-A is supported. FFS details including condition(s)/scenario(s) under which each information is enabled to be sent by UE-A and used by UE-B
Presence of expected/potential resource conflict on the resources indicated by UE-B's SCI Agreement
   In scheme 2, at least the following is supported for UE(s) to be UE-A(s)/UE-B(s) in the inter-UE coordination transmission triggered by a detection of expected/potential resource conflict(s) in Mode 2:
A UE that transmitted PSCCH/PSSCH with SCI indicating reserved resource(s) to be used for its transmission, received inter-UE coordination information from UE-A indicating expected/potential resource conflict(s) for the reserved resource(s), and uses it to determine resource re-selection is UE-B
A UE that detects expected/potential resource conflict(s) on resource(s) indicated by UE-B's SCI sends inter-UE coordination information to UE-B, subject to satisfy one of the following conditions, is UE-A
   Working assumption At least a destination UE of one of the conflicting TBs, i.e., TBs to be transmitted in the expected/potential conflicting resource(s)
      Whether a non-destination UE of a TB transmitted by UE-B can be UE-A is (pre-)configured
The above feature can be enabled or disabled or controlled by (pre-)configuration
   FFS: Details on how to support this, including (pre-)configuration signaling granularity

### Agreement

In scheme 2, the following UE-B's behavior in its resource (re)selection is supported when it receives inter-UE coordination information from UE-A:
UE-B can determine resource(s) to be re-selected based on the received coordination information
   E-B can reselect resource(s) reserved for its transmission when expected/potential resource conflict on the resource(s) is indicated

### Agreement

In scheme 2, at least the following is supported to determine inter-UE coordination information:
Among resource(s) indicated by UE-B's SCI, UE-A considers that expected/potential resource conflict occurs on the resource(s) satisfying at least one of the following condition(s):
   Condition 2-A-1:
      Other UE's reserved resource(s) identified by UE-A are fully/partially overlapping with resource(s) indicated by UE-B's SCI in time-and-frequency
      FFS: Other details (if any)
      FFS: Whether/how to specify additional criteria and other details (if any) including signaling details of conflict indication
   (Working Assumption) Condition 2-A-2:
      Resource(s) (e.g., slot(s)) where UE-A, when it is intended receiver of UE-B, does not expect to perform SL reception from UE-B due to half duplex operation
         FFS: Other details (if any)

In RAN1 #106bis-e meeting associated with R1-2110751, RAN1 has some agreements about NR V2X. One or more parts of R1-2110751 are quoted below:

### Agreement

For Scheme 2, PSFCH format 0 is used to convey the presence of expected/potential resource conflict on reserved resource(s) indicated by UE-B's SCI

### Agreement

For allocating PSFCH resources in Scheme 2, at least following can be (pre)configured separately from those for SL HARQ-ACK feedback.
Set of PRBs for PSFCH transmission/reception (sl-PSFCH-RB-Set)

### Agreement

### For Scheme 2,

Index of a PSFCH resource for inter-UE coordination information transmission is determined in the same way according to Rel-16 TS 38.213 Section 16.3 with at least following modification
   P_ID is LI-Source ID indicated by UE-B's SCI
   M_IDisO
FFS: How to set m_CS
FFS: How to set m_0
FFS: Whether M_ID can be (pre)configured

In RAN1 #107-e meeting associated with R1-2200002, RAN1 has some agreements about NR V2X. One or more parts of R1-2200002 are quoted below:

### Agreement

A resource pool level (pre-)configuration uses either of the following options
Option 1: PSFCH occasion is derived by a slot where UE-B's SCI is transmitted
   Reuse PSSCH-to-PSFCH timing as specified in TS 38.213 Section 16.3 to determine the PSFCH occasion for resource conflict indication
   Time gap between the PSFCH and a slot where expected/potential resource conflict occurs is larger than or equal to T_3
Option 2: PSFCH occasion is derived by a slot where expected/potential resource conflict occurs on PSSCH resource indicated by UE-B's SCI
   UE-A transmits the PSFCH in a latest slot that includes PSFCH resources for inter-UE coordination information and is at least T_3 slots of the resource pool before the PSSCH resource indicated by UE-B's SCI in which expected/potential resource conflict occurs
   FFS: How to account for processing timeline

### Conclusion

For Scheme 2, the values of the following parameters are the same as those for SL HARQ-ACK feedback in the same resource pool
Period of PSFCH resources (sl-PSFCH-Period)
Number of cyclic shift pairs used for a PSFCH transmission that can be multiplexed in a PRB (sl-NumMuxCS-Pair)
Number of PSFCH resources available for multiplexing information in a PSFCH transmission (sl-PSFCH-CandidateResourceType)

In RAN1 #107bis-e meeting associated with Draft Report of 3GPP TSG RAN WG1 #107bis-e v0.2.0, RAN1 has some agreements about NR Vehicle-to-Everything (V2X). One or more parts of Draft Report of 3GPP TSG RAN WG1 #107bis-e v0.2.0 are quoted below:

### Agreement

When PSFCH occasion is derived by a slot where expected/potential resource conflict occurs on PSSCH resource indicated by UE-B's SCI, time gap between the PSFCH and SCI(s) scheduling conflicting TBs is larger than or equal to X value
   X=sl-MinTimeGapPSFCH
UE does not transmit the conflict indicator or receive the conflict indicator if the timeline is not satisfied

### Agreement

For PSFCH TX/RX or TX/TX prioritization in Scheme 2,
Priority value of PSFCH TX for a resource conflict indication is the smallest priority value of the conflicting TBs
Priority value of PSFCH RX for a resource conflict indication is priority value indicated by UE-B's SCI
For PSFCH TX/RX or TX/TX prioritization between SL HARQ-ACK feedback(s) and resource conflict indication(s), PSFCH TX/RX for SL HARQ-ACK feedback is always prioritized over PSFCH TX/RX for a resource conflict indication

### Working Assumption

For Scheme 2, (pre)configuration is supported to enable or disable that 1 LSB of reserved bits of a SCI format 1-A is used to indicate of whether UE scheduling a conflict TB can be UE-B or not.

RP-213678 discusses Work Item Description (WID) on NR sidelink evolution. One or more parts of RP-213678 are quoted below:
1. Specify mechanism to support NR sidelink CA operation based on LTE sidelink CA operation [RAN2, RAN1, RAN4] (This part of the work is put on hold until further checking in RAN #97)
   Support only LTE sidelink CA features for NR (i.e., SL carrier (re-)selection, synchronization of aggregated carriers, handling the limited capability, power control for simultaneous sidelink TX, packet duplication)
   The work is limited to FR1 licensed spectrum and ITS band in FR1.
   No specific enhancements of Rel-17 sidelink features with sidelink CA support.
   This feature is backwards compatible in the following regards
      A Rel-16/Rel-17 UE can receive Rel-18 sidelink broadcast/groupcast transmissions with CA for the carrier on which it receives PSCCH/PSSCH and transmits the corresponding sidelink HARQ feedback (when SL-HARQ is enabled in SCI)

One, some and/or all of the following terminology and assumptions may be used hereafter.
Base station (BS): a network central unit and/or a network node in New Radio (NR) that is used to control one or more Transmission and/or Reception Points (TRPs) which are associated with one or more cells. Communication between a base station and one or more TRPs may be via fronthaul. Base station may be referred to as central unit (CU), eNB, gNB, and/or NodeB.
Cell: a cell comprises one or more associated TRPs (e.g., coverage of the cell may comprise coverage of some and/or all associated TRP(s)). One cell may be controlled by one base station. Cell may be referred to as TRP group (TRPG).
Slot: a slot is a scheduling unit in NR. A slot duration (e.g., a duration of a slot) may be 14 Orthogonal Frequency Division Multiplexing (OFDM) symbols.

In NR Release 16 (NR Rel-16) and/or NR Release 17 (NR Rel-17), sidelink communication is designed for and/or performed in a carrier/cell (from UE's perspective, for example). For example, a UE may perform sidelink transmissions in one sidelink Bandwidth Part (BWP) of one carrier/cell (e.g., the UE may perform sidelink transmission in only the one sidelink BWP of the one carrier/cell). In the present disclosure, the term “carrier/cell” may correspond to a carrier and/or a cell. In some examples, there are at least two sidelink resource allocation modes designed for NR sidelink communication such as discussed in a 3rd Generation Partnership Project (3GPP) 3GPP Technical Specification (TS) (3GPP TS 38.214 V17.0.0): (i) in Mode 1 (e.g., NR sidelink resource allocation mode 1), a base station (e.g., a network node) can schedule one or more sidelink transmission resources to be used by a transmitter User Equipment (UE) (TX UE) for one or more sidelink transmissions, and/or (ii) in mode 2 (e.g., NR sidelink resource allocation mode 1), a TX UE determines (e.g., a base station does not schedule) one or more sidelink transmission resources within a sidelink resource pool, wherein the sidelink resource pool is configured by a base station (e.g., network node) and/or is pre-configured.

For network scheduling mode (e.g., NR sidelink resource allocation mode 1), the network node may transmit a sidelink (SL) grant on Uu interface for scheduling resources of Physical Sidelink Control Channel (PSCCH) and/or Physical Sidelink Shared Channel (PSSCH). In response to receiving the sidelink grant, the TX UE may perform PSCCH transmissions and/or PSSCH transmissions on PC5 interface. The Uu interface corresponds to a wireless interface for communication between network and the TX UE. The PC5 interface corresponds to a wireless interface for communication between (e.g., directly between) UEs and/or devices.

For UE selection mode (e.g., NR sidelink resource allocation mode 2), since transmission resources are not scheduled by a network, the TX UE may be required to perform sensing before selecting a resource for transmission (e.g., the TX UE may perform sensing-based transmission) in order to avoid resource collision and interference with (e.g., from or to) other UEs. When sensing-based resource selection is triggered (and/or requested) for a data packet, the UE can determine a valid/identified resource set based on sensing results (e.g., the valid/identified resource set may be a resource set that is identified by the UE and/or determined to be valid by the UE). The valid/identified resource set may be reported to higher layers (e.g., higher layers of the TX UE, such as MAC layer of the TX UE). The TX UE (e.g., the higher layers of the TX UE) may select (e.g., randomly select) one or more valid/identified resources from the valid/identified resource set. The TX UE may utilized the one or more valid/identified resources to perform one or more sidelink transmissions for transmitting the data packet. The one or more sidelink transmissions from the TX UE may comprise PSCCH transmission and/or PSSCH transmission.

In NR Rel-16 sidelink and/or NR Rel-17 sidelink, a sidelink control information (SCI) can indicate/allocate/schedule at most three sidelink resources, e.g., PSSCH resources, for a same Transport Block (TB), e.g., via Frequency resource assignment field and Time resource assignment field in the SCI. The first/initial one of the at most three PSSCH resources and the SCI are in the same sidelink slot. The SCI may comprise a 1st stage SCI (i.e. SCI format 1-A) and a 2nd stage SCI (i.e. SCI format 2-A or SCI format 2-B or SCI format 2-C). The 1st stage SCI may be transmitted via PSCCH. The 2nd stage SCI may be transmitted via multiplexed with the indicated/allocated/scheduled PSSCH in the same sidelink slot. In other words, the SCI can indicate/allocate/schedule at most two PSSCH resources, for the same TB, in later sidelink slots in a same sidelink resource pool.

Moreover, resource reservation for another TB by a SCI may be configured (e.g., pre-configured) with enabled or not enabled or not configured in a sidelink resource pool. For example, a sidelink resource pool may be configured (e.g., pre-configured) with enabled resource reservation for a second TB (e.g., a TB different than the same TB) by a SCI. Alternatively and/or additionally, the resource reservation for the second TB may be enabled for the sidelink resource pool (e.g., a resource reservation configuration associated with the sidelink resource pool may enable the resource reservation for the second TB). Alternatively and/or additionally, a resource reservation for the second TB may not be enabled in the sidelink resource pool (e.g., a resource reservation configuration associated with the sidelink resource pool may not enable the resource reservation for the second TB). Alternatively and/or additionally, the sidelink resource pool may not be configured with resource reservation for the second TB by a SCI. When a sidelink resource pool is configured with the resource reservation for the second TB (and/or when the resource reservation is enabled for the sidelink resource pool), the sidelink resource pool is configured with a set of reservation period values. In an example, the set of reservation period values (e.g., a set of one or more reservation period values) may comprise 0 milliseconds, 1:99 milliseconds (e.g., a value in the range of at least 1 millisecond to at most 99 milliseconds, 100 milliseconds, 200 milliseconds, 300 milliseconds, 400 milliseconds, 500 milliseconds, 600 milliseconds, 700 milliseconds, 800 milliseconds, 900 milliseconds, and/or 1000 milliseconds. In some examples, a resource reservation period field in a SCI in the sidelink resource pool may indicate one or more reservation period values for one or more resource reservations (e.g., the resource reservation period field may be indicative of which reservation period value to use for a future resource reservation). In some examples, a size of the set of reservation period values (e.g., a number of values of the set of reservation period values) may be from 1 to 16 (e.g., the set of reservation period values may comprise at most 16 reservation period values).

For NR Rel-16 sidelink and/or NR Rel-17 sidelink, Physical Sidelink Feedback Channel (PSFCH) is designed and/or utilized for transmitting sidelink Hybrid Automatic Repeat Request-Acknowledgement (HARQ-ACK) feedback. For a sidelink resource pool, PSFCH resources may be configured (e.g., pre-configured) periodically with a period of N sidelink slots associated with the sidelink resource pool. Accordingly, PSCCH/PSSCH transmissions in N contiguous (e.g., consecutive) sidelink slots may be associated with PSFCH resources in a same slot. In the present disclosure, the term “PSCCH/PSSCH transmissions” may refer to transmissions comprising one or more PSCCH transmissions and/or one or more PSSCH transmissions. The association (e.g., timing association) between the PSCCH/PSSCH transmissions and the PSFCH resources may be determined (e.g., derived) based on (e.g., considering) a minimum time gap of K slots. The value of K may be configured for the sidelink resource pool. The K slots may be relevant to requirement process time comprising PSCCH/PSSCH reception and decoding and PSFCH generation. In the present disclosure, the term “PSCCH/PSSCH reception” may refer to one or more receptions comprising one or more PSCCH receptions and/or one or more PSSCH receptions. For separate PSCCH/PSSCH transmissions in different sidelink slots, if PSFCH resources associated with the separate PSCCH/PSSCH transmissions are in the same slot, the associated PSFCH resources may be frequency-division multiplexed (FDMed). For separate PSCCH/PSSCH transmissions with different starting sub-channels in the same sidelink slot, if PSFCH resources associated with the separate PSCCH/PSSCH transmissions are in the same slot, the associated PSFCH resources may be FDMed. For separate PSSCH transmissions with non-overlapped sub-channels in the same sidelink slot, if PSFCH resources associated with the separate PSCCH/PSSCH transmissions are in the same slot, the associated PSFCH resources may be FDMed. In some examples, for a PSCCH/PSSCH transmission, one or more PSFCH resources can be determined (e.g., derived) based on a starting sub-channel or one or more full sub-channels of an associated PSSCH transmission and a sidelink slot of an associated PSCCH/PSSCH transmission. A receiver UE receiving the PSCCH/PSSCH transmission may determine (e.g., derive) a PSFCH resource, from the one or more PSFCH resources, for transmitting sidelink HARQ-ACK feedback associated with the PSCCH/PSSCH transmission.

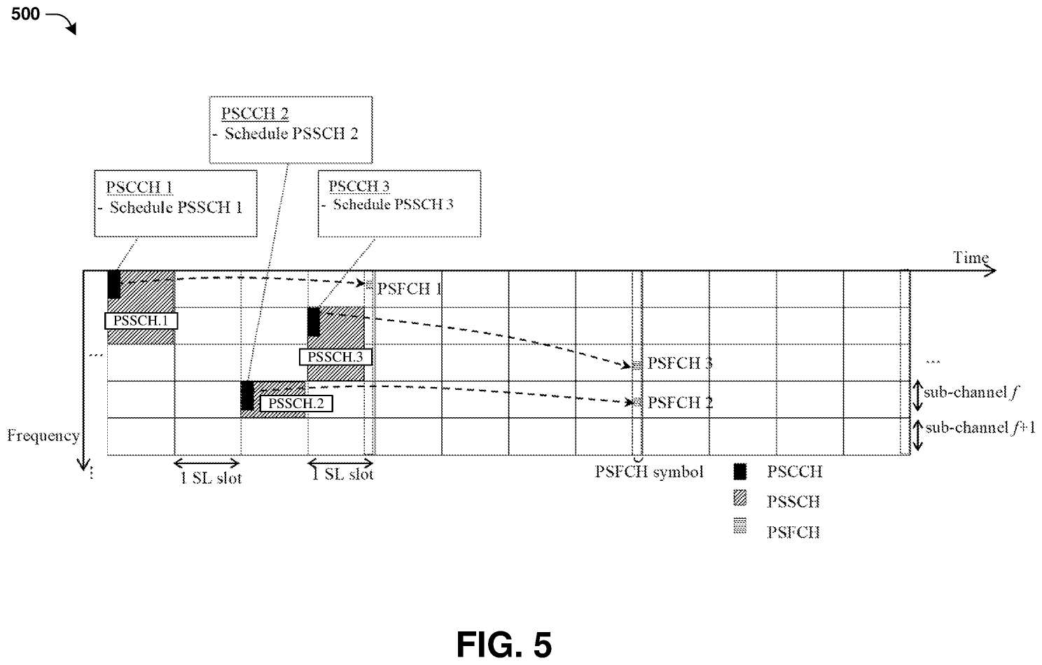

FIG. 5 illustrates an example scenario 500 associated with PSSCH transmissions comprising PSSCH 1, PSSCH 2, and PSSCH 3. For each of the PSSCH transmissions, an associated PSCCH schedules a PSSCH resource of the PSSCH transmission, and one or more PSFCH resources associated with the PSSCH transmission can be determined (e.g., derived) based on a starting sub-channel of the PSSCH transmission, one or more full sub-channels of the PSSCH transmission, a sidelink slot of a PSCCH resource of the PSCCH transmission and/or a sidelink slot of a PSSCH resource of the PSSCH transmission. For example, PSCCH 1 schedules a resource of PSSCH 1, and a resource of PSFCH 1 is associated with a resource of PSSCH 1 and/or a resource of PSCCH 1 (e.g., the resource of PSFCH 1 is based on the resource of PSSCH 1 and/or the resource of PSCCH 1). Alternatively and/or additionally, PSCCH 2 schedules a resource of PSSCH 2, and a resource of PSFCH 2 is associated with a resource of PSSCH 2 and/or a resource of PSCCH 2 (e.g., the resource of PSFCH 2 is based on the resource of PSSCH 2 and/or the resource of PSCCH 2). Alternatively and/or additionally, PSCCH 3 schedules a resource of PSSCH 3, and a resource of PSFCH 3 is associated with a resource of PSSCH 3 and/or a resource of PSCCH 3 (e.g., the resource of PSFCH 3 is based on the resource of PSSCH 3 and/or the resource of PSCCH 3). In some examples, the PSSCH 1 is transmitted from a transmitting device for delivering a data packet. A receiving device may receive the PSSCH 1 for acquiring the data packet from the transmitting device. The PSSCH 1 may be indicated as sidelink HARQ-ACK enabled (e.g., the PSSCH 1 may indicate that sidelink HARQ-ACK is enabled for transmitting feedback based on the PSSCH 1). The receiving device may transmit sidelink HARQ-ACK feedback, via the PSFCH 1, to the transmitting device to indicate whether or not the data packet is decoded successfully. The transmitting device may perform sidelink retransmission for delivering the same data packet if the transmitting device detects/receives the sidelink HARQ-ACK feedback as Negative Acknowledgement (NACK) and/or Discontinuous Transmission (DTX) (e.g., the transmitting device may perform sidelink retransmission for delivering the same data packet if the sidelink HARQ-ACK feedback is indicative of NACK and/or DTX). The transmitting device may not perform sidelink retransmission for delivering the same data packet if the transmitting device detects/receives the sidelink HARQ-ACK feedback as ACK (e.g., the transmitting device may not perform sidelink retransmission for delivering the same data packet if the sidelink HARQ-ACK feedback is indicative of ACK). In the present disclosure, the term “detects/receives” may refer to detects and/or receives.

The PSFCH transmit power (e.g., transmit power of a PSFCH transmission, such as PSFCH transmission with HARQ-ACK feedback) can be determined (e.g., derived) based on Downlink (DL) pathloss if dl-P0-PSFCH is provided, or determined based on maximum UE transmit power (noted as P_{CMAX}) if dl-P0-PSFCH is not provided. In some examples, for NR Rel-16 sidelink, transmit power derivation based on SL pathloss is not supported for PSFCH. Alternatively and/or additionally, a UE may be capable of transmitting a maximum of N_{max,PSFCH} PSFCHs at the same time, e.g., UE may be capable of transmitting a maximum of N_{max,PSFCH} PSFCHs in one PSFCH occasion/symbol. In the present disclosure, the term “occasion/symbol” may refer to an occasion and/or a symbol. In some examples, N_{max,PSFCH} may be 4, 8, or 16 depending on UE transmission capability.

Based on 3GPP TS 38.213 V17.0.0, if the UE has N_{sch,TX,PSFCH} scheduled PSFCH transmissions in one PSFCH occasion, the UE will determine to transmit N_{TX,PSFCH} PSFCHs corresponding to the smallest N_{TX},P_{SFC}H priority field values indicated in Sidelink Control Information (SCI) formats 1-A (e.g., all SCI formats 1-A) associated with the PSFCH transmission occasion. Accordingly, a priority (e.g., a priority value) of a PSFCH transmission is associated with (e.g., determined based on and/or indicated by) a priority field value indicated in a SCI format 1-A, wherein the PSFCH transmission is associated with the SCI format 1-A. In some examples, the PSFCH transmission is utilized for transmitting sidelink HARQ-ACK feedback of a PSSCH reception scheduled by the SCI format 1-A. In some examples, the UE autonomously selects the N_{Tx,PSFCH} PSFCHs, from the N_{sch,Tx,PSFCH} scheduled PSFCH transmissions, with ascending priority value order. For example, a smaller priority value may indicate a higher priority (e.g., priority value 1 corresponds to a highest priority while priority value 8 corresponds to a lowest priority). In some examples, N_{TX,PSFCH} is smaller than or equal to N_{max,PSFCH}.

In some examples, in the one PSFCH occasion, the UE will transmit the N_{Tx,PSFCH} PSFCHs with the same PSFCH transmit power (e.g., PSFCH transmit powers of the N_{Tx,PSFCH} PSFCHs are equal to each other). If dl-P0-PSFCH is provided, transmit power of each PSFCH transmission (of the N_{Tx,PSFCH} PSFCHs) may be determined to be min(P_{CMAX}−10 log₁₀(N_{TX,PSFCH}), P_{PSFCH,one}), wherein P_{PSFCH,one} is a transmit power value determined (e.g., derived) based on DL pathloss. If dl-P0-PSFCH is not provided, transmit power of each PSFCH transmission (of the N_{Tx,PSFCH} PSFCHs) may be determined to be P_{CMAX}−10 log₁₀(N_{TX,PSFCH}).

In sidelink communication, such as NR Rel-17 sidelink communication, inter-UE coordination may be supported and/or studied for enhancing reliability and reducing latency in mode 2 (e.g., NR sidelink resource allocation mode 2). For inter-UE coordination scheme 2, coordination information may be sent from a first UE (e.g., UE-A) to a second UE (e.g., UE-B), and may indicate the presence of expected and/or potential resource conflict on the resources indicated by the second UE's (e.g., UE-B's) SCI. To transmit the inter-UE coordination information, PSFCH format 0 may be used to convey the information of the presence of expected and/or potential resource conflict on one or more reserved resources indicated by the second UE's (e.g., UE-B's) SCI. For example, the inter-UE coordination information transmission may have the same channel structure and/or format as PSFCH for sidelink HARQ-ACK feedback. The PSFCH occasion for the inter-UE coordination information may be derived by a slot where the second UE's (e.g., UE-B's) SCI is transmitted, and/or may be derived by a slot where expected and/or potential resource conflict occurs on PSSCH resource indicated by the second UE's (e.g., UE-B's) SCI. For allocating PSFCH resources for the inter-UE coordination information in Scheme 2, a set of Physical Resource Blocks (PRBs) for PSFCH transmission/reception may be configured (e.g., pre-configured) separately from one or more PRBs for sidelink HARQ-ACK feedback. For example, for a sidelink resource pool, one or more PSFCH resources (e.g., a set of PSFCH resources) used for the inter-UE coordination information may be FDMed with one or more PSFCH resources (e.g., a set of PSFCH resources) used for sidelink HARQ-ACK feedback. Alternatively and/or additionally, for a sidelink slot of a sidelink resource pool, one or more PSFCH resources (e.g., a set of PSFCH resources) used for the inter-UE coordination information may be in the same OFDM symbols with one or more PSFCH resources (e.g., a set of PSFCH resources) used for sidelink HARQ-ACK feedback.

In sidelink evolution, such as NR Rel-18 sidelink evolution (e.g., discussed in RP-213678), sidelink carrier aggregation (CA) operation may be supported and/or studied. A UE may be configured with one carrier/cell and/or more than one carrier/cell to operate sidelink communication. For a sidelink data packet to be transmitted, a UE in mode 2 (e.g., NR sidelink resource allocation mode 2) may select a sidelink carrier/cell and/or may select one or more sidelink data and/or control resources (e.g., one or more PSSCH resources and/or one or more PSCCH resources) in one sidelink resource pool in the selected sidelink carrier/cell. For a sidelink data packet to be transmitted, a UE in mode 1 (e.g., NR sidelink resource allocation mode 1) may receive a sidelink grant which indicates a sidelink carrier/cell and allocate one or more sidelink data and/or control resources in one sidelink resource pool in the indicated sidelink carrier/cell. Since the UE may have multiple sidelink data packets and/or multiple sidelink connections with one or more other UEs, the UE may simultaneously (e.g., concurrently) perform multiple sidelink data transmissions (e.g., multiple PSSCH transmissions) in multiple sidelink carrier/cells (respectively, for example). In some examples, for a UE, at most one sidelink data transmission may be allowed in one sidelink carrier/cell at a timing, such that more than one sidelink data transmissions at a timing may not be allowed in one sidelink carrier/cell. If the total transmit power of the multiple sidelink data transmissions is determined to and/or predicted to exceed a maximum UE transmit power, the UE may drop some of the multiple sidelink data transmissions depending on priority order of the multiple sidelink data transmissions (e.g., if the rule of UL transmit power prioritization/reduction in 3GPP TS 38.213 V17.0.0 is applied similarly). In some examples, the UE may have sidelink data transmissions PSSCH 1-5 with respective priority value P1˜P5 (assuming P1<P2=P3<P4<P5) respectively in sidelink carrier/cell C1˜C5 at a timing, wherein the total transmit power of PSSCH 1˜5 may exceed the maximum UE transmit power. In some examples, the UE may drop PSSCH 4 and PSSCH 5 such that total transmit power of PSSCH 1˜3 may not exceed the maximum UE transmit power, wherein total transmit power of PSSCH 1˜4 may still exceed the maximum UE transmit power. In some examples, the UE may drop PSSCH 4˜5 and also drop PSSCH 3 such that the total transmit power of PSSCH 1˜2 may not exceed the maximum UE transmit power, wherein total transmit power of PSSCH 1˜3 may still exceed the maximum UE transmit power and sidelink carrier C2 may be a primary cell, a cell configured to transmit Physical Uplink Control Channel (PUCCH), and/or a non-supplementary UL carrier. Alternatively and/or additionally, the UE may drop some of the multiple sidelink data transmissions due to a limited TX capability. For example, the UE may drop some of the multiple sidelink data transmissions depending on a priority order of the multiple sidelink data transmissions and/or UE implementation. The limited TX capability may correspond to one or more limitations in the number of simultaneous transmission carriers, one or more limitations in the supported carrier combinations, and/or one or more limitations in interruptions for Radio Frequency (RF) retuning time. For example, the limited TX capability may mean that the UE cannot support one or more sidelink and/or uplink (UL) transmissions over one or more carrier/cell(s) in a slot due to one or more of (a) a number of TX chains being smaller than the number of configured TX carrier/cells, (b) the UE not supporting the given frequency band combination, (c) a TX chain switching time, and/or (d) the UE being unable to fulfill the RF requirement due to one or more reasons such as packet-switched data (PSD) imbalance.

In some examples, PSFCH may be introduced and/or designed for transmitting sidelink HARQ-ACK feedback and/or inter-UE coordination information from NR Rel-16/17 sidelink, and in sidelink carrier aggregation operation, issues on maximum UE transmit power and/or limited TX capability may also occur on multiple sidelink feedback transmissions (e.g., multiple PSFCH transmissions) in multiple sidelink carrier/cells (respectively, for example). However, there may be some differences on power determination and/or derivation between PSSCH and PSFCH. In some examples, for a UE, at most N_{max,PSFCH} PSFCH transmissions can be allowed in one sidelink carrier/cell at a timing. In some examples, in one PSFCH occasion in one sidelink carrier/cell, the UE may transmit N_{TX,PSFCH} PSFCHs (N_{TX,PSFCH}≤N_{max,PSFCH}) with the same/equal PSFCH transmit power. According to 3GPP TS 38.213 V17.0.0, the same/equal PSFCH transmit power of each PSFCH transmission (e. g., P_{PSFCH,k}, 1≤k≤N_{TX,PSFCH}) may be evenly divided/shared from the maximum UE transmit power (e.g., P_{PSFCH,k}=P_{CMAX}−10 log₁₀(N_{Tx,PSFCH})) and/or a PSFCH transmit power derived band on a DL pathloss (e.g., P_{PSFCH,k}=P_{PSFCH,one}). In some examples, such PSFCH power differences and also channel condition/attenuation differences in separate sidelink carrier/cells (e.g., different DL pathloss, P0 values and/or alpha values for separate sidelink carrier/cells) may prompt challenges and/or questions regarding how to handle the issues on maximum UE transmit power and/or limited TX capability for PSFCH transmission in sidelink carrier aggregation operation. The challenges and/or questions may include how to determine the number of allowed PSFCH transmissions in separate sidelink carriers/cells, and/or how to determine and/or derive transmit power of each allowed PSFCH transmission in separate sidelink carriers/cells, for example.

To address challenges and/or issues, including those in the aforementioned discussion, one or more concepts, mechanisms, methods and/or embodiments are presented herein.

In some examples, a first UE may have one or more configurations (e.g., pre-configurations) of a plurality of carriers/cells, which may be utilized for sidelink communication. The plurality of carriers/cells may be activated, and/or may be all or part of configured carrier/cells for the first UE. In some examples, for each of the plurality of carriers/cells, the first UE may be capable of simultaneously transmitting a corresponding maximum number of sidelink feedback transmissions. The maximum number of sidelink feedback transmissions that the first UE may be capable of simultaneously transmitting may be the same for different carriers/cells, or may be different.

In a TTI and/or occasion, the first UE may have a plurality of (scheduled and/or requested) sidelink feedback transmissions on the plurality of carriers/cells. In some examples, the plurality of (scheduled and/or requested) sidelink feedback transmissions may be partially or fully overlapped in time domain. For example, in a symbol (e.g., a time symbol), the first UE may have the plurality of (scheduled and/or requested) sidelink feedback transmissions on the plurality of carriers/cells. For each of the plurality of carriers/cells, the first UE may have one or more (scheduled and/or requested) sidelink feedback transmissions among the plurality of (scheduled and/or requested) sidelink feedback transmissions. The plurality of (scheduled and/or requested) sidelink feedback transmissions may comprise sidelink feedback transmissions for same or different usage, and/or may comprise PSFCH and/or inter-UE coordination information.

In some examples, for one (scheduled and/or requested) sidelink feedback transmission in one sidelink resource pool on one carrier/cell, the first UE may determine and/or derive one power value. When a P0 value and/or an alpha value is provided (e.g., configured for the one sidelink resource pool), the first UE may determine and/or derive the one power value based on the P0 value, the alpha value, and/or a DL pathloss value derived/determined on the one carrier/cell.

Concept A

The first UE may select, prioritize and/or determine a set of sidelink feedback transmissions from the plurality of (scheduled and/or requested) sidelink feedback transmissions. The first UE may transmit the set of sidelink feedback transmissions, and/or may drop, exclude and/or not transmit one or more non-selected/non-prioritized/non-determined sidelink feedback transmissions among the plurality of (scheduled and/or requested) sidelink feedback transmissions.

In concept A, the first UE may select, prioritize and/or determine the set of sidelink feedback transmissions, based on any combination of the techniques and/or subject matter described in the following discussion.

For a first carrier/cell among the plurality of carriers/cells, the first UE may have first one or more (scheduled and/or requested) sidelink feedback transmissions among the plurality of (scheduled and/or requested) sidelink feedback transmissions. In one embodiment, when total number of the first one or more of (scheduled and/or requested) sidelink feedback transmissions may exceed and/or is determined to and/or predicted to exceed a (first) carrier/cell-specific maximum number, the first UE may select, prioritize and/or determine a first set of sidelink feedback transmissions, wherein the number and/or cardinality of the first set of sidelink feedback transmissions may be smaller than or equal to the (first) carrier/cell-specific maximum number. In some examples, the set of sidelink feedback transmissions may comprise the first set of sidelink feedback transmissions. For example, the first UE may select, prioritize and/or determine the first set of sidelink feedback transmissions determined to satisfy a condition that the number and/or cardinality of the first set of sidelink feedback transmissions is smaller than or equal to the (first) carrier/cell-specific maximum number.

In some examples, the first UE may select, prioritize and/or determine the first set of sidelink feedback transmissions according to and/or based on ascending priority value order of each of the first one or more (scheduled and/or requested) sidelink feedback transmissions. For example, the first UE may firstly select, prioritize and/or determine a sidelink feedback transmission determined to have a smaller priority value into the first set of sidelink feedback transmissions than the one or more non-selected/non-prioritized/non-determined sidelink feedback transmissions among the first one or more (scheduled and/or requested) sidelink feedback transmissions. The first UE may drop and/or exclude one or more sidelink feedback transmissions according to and/or based on descending priority value order of each of the first one or more (scheduled and/or requested) sidelink feedback transmissions. For example, the one or more non-selected/non-prioritized/non-determined sidelink feedback transmissions among the first one or more (scheduled and/or requested) sidelink feedback transmissions may have a larger priority value than the first set of sidelink feedback transmissions.

In some examples, when a total number of the plurality of (scheduled and/or requested) sidelink feedback transmissions may exceed and/or is determined to and/or predicted to exceed a UE-specific maximum number, the first UE may select, prioritize and/or determine the set of sidelink feedback transmissions, wherein the number and/or cardinality of the set of sidelink feedback transmissions may be smaller than or equal to the UE-specific maximum number. For example, the first UE may select, prioritize and/or determine the set of sidelink feedback transmissions determined to satisfy a condition that the number and/or cardinality of the set of sidelink feedback transmissions is smaller than or equal to the UE-specific maximum number.

In some examples, the set of sidelink feedback transmissions may be selected, prioritized and/or determined to satisfy a carrier/cell-specific maximum number embodiment, condition and/or restriction for each of the plurality of carriers/cells, and/or may be determined to satisfy power-related embodiments/conditions/restrictions, and/or may be determined to satisfy limited TX capability-related embodiments, conditions and/or restrictions.

In some examples, the first UE may select, prioritize and/or determine the set of sidelink feedback transmissions according to and/or based on ascending priority value order of each of the plurality of (scheduled and/or requested) sidelink feedback transmissions. For example, the first UE may initially select, prioritize and/or determine, for inclusion in the set of sidelink feedback transmissions, a sidelink feedback transmission with a smaller priority value than the non-selected, non-prioritized and/or non-determined sidelink feedback transmissions at least in the same carrier/cell. Alternatively and/or additionally, the first UE may drop and/or exclude one or more sidelink feedback transmissions according to and/or based on descending priority value order of each of the plurality of (scheduled and/or requested) sidelink feedback transmissions. For example, the non-selected, non-prioritized and/or non-determined sidelink feedback transmissions may be determined to have a larger priority value than the set of sidelink feedback transmissions.

In some examples, the first UE may select, prioritize and/or determine the set of sidelink feedback transmissions determined to satisfy a condition that the set of sidelink feedback transmissions is on a set of carriers/cells among the plurality of carriers/cells. For example, the first UE may select, prioritize and/or determine the set of sidelink feedback transmissions on the set of carriers/cells determined to satisfy a condition of limited TX capability. The first UE may drop and/or exclude or not transmit one or more (and/or all, for example) sidelink feedback transmissions on a third carrier/cell of the plurality of carriers/cells, due to limited TX capability, when the third carrier/cell is not in the set of carriers/cells. For example, due to limited TX capability, the first UE may support and/or be able to transmit the set of sidelink feedback transmissions on the set of carriers/cells. However, in some examples, the first UE may not support and/or may not be able to simultaneously transmit the set of sidelink feedback transmissions on the set of carriers/cells and/or any sidelink feedback transmission(s) on the third carrier/cell.

In some examples, the first UE may select, prioritize and/or determine sidelink feedback transmission(s), from the plurality of (scheduled and/or requested) sidelink feedback transmissions, according to and/or based on an ascending priority value order of each of the plurality of (scheduled and/or requested) sidelink feedback transmissions and/or according to and/or based on a limited TX capability given and/or induced by one or more already selected, prioritized and/or determined sidelink feedback transmissions. The first UE may drop and/or exclude one or more sidelink feedback transmissions that are determined to not satisfy the condition of limited TX capability (from among the one or more already selected, prioritized and/or determined sidelink feedback transmissions, for example). For example, the UE may have sidelink feedback transmissions PSFCH 1˜5 with respective priority value P1˜P5 in sidelink carrier/cell C1˜C3 at a timing, wherein assuming P1<P2<P3<P4<P5, PSFCH 1 and 5 is on sidelink carrier/cell C1, PSFCH 2 and PSFCH 4 may be on sidelink carrier/cell C2, and/or PSFCH 3 may be on sidelink carrier/cell C3. The UE may initially select, prioritize and/or determine PSFCH 1 on C1 and PSFCH 2 on C2. The UE may not select, prioritize and/or determine PSFCH 3 on C3 due to limited TX capability (on C1, C2, C3), for example. Then, the UE may select, prioritize and/or determine PSFCH 4 on C2 and/or may not select, prioritize and/or determine PSFCH 5 on C1, in cases where a that total sidelink transmit power of PSSCH 1, 2, 4 may not exceed the maximum UE transmit power, and/or a total sidelink transmit power of PSSCH 1, 2, 4, 5 may exceed the maximum UE transmit power.

In some examples, a limited TX capability may correspond to simultaneous sidelink transmissions on two or more carriers/cells and/or simultaneous sidelink transmissions on a specific and/or configured number of carriers/cells (e.g., a maximum number of carriers/cells). For example, priority for each carrier/cell may be based on lowest priority value of sidelink (feedback) transmissions among the plurality of sidelink transmissions. Priority for each carrier/cell may be based on a lowest priority value of one or more sidelink (feedback) transmissions among one or more sidelink (feedback) transmissions in each carrier/cell. When the first UE selects, prioritizes and/or determines the set of carriers/cells (for satisfying a limited TX capability), the first UE may prioritize based on the priority for each carrier/cell, for example.

In some examples, the first UE may select, prioritize and/or determine the set of sidelink feedback transmissions, wherein the set of sidelink feedback transmissions may comprise a subset of sidelink feedback transmissions with priority values smaller than or equal to a value K. For example, each and/or any sidelink feedback transmission, in the set of sidelink feedback transmissions, with priority value smaller than or equal to K may be included, comprised, selected and/or determined for the subset. In some examples, the K may be a largest value such that summation of specific power values of the subset of sidelink feedback transmissions (with priority value smaller than or equal to the value K) may be smaller than or equal to the maximum UE transmit power, noted as P_{CMAX}. In some examples, if there are remaining sidelink feedback transmissions (of the plurality of sidelink feedback transmissions) with priority values larger than K, summation of one or more specific power values of one, some and/or all sidelink feedback transmissions with priority value smaller than or equal to the value (K+1) will be larger than the maximum UE transmit power, noted as P_{CMAX}. In some examples, using the subset of sidelink feedback transmissions with priority values smaller than or equal to the value K may be applied and/or performed when summation of specific power values of the plurality of (scheduled and/or requested) sidelink feedback transmissions may exceed and/or may be determined to and/or predicted to exceed a maximum UE transmit power (of a carrier/cell or of UE). In some examples, using the subset of sidelink feedback transmissions with priority values smaller than or equal to the value K may be applied and/or performed when total sidelink transmit powers of the plurality of (scheduled and/or requested) sidelink feedback transmissions may exceed and/or may be determined to and/or predicted to exceed maximum UE transmit power (of a carrier/cell or of UE).

In some examples, the specific power value (noted as Pₒₙₑ) may be a power value derived and/or determined based on pathloss. For example, for one sidelink feedback transmission in one sidelink resource pool on one carrier/cell, the first UE may derive and/or determine the one power value based on a DL pathloss value derived and/or determined on the one carrier/cell (when DL pathloss based sidelink power control is enabled and/or applied, for example). Alternatively and/or additionally, the first UE may derive and/or determine the one power value based on a SL pathloss value (when SL pathloss based sidelink power control is enabled and/or applied, for example). The first UE may derive and/or determine the one power value, based on a P0 value and/or an alpha value, when and/or if the P0 value and/or the alpha value is provided (for the one sidelink resource pool, the one carrier/cell and/or the first UE, for example).

Alternatively and/or additionally, when a DL pathloss based sidelink power control is not applied and/or is disabled, and/or when a SL pathloss based sidelink power control is not applied and/or is disabled, the specific power value may be a power value derived and/or determined based on maximum UE transmit power (noted as P_{CMAX}) and/or maximum UE transmit power of a carrier/cell (noted as P_{CMAX,c}). The specific power value may be derived and/or determined based on a carrier/cell-specific maximum number (noted as N_{max,Tx,c}), and/or may be derived and/or determined based on a configured (carrier/cell-specific) number (noted as N_{configured,Tx,c}). For example, for one sidelink feedback transmission in one sidelink resource pool on one carrier/cell C1, the power value based on maximum UE transmit power may be P_{CMAX}−10 log₁₀ (N_{max,TX,c1}) or P_{CMAX}−10 log₁₀o(N_{configured,TX,c1}). For example, for one sidelink feedback transmission in one sidelink resource pool on one carrier/cell C1, the power value based on a maximum UE transmit power of a carrier/cell may be P_{CMAX,c1}−10 log₁₀(N_{max,TX,c1}) or P_{CMAX,c1}−10 log₁₀(N_{configured,Tx,c1}).

In some examples, when DL pathloss based sidelink power control is not applied and/or is disabled, and/or when SL pathloss based sidelink power control is not applied or is disabled, the specific power value may be a configured (e.g., guarantee) power value (noted as P_{one,guarantee}), which may, for example, be configured for a sidelink resource pool, for a carrier/cell and/or for the first UE.

In some examples, the specific power value may be derived and/or determined according to one or more of the power value based on pathloss, the configured (e.g., guarantee) power value, and/or the power value based on maximum UE transmit power (noted as P_{CMAX}) and/or maximum UE transmit power of a carrier/cell (noted as P_{CMAX,c}). For example, for one sidelink feedback transmission in one sidelink resource pool on one carrier/cell C1, the specific power value may be one or more of min(P_{CMAX}−10 log₁₀(N_{max,TX,c1}), Pₒₙₑ), min(P_{CMAX}−10 log₁₀(N_{configured,TX,c1}), Pₒₙₑ), min(P_{CMAX,c1}−10 log₁₀(N_{max,TX,c1}), Pₒₙₑ), min(P_{CMAX,c1}−10 log₁₀(N_{configured,Tx,c1}), Pₒₙₑ), min(P_{CMAX}−10 log₁₀(N_{max,TX,c1}), P_{one,guarantee}, Pₒₙₑ), min(P_{CMAX,c1}−10 log₁₀(N_{max,Tx,c1}), P_{one,guarantee}, Pₒₙₑ), and/or min(P_{one,guarantee}, Pₒₙₑ).

In some examples, the first UE may allocate, distribute and/or determine a carrier/cell-specific power budget/headroom (e.g., noted as P_{budget,c1}) for the set of carrier/cells. For example, the maximum UE transmit power of the carrier/cell may be replaced, represented and/or changed as the carrier/cell-specific power budget/headroom. The power value, based on the maximum UE transmit power of the carrier/cell, may be replaced, represented and/or changed as the power value based on the carrier/cell-specific power budget/headroom, e.g., P_{budget,c1}−10 log₁₀(N_{max,TX,c1}) and/or P_{budget,c1}−10 log₁₀(N_{configured,TX,c1}). The carrier/cell-specific power budget/headroom may be derived and/or determined based a carrier/cell-specific ratio and/or the maximum UE transmit power, e.g., P_{budget,c1}=r_{budget,c1}·P_{CMAX}. For example, the carrier/cell-specific power budget/headroom and/or the carrier/cell-specific ratio may be configured, varied, derived and/or determined based on a carrier/cell distribution of the set of sidelink feedback transmission.

In some examples, the set of sidelink feedback transmissions may not comprise one or more and/or any sidelink feedback transmissions with priority values larger than (K+1). The first UE may drop and/or exclude one or more and/or any sidelink feedback transmissions with priority values larger than (K+1), for example.

In some examples, the set of sidelink feedback transmissions may not comprise one or more and/or any sidelink feedback transmissions with priority values equal to (K+1). In some examples, the set of sidelink feedback transmissions may comprise one or more and/or some sidelink feedback transmissions with priority values equal to (K+1), such that the set of sidelink feedback transmissions may comprise the some sidelink feedback transmissions and/or the subset of sidelink feedback transmissions with priority values smaller than or equal to K. For example, summation of specific power values of the set of sidelink feedback transmissions may or may not be larger than the maximum UE transmit power, noted as P_{CMAX}.

In some examples, if and/or when the summation of specific power values of the set of sidelink feedback transmissions is smaller than or equal to the maximum UE transmit power, the first UE may derive, determine and/or set a sidelink transmit power of each of the set of sidelink feedback transmissions as its specific power value. If and/or when the summation of specific power values of the set of sidelink feedback transmissions is larger than the maximum UE transmit power, the first UE may derive, determine and/or set a sidelink transmit power of each of the set of sidelink feedback transmissions based on one or more handling, methods and/or embodiments described below in association with Concept B.

In some examples, the subset of sidelink feedback transmissions may be selected, prioritized and/or determined to satisfy a carrier/cell-specific maximum number embodiment, condition and/or restriction for each of the plurality of carriers/cells, a UE-specific maximum number embodiment, condition and/or restriction, and/or to satisfy one or more limited TX capability-related embodiments, conditions and/or restrictions.

In some examples, the set of sidelink feedback transmissions may be selected, prioritized and/or determined to satisfy a carrier/cell-specific maximum number embodiment, condition and/or restriction for each of the plurality of carriers/cells, a UE-specific maximum number embodiment, condition and/or restriction, and/or to satisfy one or more limited TX capability-related embodiments, conditions and/or restrictions.

In some examples, the set of carriers/cells may comprise at least the first carrier/cell and/or the second carrier/cell. The set of sidelink feedback transmissions may comprise at least the first set of sidelink feedback transmissions and/or the second set of sidelink feedback transmissions.

In at least some of the aforementioned examples, the selection, prioritization, determination, exclusion and/or dropping based on priority values may be at least performed to sidelink feedback transmissions for the same type of usage. In some examples, the selection, prioritization, determination, exclusion and/or dropping based on priority values may be performed to sidelink feedback transmissions for sidelink HARQ feedback. In some examples, the selection, prioritization, determination, exclusion and/or dropping based on priority values may be performed to sidelink feedback transmissions for inter-UE coordination information (e.g., scheme 2) and/or for conflict indication.

In some examples, the selection, prioritization, determination, exclusion and/or dropping based on priority values may mean, comprise and/or replace as the selection, prioritization, determination, exclusion and/or dropping based on a type of usage. For example, the first UE may perform the selection, prioritization, determination, exclusion and/or dropping based on priority values and/or may perform selection, prioritization, determination, exclusion and/or dropping based on one or more types of usage. In some examples, sidelink feedback transmissions for sidelink HARQ feedback may be prioritized over sidelink feedback transmissions for inter-UE coordination information (e.g., scheme 2) and/or conflict indication (e.g., regardless of which priority value is higher or smaller). For example, a PSFCH for sidelink HARQ feedback with priority P2 may be prioritized, selected and/or determined differently than a PSFCH for inter-UE coordination information (scheme 2) or conflict indication with priority P1, wherein P1<P2. Besides sidelink HARQ feedback, inter-UE coordination information (e.g., scheme 2) and/or conflict indication, the type of usage may comprise one or more other features and/or functions introduced and/or specified in one or more other releases (e.g., future releases).

Concept B

The first UE may perform a set of sidelink feedback transmissions, wherein the set of sidelink feedback transmissions may be partially or fully overlapped in time domain and/or in a TTI and/or occasion. In some examples, the set of sidelink feedback transmissions may be selected, prioritized and/or determined from the plurality of (scheduled and/or requested) sidelink feedback transmissions. The set of sidelink feedback transmissions may be on a set of carriers/cells among the plurality of carriers/cells. For example, the set of carriers/cells may comprise at least a first carrier/cell and/or a second carrier/cell. The set of sidelink feedback transmissions may comprise at least a first set of sidelink feedback transmissions on the first carrier/cell and/or a second set of sidelink feedback transmissions on the second carrier/cell. In some examples, the number of the first set of sidelink feedback transmissions may be upper bounded and/or limited in a (first) carrier/cell-specific maximum number, and/or the number of the second set of sidelink feedback transmissions may be upper bounded and/or limited in a (second) carrier/cell-specific maximum number. The carrier/cell-specific maximum number for different carriers/cells may be the same or different.

For each sidelink feedback transmission of the set of sidelink feedback transmissions, the first UE may derive and/or determine a corresponding sidelink transmit power. The first UE may perform the set of sidelink feedback transmissions with each corresponding sidelink transmit power, for example.

In some examples, the total sidelink transmit power of the set of sidelink feedback transmissions may be upper bounded and/or limited in a maximum UE transmit power, noted as P_{CMAX}. For example, sidelink feedback transmissions on one carrier/cell may be upper bounded and/or limited in a maximum UE transmit power of the carrier/cell c, noted as P_{CMAX,c}. The total sidelink transmit power of the first set of sidelink feedback transmissions on the first carrier/cell C1 may be upper bounded and/or limited in a maximum UE transmit power of the first carrier/cell, noted as P_{CMAX,c1}. The total sidelink transmit power of the second set of sidelink feedback transmissions on the second carrier/cell C2 may be upper bounded and/or limited in a maximum UE transmit power of the second carrier/cell, noted as P_{CMAX,c2}.

In some examples, for one sidelink feedback transmission of the set of sidelink feedback transmissions, the first UE may derive and/or determine one power value (e.g., noted as Pₒₙₑ) based on pathloss. For the one sidelink feedback transmission in one sidelink resource pool on one carrier/cell, the first UE may derive and/or determine the one power value based on a DL pathloss value derived and/or determined on the one carrier/cell (when DL pathloss based sidelink power control is enabled and/or applied). In some examples, the first UE may derive and/or determine the one power value based on a SL pathloss value (when SL pathloss based sidelink power control is enabled and/or applied). In some examples, the first UE may derive and/or determine the one power value based on a P0 value and/or an alpha value when and/or if the P0 value and/or the alpha value is provided (for the one sidelink resource pool or for the one carrier/cell or for the first UE, for example). In some examples, for a first sidelink feedback transmission of the first set of sidelink feedback transmissions, the first UE may derive and/or determine a first power value based on pathloss (e.g., based on a first DL pathloss value derived/determined on the first carrier/cell, and/or based on a first SL pathloss value). For a second sidelink feedback transmission of the second set of sidelink feedback transmissions, the first UE may derive and/or determine a second power value based on pathloss (e.g., based on a second DL pathloss value derived and/or determined on the second carrier/cell, and/or based on a second SL pathloss value). In some examples, the first power value and the second power value may be different.

In some examples, for one sidelink feedback transmission of the set of sidelink feedback transmissions, the first UE may not derive and/or determine one power value based on pathloss (when DL pathloss based sidelink power control is not applied or is disabled, and/or when SL pathloss based sidelink power control is not applied or is disabled, for example).

In concept B, sidelink transmit power may be derived, determined and/or allocated for each sidelink feedback transmission of the set of sidelink feedback transmissions, given the upper bounded and/or limitation of UE transmit power. The first UE may derive and/or determine each corresponding sidelink transmit power of the set of sidelink feedback transmissions, based on any combinations of the techniques and/or subject matter described in the following discussion.

In some examples, the first UE may derive a (UE-specific) limited power value based on the maximum UE transmit power P_{CMAX} and/or the number and/or cardinality of the set of sidelink feedback transmissions in the set of carriers/cells, noted as N_{TX}. For example, the (UE-specific) limited power value based on the maximum UE transmit power may be derived, determined and/or equal to P_{CMAX}−10 log₁₀(N_{Tx}). For each sidelink feedback transmission of the set of sidelink feedback transmissions, the first UE may derive and/or determine a corresponding sidelink transmit power based on the (UE-specific) limited power value.

In some examples, if the first UE derives and/or determines one power value (e.g., noted as Pₒₙₑ,) based on pathloss for one sidelink feedback transmission of the set of sidelink feedback transmissions, the first UE may derive and/or determine a sidelink transmit power of the one sidelink feedback transmission based on the one power value and/or the (UE-specific) limited power value. For example, the sidelink transmit power of the one sidelink feedback transmission may be derived, determined and/or equal to min(P_{CMAX}−10 log₁₀ (N_{Tx}), Pₒₙₑ).

In some examples, if the first UE does not derive and/or determine power value based on pathloss for one sidelink feedback transmission of the set of sidelink feedback transmissions, the first UE may derive and/or determine a sidelink transmit power of the one sidelink feedback transmission based on the (UE-specific) limited power value. For example, the sidelink transmit power of the one sidelink feedback transmission may be derived, determined and/or equal to P_{CMAX}-10 log₁₀(N_{Tx}).

In some examples, the (UE-specific) limited power value based on the maximum UE transmit power may be applied and/or used for the set of sidelink feedback transmissions on the set of carriers/cells. For example, the total sidelink transmit power of the set of sidelink feedback transmissions may be smaller than or equal to the maximum UE transmit power. Such examples may be simple but less enhanced, since remaining power headroom between the (UE-specific) limited power value and one smaller power value cannot be utilized for other sidelink feedback transmissions with larger power value, for example. In some examples, the first UE may utilize remaining power to compensate one or some sidelink feedback transmission in the set of sidelink feedback transmission (e.g., compensate one or some sidelink feedback transmissions with smaller or smallest priority value among the set of sidelink feedback transmission).

In some examples, the set of sidelink feedback transmissions may at least comprise a subset of sidelink feedback transmissions with priority values smaller than or equal to a value K. One or more sidelink feedback transmissions, in the set of sidelink feedback transmissions, with priority value smaller than or equal to K may be included, comprised, selected and/or determined to be in the subset. The K may be a largest value such that summation of specific power values of the subset of sidelink feedback transmissions (with priority value smaller than or equal to the value K) may be smaller than or equal to the maximum UE transmit power, which may be noted as P_{CMAX}. For example, if there are remaining sidelink feedback transmissions (of the plurality of sidelink feedback transmissions) with priority values larger than K, summation of specific power values of one or more and/or all sidelink feedback transmissions with priority value smaller than or equal to the value (K+1) may be larger than the maximum UE transmit power, which may be noted as P_{CMAX}.

In some examples, the set of sidelink feedback transmissions may not comprise any sidelink feedback transmissions with priority values equal to (K+1), such that the subset may be the same as the set. The first UE may derive, determine and/or set sidelink transmit power of each of the set of sidelink feedback transmissions as its specific power value.

In some examples, the set of sidelink feedback transmissions may comprise some sidelink feedback transmissions with priority values equal to (K+1). For example, the set of sidelink feedback transmissions may comprise and/or consist of the some sidelink feedback transmissions and the subset of sidelink feedback transmissions with priority values smaller than or equal to K.

In some examples, if and/or when the summation of specific power values of the set of sidelink feedback transmissions is smaller than or equal to the maximum UE transmit power, the first UE may derive, determine and/or set sidelink transmit power of each of the set of sidelink feedback transmissions as its specific power value.

In some examples, if and/or when the summation of specific power values of the set of sidelink feedback transmissions is larger than the maximum UE transmit power, the first UE may derive, determine and/or set sidelink transmit power of each of the subset of sidelink feedback transmissions as its specific power value. The first UE may scale down or reduce specific power values of the some sidelink feedback transmissions (e.g., scale down with the same scaling ratio), such that the total sidelink transmit power of the set of sidelink feedback transmissions may be smaller than or equal to the maximum UE transmit power. Thus, sidelink transmit power values of the some sidelink feedback transmissions may be smaller than specific power values of the some sidelink feedback transmissions.

In some examples, if and/or when the summation of specific power values of the set of sidelink feedback transmissions is larger than the maximum UE transmit power, the first UE may scale down or reduce specific power values of the set of sidelink feedback transmissions (e.g., scale down with the same scaling ratio), such that the total sidelink transmit power of the set of sidelink feedback transmissions may be smaller than or equal to the maximum UE transmit power. Thus, sidelink transmit power values of the set of sidelink feedback transmissions may be smaller than specific power values of the set of sidelink feedback transmissions.

In some examples, the specific power value may be a power value (noted, for example, as Pₒₙₑ) derived and/or determined based on pathloss. For example, for one sidelink feedback transmission in one sidelink resource pool on one carrier/cell, the first UE may derive and/or determine the one power value based on a DL pathloss value derived and/or determined on the one carrier/cell (when DL pathloss based sidelink power control may be enabled and/or applied, for example). In some examples, the first UE may derive and/or determine the one power value based on a SL pathloss value (when SL pathloss based sidelink power control is enabled and/or applied, for example). In some examples, the first UE may derive and/or determine the one power value based on a P0 value and/or an alpha value, when and/or if the P0 value and/or the alpha value is provided (for the one sidelink resource pool or for the one carrier/cell or for the first UE, for example).

In some examples, such as when DL pathloss based sidelink power control is not applied or is disabled, and/or when SL pathloss based sidelink power control is not applied or is disabled the specific power value may be a power value derived and/or determined based on maximum UE transmit power (noted as P_{CMAX}) and/or maximum UE transmit power of a carrier/cell (noted as P_{CMAX,c}). For example, the specific power value may be derived and/or determined based on a carrier/cell-specific maximum number (noted as N_{max,TX,c}), and/or based on a configured (carrier/cell-specific) number (noted as N_{configured,Tx,c}). For one sidelink feedback transmission in one sidelink resource pool on one carrier/cell C1, the power value based on a maximum UE transmit power may be P_{CMAX}−10 log₁₀(N_{max,TX,c1}) or P_{CMAX}−10 log₁₀(N_{configured,TX,c1}). For one sidelink feedback transmission in one sidelink resource pool on one carrier/cell C1, the power value based on a maximum UE transmit power of a carrier/cell may be P_{CMAX,c1}−10 log₁₀ (N_{max,Tx,c1}) or P_{CMAX,c1}−10 log₁₀ (N_{configured,Tx,c1}).

In some examples, such as when DL pathloss based sidelink power control is not applied or is disabled, and/or when SL pathloss based sidelink power control is not applied or is disabled, the specific power value may be a configured (guarantee) power value (noted as P_{one,guarantee}), which may, for example, be configured for sidelink resource pool or for carrier/cell or for the first UE.

In some examples, the specific power value may be derived and/or determined according to one or more of the power value based on pathloss, the configured (guarantee) power value, and/or the power value based on maximum UE transmit power (noted as P_{CMAX}) or maximum UE transmit power of a carrier/cell (noted as P_{CMAX,c}). For example, for one sidelink feedback transmission in one sidelink resource pool on one carrier/cell C1, the specific power value may be one or more of min(P_{CMAX}−10 log₁₀(N_{max,TX,c1}), Pₒₙₑ), min(P_{CMAX}−10 log₁₀(N_{configured,TX,c1}), Pₒₙₑ), min(P_{CMAX,c1}−10 log₁₀(N_{max,TX,c1}), Pₒₙₑ), min(P_{CMAX,c1}−10 log₁₀(N_{configured,TX,c1}), Pₒₙₑ), min(P_{CMAX}−10 log₁₀(N_{max,TX,c1}), P_{one,guarantee}, Pₒₙₑ), min(P_{CMAX,c1}−10 log₁₀(N_{max,Tx,c1}), P_{one,guarantee}, Pₒₙₑ), and/or min(P_{one,guarantee}, Pₒₙₑ).

In some examples, the first UE may allocate, distribute and/or determine a carrier/cell-specific power budget/headroom (e.g., noted as P_{budget,c1}) for the set of carrier/cells. In this embodiment, the maximum UE transmit power of the carrier/cell may be replaced, represented and/or changed as and/or based on the carrier/cell-specific power budget/headroom. For example, the power value based on maximum UE transmit power of the carrier/cell may be replaced, represented and/or changed as the power value based on the carrier/cell-specific power budget/headroom, for example, P_{budget,c1}−10 log₁₀(N_{max,TX,c1}) or P_{budget,c1}−10 log₁₀(N_{configured,TX,c1}). In some examples, the carrier/cell-specific power budget/headroom may be derived and/or determined based a carrier/cell-specific ratio and/or the maximum UE transmit power, e.g., P_{budget,c1}−r_{budget,c1}−P_{CMAX}. The carrier/cell-specific power budget/headroom or the carrier/cell-specific ratio may be configured, or varied, derived and/or determined based on a carrier/cell distribution of the set of sidelink feedback transmission.

In some examples, the first UE may derive a carrier/cell-specific limited power value based on the maximum UE transmit power of a carrier/cell P_{CMAX,c}. The number of sidelink feedback transmissions, among the set of sidelink feedback transmission, in the carrier/cell may be noted as N_{TX,c}. The number of sidelink feedback transmissions N_{TX,c} may be smaller than or equal to a carrier/cell-specific maximum number of the carrier/cell. In some examples, the carrier/cell-specific limited power value based on the maximum UE transmit power of the carrier/cell may be derived, determined and/or equal as and/or based on P_{CMAX,c}−10 log₁₀(N_{Tx,c}). For one sidelink feedback transmission in the carrier/cell, the first UE may derive/determine a corresponding sidelink transmit power based on the carrier/cell-specific limited power value, for example.

In some examples, if the first UE derives and/or determines one power value (e.g., noted as Pₒₙₑ,) based on pathloss for the one sidelink feedback transmission in the carrier/cell, the first UE may derive and/or determine a sidelink transmit power of the one sidelink feedback transmission based on the one power value and/or the carrier/cell-specific limited power value. For example, the sidelink transmit power of the one sidelink feedback transmission may be derived, determined and/or equal as and/or based on min(P_{CMAX,c}−10 log₁₀ (N_{TX,c}), Pₒₙₑ).

In some examples, if the first UE does not derive and/or determine power value based on pathloss for one sidelink feedback transmission of the set of sidelink feedback transmissions, the first UE may derive and/or determine a sidelink transmit power of the one sidelink feedback transmission based on the carrier/cell-specific limited power value. For example, the sidelink transmit power of the one sidelink feedback transmission may be derived, determined and/or equal as and/or based on P_{CMAX,c}−10 log₁₀(N_{TX,c}). In some examples, the first UE may derive/determine the sidelink transmit power of the one sidelink feedback transmission based on the carrier/cell-specific limited power value and/or a (UE-specific) limited power value based on the maximum UE transmit power. For example, the sidelink transmit power of the one sidelink feedback transmission may be derived, determined and/or equal as and/or based on min(P_{CMAX}−10 log₁₀(Nx), P_{CMAX,c}−10 log₁₀(N_{TX,c})). In some examples, the (UE-specific) limited power value based on the maximum UE transmit power may be applied and/or used for the set of sidelink feedback transmissions on the set of carriers/cells.

In some examples, if and/or when the total sidelink transmit power of the set of sidelink feedback transmissions is larger than the maximum UE transmit power, the first UE may scale down and/or reduce sidelink transmit power values of the set of sidelink feedback transmissions, such that the total scaled/reduced sidelink transmit power of the set of sidelink feedback transmissions may be smaller than or equal to the maximum UE transmit power. For example, the first UE may scale down and/or reduce the sidelink transmit power values of the set of sidelink feedback transmissions with the same scaling ratio. The first UE may scale down and/or reduce (with the same scaling ratio) sidelink transmit power values of some/all sidelink feedback transmissions with larger and/or largest priority values (e.g., priority values equal to (K+1)) in the set of sidelink feedback transmissions. The first UE may not scale down and/or reduce sidelink transmit power values of other sidelink feedback transmissions with smaller priority values (e.g., priority values smaller than or equal to K) in the set of sidelink feedback transmissions, for example.

In some examples, the first UE may allocate, distribute and/or determine a carrier/cell-specific power budget/headroom (e.g., noted as P_{budget,c1}) for the set of carrier/cells. The maximum UE transmit power of the carrier/cell may be replaced, represented and/or changed as the carrier/cell-specific power budget/headroom. In some examples, the carrier/cell-specific limited power value may be derived, determined and/or equal as or based on P_{budget,c1}−10 log₁₀(N_{Tx,c}), and/or the carrier/cell-specific power budget/headroom may be derived and/or determined based a carrier/cell-specific ratio and/or the maximum UE transmit power (e.g., P_{budget,c1}−r_{budget,c1}·P_{CMAX}). In some examples, the carrier/cell-specific power budget/headroom or the carrier/cell-specific ratio may be configured, or varied, derived and/or determined based on carrier/cell distribution of the set of sidelink feedback transmission. P_{budget,c1} may be P_{CMAX,c1}, and/or the first UE may determine P_{budget,c1} and/or P_{CMAX,c1} such that summation of P_{CMAX,c1} may not exceed P_{CMAX}. In some examples, ci may correspond to a carrier/cell which the first UE has PSFCH to transmit, a carrier/cell which the first UE prioritizes to transmit PSFCH, a carrier/cell which the first UE prioritizes for satisfying limited TX UE capability, a carrier/cell which the first UE is configured for sidelink transmission and/or a carrier/cell which the first UE has PSFCH to transmit in a timing and/or slot.

In some examples, including the aforementioned examples, the derivation, determination and/or allocation of sidelink transmit power may be at least performed to sidelink feedback transmissions for the same type of usage. The derivation, determination and/or allocation of sidelink transmit power may be performed to sidelink feedback transmissions for sidelink HARQ feedback and/or to sidelink feedback transmissions for inter-UE coordination information (e.g., scheme 2) and/or conflict indication.

In some examples, the derivation, determination and/or allocation of sidelink transmit power may be applied and/or performed based on a type of usage. For the derivation, determination and/or allocation of sidelink transmit power, one or more sidelink feedback transmissions for sidelink HARQ feedback may be prioritized over sidelink feedback transmissions for inter-UE coordination information (e.g., scheme 2) and/or conflict indication (e.g., regardless of which priority value is higher or smaller). In some examples, the first UE may initially scale down and/or reduce one or more sidelink transmit power values of one or more sidelink feedback transmissions for inter-UE coordination information (e.g., scheme 2) and/or conflict indication, such that the total scaled/reduced sidelink transmit power of the set of sidelink feedback transmissions may be smaller than or equal to the maximum UE transmit power. If scaling down or reducing one or more sidelink transmit power values of one or more sidelink feedback transmissions for inter-UE coordination information (e.g., scheme 2) and/or conflict indication does not satisfy the restriction and/or condition of the maximum UE transmit power, the first UE may (consider whether to and/or start to) scale down and/or reduce one or more sidelink transmit power values of one or more sidelink feedback transmissions for sidelink HARQ feedback. For example, a PSFCH for sidelink HARQ feedback with priority P2 may be prioritized, selected and/or determined differently than a PSFCH for inter-UE coordination information (e.g., scheme 2) and/or conflict indication with priority P1, wherein P1<P2. The first UE may initially scale down and/or reduce sidelink transmit power of the PSFCH for inter-UE coordination information (e.g., scheme 2) and/or conflict indication. Besides sidelink HARQ feedback and/or inter-UE coordination information (scheme 2) or conflict indication, the type of usage may comprise one or more other features and/or functions introduced and/or specified in one or more other releases (e.g., future releases).

Concept C

The first UE may select, prioritize and/or determine a set of sidelink feedback transmissions from the plurality of (scheduled and/or requested) sidelink feedback transmissions. The plurality of (scheduled and/or requested) sidelink feedback transmissions may be on a plurality of carriers/cells. The first UE may transmit the set of sidelink feedback transmissions, and/or may drop and/or exclude or not transmit one or more non-selected, non-prioritized and/or non-determined sidelink feedback transmissions among the plurality of (scheduled and/or requested) sidelink feedback transmissions.

In concept C, the first UE may select, prioritize and/or determine the set of sidelink feedback transmissions for a given timing and/or slot such that a first condition, a second condition and/or a third condition are met.

The first condition is met when a number of carriers/cells for transmitting the set of sidelink feedback transmissions satisfies one or more limited TX capability-related embodiments, conditions and/or restrictions. The number of carriers/cells for transmitting the set of sidelink feedback transmissions may be smaller than or equal to a (maximum) number of simultaneous transmission carriers/cells, for example.

The second condition is met when a per carrier/cell's maximum number of TX PSFCH (e.g., noted as N_{max,TX,c}) is satisfied and/or a per carrier/cell's maximum transmit power (e.g., noted as P_{CMAX,c}) is satisfied. One or more different carriers may have the same or different maximum number of TX PSFCH, and/or may have the same or different per carrier/cell's maximum transmit power (e.g., noted as P_{CMAX,c}). In some examples, a per carrier/cell's maximum number of TX PSFCH (e.g., noted as N_{max,TX,c}) is for at least a carrier/cell in which the first UE has PSFCH to transmit in the given timing and/or slot. For example, a per carrier/cell's maximum transmit power (e.g., noted as P_{CMAX,c}) may be for at least a carrier/cell in which the first UE has PSFCH to transmit in the given timing/slot, for example.

The third condition is met when a total maximum UE transmit power for the set of sidelink feedback transmissions is satisfied and/or a cardinality of the set of sidelink feedback transmissions (e.g., a total number sidelink feedback transmissions in the set of sidelink feedback transmission) is smaller than or equal to a total maximum number of TX PSFCH (e.g., noted as N_{max,TX}).

In some examples, the first UE may, based on any order and/or combination of the first condition, the second condition and/or the third condition, determine the set of sidelink feedback transmissions.

In some examples, for the first condition, the first UE may prioritize the number of carriers/cells based on at least a (smallest) priority value associated with each carrier/cell of the plurality of carriers/cells. For example, the (smallest) priority value associated with a carrier/cell may be based on a smallest priority value associated with one or more PSFCHs in the carrier/cell, such as one or more PSFCHs for sidelink HARQ feedback and/or one or more PSFCHs for inter-UE coordination information (e.g., scheme 2) and/or conflict indication. In some examples, the (smallest) priority value associated with a carrier/cell may be based on a smallest priority value associated with one or more PSFCHs for sidelink HARQ feedback in the carrier/cell. In some examples, the (smallest) priority value of each carrier/cell may not be based on a smallest priority value associated with one or more PSFCHs for inter-UE coordination information (e.g., scheme 2) and/or conflict indication. In some examples, the (smallest) priority value of each carrier/cell may not be based on a smallest priority value associated with one or more PSFCHs for one or more other types of usage, except, for example, sidelink HARQ feedback.

In some examples, the first UE may prioritize the number of one or more carriers/cells based on at least a carrier/cell index among the plurality of carriers/cells. For example, the first UE may prioritize the number of one or more carriers/cells according to and/or based on an ascending carrier/cell index value order among the plurality of carriers/cells.

In some examples, the first UE may be configured with a parameter and/or a threshold. For example, based on the parameter and/or the threshold, the first UE may determine whether to determine a (smallest, for example) priority associated with a carrier/cell based (also, for example) on a priority value associated with one or more PSFCHs for inter-UE coordination information (e.g., scheme 2) and/or conflict indication. Alternatively and/or additionally, based on the parameter and/or the threshold, the first UE may determine, consider and/or set a smallest priority value associated with PSFCH for inter-UE coordination information (e.g., scheme 2) and/or conflict indication in one carrier/cell as a (smallest, for example) priority value associated with the one carrier/cell. In some examples, when and/or if a priority value associated with PSFCH for inter-UE coordination information (e.g., scheme 2) and/or conflict indication in one carrier/cell is smaller than or equal to the parameter and/or the threshold, the first UE may determine, consider and/or set the priority value associated with PSFCH for inter-UE coordination information (e.g., scheme 2) and/or conflict indication as a (smallest, for example) priority value associated with the one carrier/cell. In some examples, when and/or if a priority value associated with PSFCH for inter-UE coordination information (e.g., scheme 2) and/or conflict indication in one carrier/cell is larger than the parameter and/or the threshold, the first UE may not determine, consider and/or set the priority value associated with PSFCH for inter-UE coordination information (e.g., scheme 2) and/or conflict indication as a (smallest) priority value associated with the one carrier/cell.

In some examples, the plurality of carriers/cells may comprise carriers/cells C1, C2, and/or C3. In carrier/cell C1, there may be two PSFCHs with respective priority value {3}, {4} for sidelink HARQ feedback and/or a PSFCH with priority value {1} for inter-UE coordination information (e.g., scheme 2) and/or conflict indication. In one example, the (smallest) priority value for carrier/cell C1 may be {3}. The first UE may determine one or more of the respective priority values, such as the priority value for carrier/cell C1, based on a smallest priority value of one or more PSFCHs for sidelink HARQ feedback. The first UE may not be configured with a parameter and/or a threshold, and/or the parameter/threshold may not allow for use of a priority value of one or more PSFCHs for inter-UE coordination information (e.g., scheme 2) and/or conflict indication as the (smallest) priority value associated with carrier/cell C1. In another example, the (smallest) priority value for carrier/cell C1 may be {1}. The first UE may determine one or more of the respective priority values, such as the priority value for carrier/cell C1, based on a smallest priority value among the three PSFCHs in the carrier/cell C1.

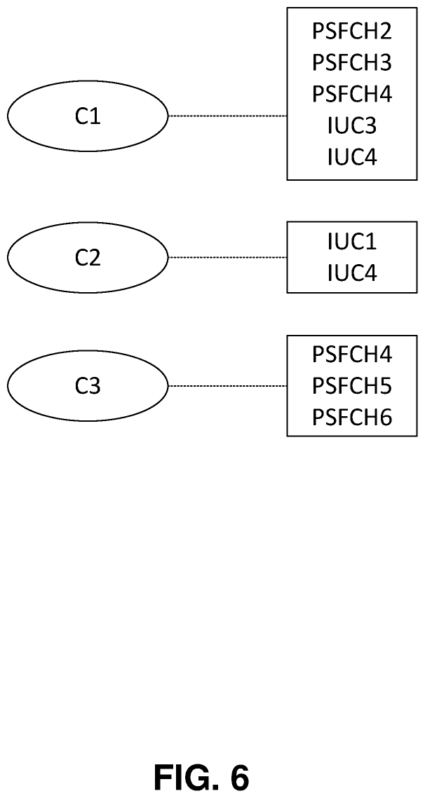

FIG. 6 illustrates a first UE having one or more sidelink feedback channels to be transmitted on carriers/cells C1, C2, and/or C3. There may be three PSFCHs with corresponding priority values 2, 3, and 4 for sidelink HARQ feedback and/or two PSFCHs for Inter-UE Coordination (IUC) with corresponding priority values 3, and 4 in carrier/cell C1, and there may be two PSFCHs for IUC with corresponding priority value 1, and 4 in carrier/cell C2, and there may be three PSFCHs with corresponding priority values 4, 5, and 6 in carrier/cell C3. For determining the number of carriers/cells for the first condition, one or more (smaller and/or smallest, for example) priority values associated with carriers/cells may be derived and/or determined based on PSFCH2 for carriers/cell C1 (e.g., priority value 2) and/or based on PSFCH4 for carrier/cell C3. In one example, there may be no priority value associated with carrier/cell C2 (due to pure IUC transmission and/or due to no consideration on IUC transmission, for example). In some examples, the first UE may determine a (smaller and/or smallest, for example) priority value associated with carrier/cell C2 as a highest priority value (e.g., 8). In some examples, the first UE may determine a (smaller and/or smallest, for example) priority value associated with carrier/cell C2 as a specific priority value (e.g., 9) larger than the highest priority value (e.g., 8). The first UE may prioritize a portion and/or some of carriers/cells C1, C2, C3 (over one or more other carriers/cells, for example) for satisfying a limited TX capability (e.g., assuming as 2 carriers/cells). In some examples, the first UE may prioritize carrier/cell C1 followed by carrier/cell C3. In some examples, if there is no carriers/cell C3, the first UE may prioritize carrier/cell C1 followed by carrier/cell C2. In some examples, based on one or more priority values only and/or not based on one or more types of usage, the first UE may determine a (smaller and/or smallest, for example) priority value associated with carrier/cell C2 based on IUC1 (e.g., priority value 1). The first UE may prioritize carrier/cell C2 followed by carrier/cell C1. In some examples, based on a carrier/cell index, the first UE may prioritize carrier/cell C1 followed by carrier/cell C2. In some examples, the prioritized order in the first condition is based on at least one or more carriers/cells comprising at least one PSFCH followed by one or more carriers/cells not comprising PSFCH for transmission. In some examples, the prioritized order in the first condition may be based on the threshold and/or the parameter. In some examples, the parameter may indicate whether to consider a priority value of IUC. In some examples, the threshold may indicate comparison criteria for IUC and sidelink HARQ feedback. For example, the threshold may be 2 which may indicate and/or mean that when IUC is important, such as with a priority value 1 or a priority value 2, such a priority is taken into account. In FIG. 6, the prioritized order would be carrier/cell C2 followed by carrier/cell C1.

In some examples, in the second condition, the first UE may determine a transmit power for each carrier/cell independently, and/or may determine a transmit power for each carrier/cell the same as a single carrier/cell. For example, in FIG. 6, (assuming the prioritized carrier/cell is carriers/cells C1, C3) for carrier/cell C1, the first UE may prioritize PSFCH 2, 3, and 4 and IUC3 if C1's maximum number of TX PSFCH is four and/or a summation of transmit power for these four sidelink feedback channels may meet maximum transmit power for carrier/cell C1. For carrier/cell C3, the first UE may prioritize PSFCH 4, 5, and 6 if C3's maximum number of TX PSFCH is four and/or a summation of transmit power for these three sidelink feedback channels may meet maximum transmit power for carrier/cell C3. In some examples, the maximum transmit power for carrier/cell Ci may be based on scaling one after the third condition.

In some examples, in the third condition, the first UE may determine and/or a adjust maximum transmit power of each carrier/cell for satisfying total maximum UE transmit power. The first UE may scale down a maximum transmit power of each carrier/cell (with a same or different scaling ratio, for example), and/or may (further) drop one or more (but not all, for example) sidelink feedback channels and/or drop all sidelink feedback channels in one carrier/cell. In some examples, the first UE may (further) drop one or more (but not all, for example) sidelink feedback channels with usage as inter-UE coordination information (e.g., scheme 2) and/or conflict indication (e.g., before dropping one or more (but not all, for example) sidelink feedback channels with usage as sidelink HARQ feedback). In FIG. 6, assuming the carrier/cell C1 and C3 are prioritized to satisfy limited TX capability, the first UE may drop a portion and/or some of one or more sidelink feedback channels from PSFCH 2, 3, and 4 and IUC3,4 in carrier/cell C1 and PSFCH4, 5, and 6 for meeting a total maximum UE transmit power (e.g., a drop order may be according to and/or based on descending priority value order PSFCH6=>PSFCH5=> . . . =>PSFCH2). In some examples, the first UE may drop in an interleaved way, such as for example dropping PSFCH6 in carrier/cell C3 followed by dropping IUC4 in carrier/cell C1 followed by dropping PSFCH5 in carrier/cell C3 followed by dropping IUC3 in carrier/cell C1, and/or the dropping may continue until reaching and/or meeting a total maximum UE transmit power. In some examples, when determining the set of sidelink feedback channels, the third condition may be earlier than the second condition and/or the first UE may perform one or more procedures related to the third condition earlier than one or more procedures related to the second condition. In FIG. 6, an original maximum transmit power for carrier/cell C1 and/or an original maximum transmit power for carrier/cell C3 may be determined by the first UE. If there are no simultaneous transmissions on carriers/cells C1 and C3, the first UE may determine a transmit power of each sidelink feedback channel based on a maximum transmit power for each carrier/cell. When a summation of maximum transmit power for carrier/cell C1 and a maximum transmit power for carrier/cell C3 is larger than a total maximum UE transmit power, the first UE may perform power scaling. Based on the power scaling, a reduced maximum transmit power for carrier/cell C1 and a reduced maximum transmit power for carrier/cell C3 may be determined. Then, the first UE may determine transmit power for one or more sidelink feedback channels in carriers/cells C1 and C3 based on the reduced maximum transmit power for carrier/cell C1 and/or the reduced maximum transmit power for carrier/cell C3, respectively. In some examples, for the third condition, the first UE may determine and/or adjust cardinality of the set of sidelink feedback transmissions to be smaller than or equal to a total maximum number of TX PSFCH. For example, the first UE may drop one or more (but not all, for example) TX PSFCHs from the plurality of sidelink feedback transmissions to satisfy the total maximum number of TX PSFCH, and/or may drop one or more TX PSFCHs from the plurality of sidelink feedback transmissions based on one or more priority values (of each TX PSFCH, for example). In some examples, the first UE may drop one or more (but not all, for example) TX PSFCHs, from the plurality of sidelink feedback transmissions, that are for inter-UE coordination information (e.g., scheme2) and/or conflict indication. In some examples, the first UE may drop all TX PSFCHs in a carrier/cell to satisfy the cardinality of the set of sidelink feedback transmissions being smaller than or equal to a total maximum number of TX PSFCH.

In some examples, the first UE may prioritize one or more carriers/cells for satisfying limited TX capability, and/or may prioritize the one or more carriers/cells (for transmitting PSFCH) based on a lowest priority value (of PSFCH) in each carrier/cell. In response to the prioritized one or more carriers/cells, the first UE may determine a number of prioritized PSFCHs with each transmit power satisfying each carrier/cell's maximum number of TX PSFCH (e.g., noted as N_{max,TX,c}) and/or each carrier/cell's maximum transmit power (e.g., noted as P_{CMAX,c}). In some examples, the one or more prioritized carriers/cells may comprise a first carrier/cell and/or a second carrier/cell. For each carrier/cell among the prioritized carriers/cells, the first UE may determine a number of prioritized PSFCHs with each PSFCH transmit power based on a single carrier/cell case, for example.

In some examples, all of the one or more prioritized carriers/cells may be enabled and/or configured to use DL pathloss for determining a PSFCH transmit power, and/or may be enabled and/or configured to use SL pathloss for determining a PSFCH transmit power.

In some examples, all of the one or more prioritized carriers/cells may not be enabled and/or configured to use DL pathloss for determining a PSFCH transmit power, and/or may not be enabled and/or configured to use SL pathloss for determining a PSFCH transmit power.

In some examples, the first carrier/cell may be enabled and/or configured to use DL pathloss for determining a PSFCH transmit power while the second carrier/cell may not be enabled and/or configured to use DL pathloss for determining a PSFCH transmit power. The first UE may be configured, enabled and/or applied to use DL pathloss for determining a PSFCH transmit power for the first carrier/cell while the first UE may not be configured, enabled and/or applied to use DL pathloss for determining a PSFCH transmit power for the second carrier/cell. The first carrier/cell may be enabled and/or configured to use SL pathloss for determining a PSFCH transmit power while the second carrier/cell may not be enabled and/or configured to use SL pathloss for determining a PSFCH transmit power. The first UE may be configured, enabled and/or applied to use SL pathloss for determining a PSFCH transmit power for the first carrier/cell while the first UE may not be configured, enabled and/or applied to use SL pathloss for determining a PSFCH transmit power for the second carrier/cell.

In some examples, for the first carrier/cell being configured and/or enabled to use DL pathloss for determining a PSFCH transmit power (and/or the first UE being configured and/or enabled to use DL pathloss for determining a PSFCH transmit power for the first carrier/cell). If the first UE has more than N_{max,TX,c} PSFCH for transmission in the given timing in the first cell, the first UE may determine Nma_{X}TX,c PSFCH transmit power based on a priority of each PSFCH in the first cell. For example, a PSFCH transmit power of each determined PSFCH in the first cell may be min(P_{CMAX,c}−10 log₁₀(N_{max,Tx,c}, Pₒₙₑ) or Pₒₙₑ. Pₒₙₑ may be the specific power value derived/determined based on a pathloss (e.g., similar to Pₒₙₑ in concept A). Both the P_{CMAX,c} and N_{max,TX,c} may be for the first carrier/cell. If the first UE has less than or equal to N_{max,TX,c} PSFCH for transmission in the given timing in the first carrier/cell, the first UE may determine a number of PSFCHs (N_{TX,c}) being smaller than or equal to N_{max,TX,c}. For example, a PSFCH transmit power of each determined PSFCH in the first carrier/cell may be min(P_{CMAX,c}−10 log₁₀ (N_{max,Tx,c}) Pₒₙₑ) or min(P_{CMAX,c}−10 log₁₀(N_{TX,c}), Pₒₙₑ) or Pₒₙₑ. Pₒₙₑ may be the specific power value derived and/or determined based on a pathloss (e.g., similar to Pₒₙₑ in concept A). Both the P_{CMAX,c} cand N_{max,TX,c} may be for the first carrier/cell.

In some examples, for the second carrier/cell not being configured and/or enabled to use DL pathloss for determining a PSFCH transmit power (and/or the first UE is not being configured and/or enabled to use DL pathloss for determining a PSFCH transmit power for the second carrier/cell), the first UE may determine a number of PSFCHs (N_{TX,c}) based on priority such that the number of PSFCHs is equal to or smaller than N_{max,TX,c} for the second carrier/cell. In some examples, a PSFCH transmit power of each of N_{TX,c} PSFCH in the second carrier/cell may be P_{CMAX,c}−10 log₁₀(N_{TX,c}), wherein P_{CMAX,c} is for the second cell. A PSFCH transmit power of each of N_{TX,c} PSFCH in the second carrier/cell may be a configured (e.g., guarantee) power value (noted as P_{one,guarantee}), which may, for example, be configured for sidelink resource pool, for a carrier/cell and/or for the first UE. In some examples, when and/or if the determined and/or prioritized PSFCH in the prioritized one or more carriers/cells does not satisfy a UE's total maximum number of TX PSFCH and/or does not satisfy per carrier/cell's maximum number of TX PSFCH, the first UE may (i) prioritize a subset of prioritized one or more carriers/cells based on priority (e.g., based on (smaller and/or smallest, for example) priority value associated with each carrier/cell), (ii) drop or not transmit (one or more and/or all) PSFCHs in the prioritized one or more carriers/cells except the subset of prioritized one or more carriers, (iii) prioritize a subset of prioritized PSFCH based on priority (e.g., based on a priority value of each PSFCH), (iv) drop or not transmit a deprioritized PSFCH, and/or (v) perform scaling for and/or on P_{CMAX,c} for each prioritized one or more carriers/cells.

In some examples, summation of P_{CMAX,c} for each prioritized one or more carriers/cells is X (with or without ceiling or floor operation) multiple of P_{CMAX}. The first UE may scale each P_{CMAX,c} for each prioritized one or more carriers/cells as 1/XP_{CMAX,c}.

One, some and/or all of the foregoing examples, concepts, techniques and/or embodiments can be formed and/or combined to a new embodiment.

In some examples, embodiments disclosed herein, such as embodiments described with respect to Concept A, Concept B and Concept C, may be implemented independently and/or separately. Alternatively and/or additionally, a combination of embodiments described herein, such as embodiments described with respect to Concept A, Concept B and/or Concept C, may be implemented. Alternatively and/or additionally, a combination of embodiments described herein, such as embodiments described with respect to Concept A, Concept B and/or Concept C, may be implemented concurrently and/or simultaneously.

Various techniques, embodiments, methods and/or alternatives of the present disclosure may be performed independently and/or separately from one another. Alternatively and/or additionally, various techniques, embodiments, methods and/or alternatives of the present disclosure may be combined and/or implemented using a single system. Alternatively and/or additionally, various techniques, embodiments, methods and/or alternatives of the present disclosure may be implemented concurrently and/or simultaneously.

With respect to one or more embodiments herein, such as one or more techniques, devices, concepts, methods, example scenarios and/or alternatives described above, for sidelink, a lower priority value may mean a higher priority.

With respect to one or more embodiments herein, in some examples, a smaller priority value (associated with SL Medium Access Control (MAC) Control Element (CE), sidelink data, and/or sidelink logical channel) may mean and/or indicate a higher priority. For example, priority value 1 may mean and/or indicate a highest priority, while priority value 8 may mean and/or indicate a lower and/or a lowest priority.

With respect to one or more embodiments herein, in some examples, when a first priority value of a first sidelink MAC CE, data and/or logical channel is smaller than a second priority value of a second sidelink MAC CE, data and/or logical channel, priority of the first sidelink MAC CE, data and/or logical channel may be higher than priority of the second sidelink MAC CE, data and/or logical channel. Alternatively and/or additionally, a sidelink MAC CE, data and/or logical channel with a highest priority may be set to and/or configured with a lower and/or a lowest priority value (e.g., a fixed value 0 or 1).

With respect to one or more embodiments herein, in some examples, the PSSCH transmission from a UE may be and/or comprise a sidelink data transmission. For example, the PSSCH transmission from the UE may be a device-to-device transmission. The PSSCH transmission may be utilized for transmitting a data packet, a transport block, and/or a MAC Protocol Data Unit (PDU). MAC CE may be comprised in a MAC PDU, a transport block and/or a data packet. The MAC PDU may represent and/or be a data packet and/or a transport block.

With respect to one or more embodiments herein, in some examples, the sidelink transmission from a UE may be and/or comprise a PSCCH transmission.

With respect to one or more embodiments herein, in some examples, the sidelink control information may be delivered in PSCCH (and/or in one or more other channels in addition to PSCCH).

With respect to one or more embodiments herein, in some examples, the slot may correspond to (e.g., may be and/or may refer to) a sidelink slot. In some examples, the slot may be represented as and/or replaced with a Transmission Time Interval (TTI). In some examples, in the present disclosure, one, some and/or all instances of the term “slot” may be replaced with the term “TTI”.

With respect to one or more embodiments herein, in some examples, the sidelink slot may correspond to (e.g., may be and/or may refer to) slot for sidelink. In some examples, a TTI may be a subframe (for sidelink, for example), a slot (for sidelink, for example) or a sub-slot (for sidelink, for example). In some examples, a TTI comprises multiple symbols, e.g., 12, 14 or other number of symbols. In some examples, a TTI may be a slot comprising sidelink symbols (e.g., the slot may fully/partially comprise the sidelink symbols). In some examples, a TTI may mean a transmission time interval for a sidelink transmission (e.g., a sidelink data transmission).

With respect to one or more embodiments herein, in some examples, the slot may correspond to (e.g., may be and/or may refer to) a sidelink slot associated with the sidelink resource pool. In some examples, the slot may not correspond to (e.g., may not comprise and/or may not refer to) a sidelink slot associated with a different sidelink resource pool.

With respect to one or more embodiments herein, in some examples, there may be one or more sidelink resource pools in a sidelink BWP and/or a sidelink carrier/cell.

With respect to one or more embodiments herein, in some examples, sidelink data (e.g., sidelink data of a sidelink data transmission) may be and/or comprise a transport block (TB). The (first) sidelink data may be and/or comprise a MAC PDU, and/or may be and/or comprise a (first) data packet.

With respect to one or more embodiments herein, in some examples, the (first) sidelink data may be associated with at least a sidelink logical channel, and/or may comprise data from at least a sidelink logical channel.

With respect to one or more embodiments herein, in some examples, a sub-channel may be a unit for sidelink resource allocation and/or scheduling (for PSSCH, for example). A sub-channel may comprise multiple contagious PRBs in frequency domain, and/or the number of PRBs for each sub-channel may be configured (e.g., pre-configured) for a sidelink resource pool.

With respect to one or more embodiments herein, in some examples, the resource reservation period value may be in units of milliseconds. The resource reservation period value may be (converted and/or changed, for example) into units of slots for deriving and/or determining periodic occasions of periodic sidelink data resources.

With respect to one or more embodiments herein, in some examples, the UE may be and/or comprise a device.

With respect to one or more embodiments herein, in some examples, the sidelink transmission and/or reception may be UE-to-UE transmission and/or reception. The sidelink transmission and/or reception may be device-to-device transmission and/or reception, may be Vehicle-to-Everything (V2X) transmission and/or reception, and/or may be Pedestrian-to-Everything (P2X) transmission and/or reception. In some examples, the sidelink transmission and/or reception may be on a PC5 interface.

With respect to one or more embodiments herein, in some examples, the PC5 interface may be a wireless interface for communication between a device and a device. The PC5 interface may be a wireless interface for communication between devices and/or between UEs. The PC5 interface may be a wireless interface for V2X and/or P2X communication. The Uu interface may be a wireless interface for communication between a network node and a device. The Uu interface may be a wireless interface for communication between a network node and a UE.

With respect to one or more embodiments herein, in some examples, the first UE may be a first device, a UE-A and/or a UE-B. The first UE may be a vehicle UE and/or a V2X UE.

With respect to one or more embodiments herein, in some examples, the second UE may be a second device, a UE-B and/or a UE-A. The second UE may be a vehicle UE and/or a V2X UE.

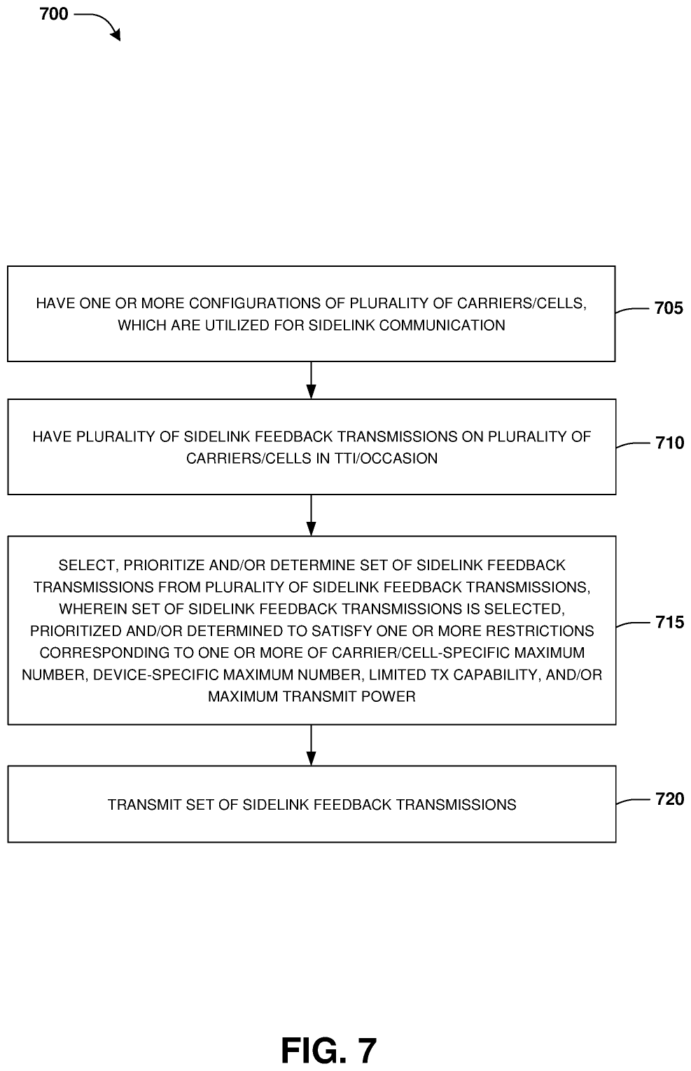

FIG. 7 is a flow chart 700 according to one exemplary embodiment from the perspective of a first device. In step 705, the first device has one or more configurations (e.g., pre-configurations) of a plurality of carriers/cells, which may be utilized for sidelink communication. In step 710, the first device has a plurality of (scheduled and/or requested) sidelink feedback transmissions on the plurality of carriers/cells in a TTI/occasion. In step 715, the first device selects, prioritizes and/or determines a set of sidelink feedback transmissions from the plurality of (scheduled and/or requested) sidelink feedback transmissions, wherein the set of sidelink feedback transmissions is selected, prioritized and/or determined to satisfy one or more restrictions corresponding to one or more of a carrier/cell-specific maximum number, a device-specific maximum number, a limited TX capability, and/or a maximum transmit power. In step 720, the first device transmits the set of sidelink feedback transmissions.

Referring back to FIGS. 3 and 4, in one exemplary embodiment of a first device, the device 300 includes a program code 312 stored in the memory 310. The CPU 308 may execute program code 312 to enable first device (i) to have one or more configurations (e.g., pre-configurations) of a plurality of carriers/cells, which are utilized for sidelink communication, (ii) to have a plurality of (scheduled and/or requested) sidelink feedback transmissions on the plurality of carriers/cells in a TTI/occasion, (iii) to select, prioritize and/or determine a set of sidelink feedback transmissions from the plurality of (scheduled and/or requested) sidelink feedback transmissions, wherein the set of sidelink feedback transmissions is selected, prioritized and/or determined to satisfy one or more restrictions corresponding to one or more of a carrier/cell-specific maximum number, a device-specific maximum number, a limited TX capability, and/or a maximum transmit power, and (iv) to transmit the set of sidelink feedback transmissions. Furthermore, the CPU 308 can execute the program code 312 to perform one, some and/or all of the above-described actions and steps and/or others described herein.

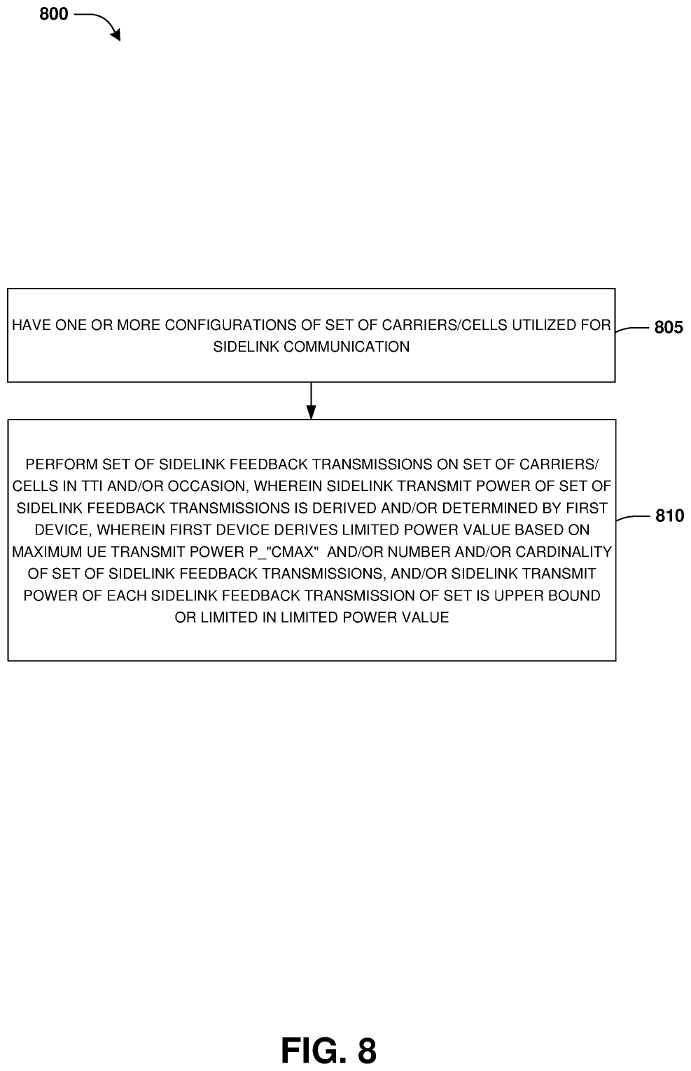

FIG. 8 is a flow chart 800 according to one exemplary embodiment from the perspective of a first device. In step 805, the first device has one or more configurations (e.g., pre-configurations) of a set of carriers/cells, which may be utilized for sidelink communication. In step 810, the first device performs a set of sidelink feedback transmissions on the set of carriers/cells in a TTI and/or occasion, wherein sidelink transmit power of the set of sidelink feedback transmissions may be derived and/or determined by the first device. The first device may derive a (UE-specific, for example) limited power value based on a maximum UE transmit power P_“CMAX” and/or a number and/or cardinality of the set of sidelink feedback transmissions, and/or the sidelink transmit power of each sidelink feedback transmission of the set may upper bound or limited in the (UE-specific, for example) limited power value.

Referring back to FIGS. 3 and 4, in one exemplary embodiment of a first device, the device 300 includes a program code 312 stored in the memory 310. The CPU 308 may execute program code 312 to enable the first device (i) to have one or more configurations (e.g., pre-configurations) of a set of carriers/cells, which may be utilized for sidelink communication, and (ii) to perform a set of sidelink feedback transmissions on the set of carriers/cells in a TTI and/or occasion, wherein a sidelink transmit power of the set of sidelink feedback transmissions may be derived and/or determined by the first device. The first device may derive a (UE-specific, for example) limited power value based on a maximum UE transmit power P_“CMAX” and/or a number and/or cardinality of the set of sidelink feedback transmissions, and/or the sidelink transmit power of each sidelink feedback transmission of the set may be upper bound or limited in the (UE-specific, for example) limited power value. Furthermore, the CPU 308 can execute the program code 312 to perform one, some and/or all of the above-described actions and steps and/or others described herein.

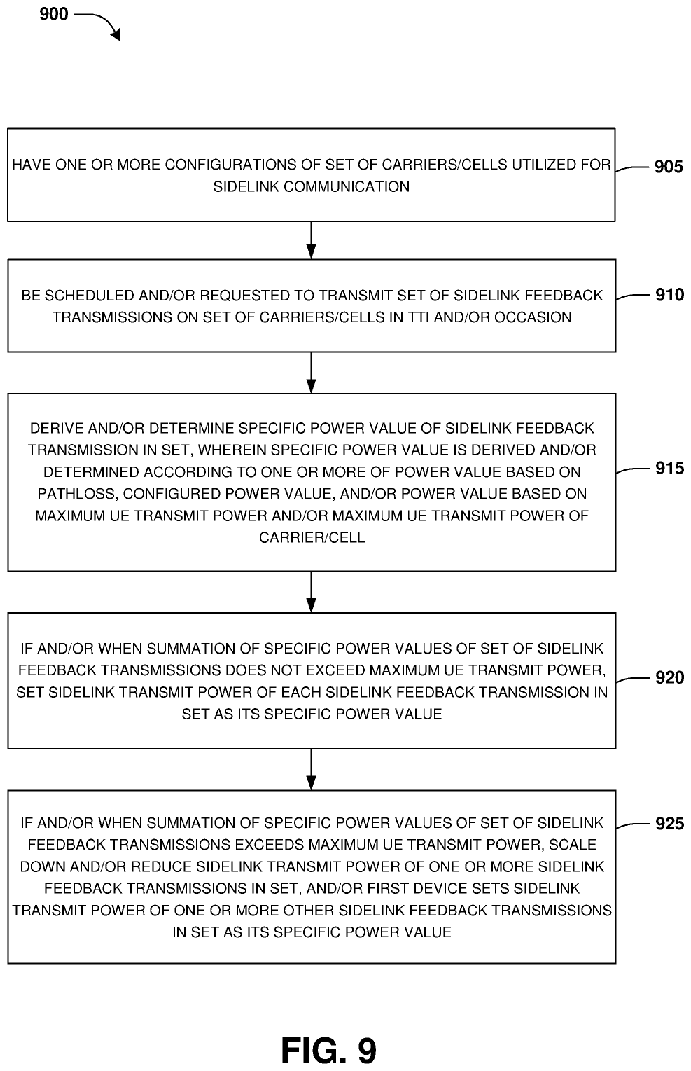

FIG. 9 is a flow chart 900 according to one exemplary embodiment from the perspective of a first device. In step 905, the first device has one or more configurations (e.g., pre-configurations) of a set of carriers/cells, which may be utilized for sidelink communication. In step 910, the first device is scheduled and/or requested to transmit a set of sidelink feedback transmissions on the set of carriers/cells in a TTI and/or occasion. In step 915, the first device derives and/or determines a specific power value of a sidelink feedback transmission in the set, wherein the specific power value may be derived and/or determined according to one or more of a power value based on pathloss, a configured (guarantee, for example) power value, and/or a power value based on a maximum UE transmit power and/or a maximum UE transmit power of a carrier/cell. In step 920, if and/or when summation of one or more specific power values of the set of sidelink feedback transmissions does not exceed a maximum UE transmit power, the first device sets a sidelink transmit power of each sidelink feedback transmission in the set as its specific power value. In step 925, if and/or when summation of one or more specific power values of the set of sidelink feedback transmissions exceed a maximum UE transmit power, the first device scales down and/or reduces a sidelink transmit power of one or more (e.g., but not all) sidelink feedback transmissions in the set, and/or the first device sets a sidelink transmit power of one or more other sidelink feedback transmissions in the set as its specific power value.

Referring back to FIGS. 3 and 4, in one exemplary embodiment of a first device, the device 300 includes a program code 312 stored in the memory 310. The CPU 308 may execute program code 312 to enable a first device (i) to have one or more configurations (e.g., pre-configurations) of a set of carriers/cells, which may be utilized for sidelink communication, (ii) to be scheduled and/or requested to transmit a set of sidelink feedback transmissions on the set of carriers/cells in a TTI and/or occasion, (iii) to derive and/or determine a specific power value of a sidelink feedback transmission in the set, wherein the specific power value may be derived and/or determined according to one or more of a power value based on pathloss, a configured (guarantee, for example) power value, and/or a power value based on a maximum UE transmit power and/or a maximum UE transmit power of a carrier/cell, (iv) if and/or when summation of specific power values of the set of sidelink feedback transmissions does not exceed a maximum UE transmit power, to set a sidelink transmit power of each sidelink feedback transmission in the set as its specific power value, and (v) if and/or when summation of specific power values of the set of sidelink feedback transmissions exceeds a maximum UE transmit power, to scale down and/or reduce sidelink transmit power of one or more (e.g., but not all) sidelink feedback transmissions in the set, and/or the first device may set a sidelink transmit power of one or more other sidelink feedback transmissions in the set as its specific power value. Furthermore, the CPU 308 can execute the program code 312 to perform one, some and/or all of the above-described actions and steps and/or others described herein.

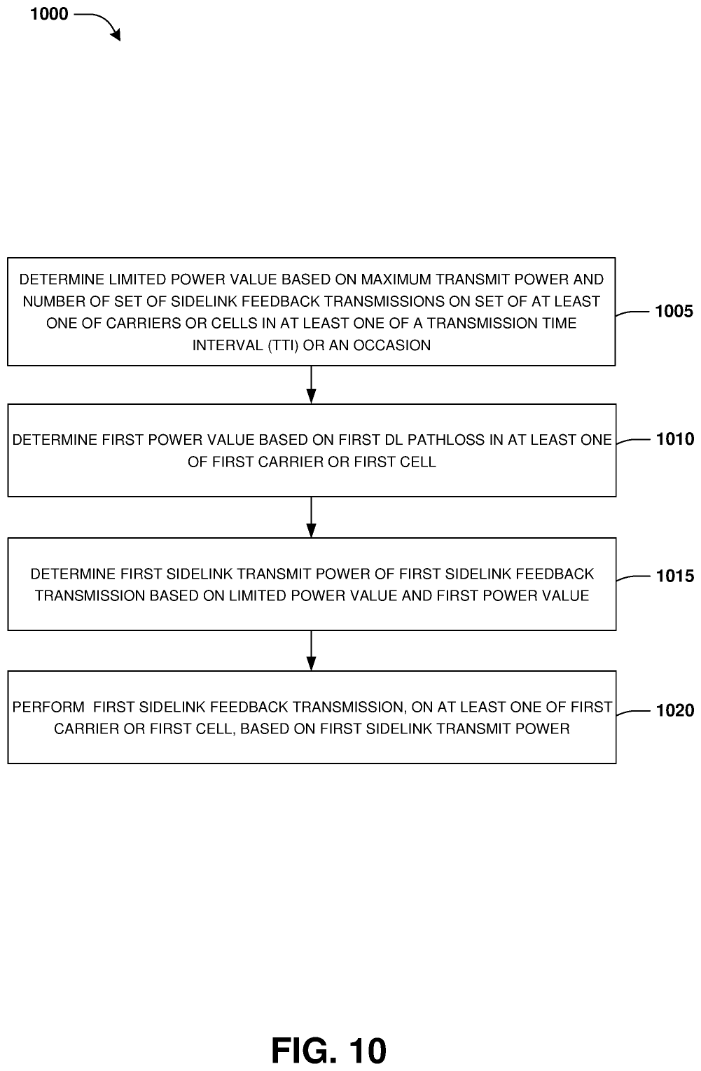

FIG. 10 is a flow chart 1000 according to one exemplary embodiment from the perspective of a device configured with a set of carriers and/or cells (e.g., the device has one or more configurations of the set of carriers and/or cells) comprising a first carrier and/or a first cell. The set of carriers and/or cells may be utilized for sidelink communication, for example. In step 1005, the device determines a limited power value based on a maximum transmit power and a number (e.g., a cardinality) of a set of sidelink feedback transmissions on the set of carriers and/or cells in a transmission time interval (TTI) and/or an occasion. In step 1010, the device determines a first power value based on a first downlink (DL) pathloss in the first carrier and/or the first cell. In step 1015, the device determines a first sidelink transmit power of a first sidelink feedback transmission based on the limited power value and the first power value (and/or based on other information in addition to the limited power value and the first power value). The first sidelink feedback transmission may be among the set of sidelink feedback transmissions. In step 1020, the device performs the first sidelink feedback transmission, on the first carrier and/or the first cell, based on the first sidelink transmit power. The first sidelink feedback transmission may be one of the set of sidelink feedback transmissions that the device performs on the set of carriers and/or cells in the TTI and/or the occasion, for example.

In one embodiment, the first sidelink transmit power is determined based on a limit (e.g., an upper limit and/or an upper bound) corresponding to the limited power value. For example, the first sidelink transmit power may be upper bound and/or otherwise limited by the limited power value such that the first sidelink transmit power is determined based on a determination that the first sidelink transmit power does not exceed the limited power value. In one embodiment, a sidelink transmit power of each sidelink feedback transmission of the set of sidelink feedback transmissions is determined based on a limit (e.g., an upper limit and/or an upper bound) corresponding to the limited power value. For example, each sidelink transmit power of each sidelink feedback transmission of the set of sidelink feedback transmissions may be upper bound and/or otherwise limited by the limited power value such that each sidelink transmit power is determined based on a determination that each sidelink transmit power does not exceed the limited power value.

In one embodiment, the first sidelink transmit power is determined based on a smaller value among values comprising the limited power value and the first power value (and/or one of more other values). For example, the first sidelink transmit power may be determined as being a minimum and/or smallest value among one or more values comprising the limited power value and/or the first power value. In one embodiment, the limited power value is determined based on an average of one or more power values associated with the set of sidelink feedback transmissions. For example, the limited power value may be determined as an average power value based on a maximum power value (e.g., associated with the maximum transmit power). For example, the limited power value may be determined as an average power value, from the maximum power value, for the set of sidelink feedback transmissions. In one embodiment, the limited power value is determined based on a value (e.g., the maximum power value) of the maximum transmit power and/or the number (e.g., the cardinality) of the set of sidelink feedback transmissions. In one embodiment, the limited power value is determined based on the value (e.g., the maximum power value) of the maximum transmit power divided by the number (e.g., the cardinality) of the set of sidelink feedback transmissions. In one embodiment, the limited power value (e.g., the limited power value in unit of dBm) is determined based on the maximum transmit power (e.g., the maximum transmit power in unit of dBm) minus 10 log_10 (the number (e.g., the cardinality) of the set of sidelink feedback transmissions), where the log_10 means base-10 Logarithm. In one embodiment, the maximum transmit power may correspond to a device-specific maximum transmit power (e.g., specific to the device). For example, the specific device (and/or specific device type) may be associated with the maximum transmit power, while a second device (and/or second device type) may be associated with a second maximum transmit power.

In one embodiment, the device determines a second power value based on a second DL pathloss in a second carrier and/or a second cell of the set carriers and/or cells. The device determines a second sidelink transmit power of a second sidelink feedback transmission based on the limited power value and the second power value. The second sidelink feedback transmission may be among the set of sidelink feedback transmissions. The device performs the second sidelink feedback transmission, on the second carrier and/or the second cell, based on the second sidelink transmit power.

In one embodiment, the second sidelink transmit power is determined based on a smaller value among values comprising the limited power value and the second power value (and/or one of more other values). For example, the second sidelink transmit power may be determined as being a minimum and/or smallest value among one or more values comprising the limited power value and/or the second power value.

In one embodiment, the device is configured with a plurality of carriers and/or cells (e.g., the device has one or more configurations of the plurality of carriers and/or cells) comprising the set of carriers and/or cells. The plurality of carriers and/or cells may be utilized for sidelink communication, for example. In one embodiment, the device has a plurality of sidelink feedback transmissions on the plurality of carriers and/or cells in the transmission time interval (TTI) and/or the occasion. In one embodiment, the device determines the set of sidelink feedback transmissions from among the plurality of sidelink feedback transmissions. The device may perform the set of sidelink feedback transmissions on the set of carriers and/or cells in the TTI and/or the occasion.

In one embodiment, the device determines the set of sidelink feedback transmissions based on the number (e.g., the cardinality) of the set of sidelink feedback transmissions being smaller than or equal to a maximum number. For example, the device may determine and/or select the set of sidelink feedback transmissions from among the plurality of sidelink feedback transmissions based on a determination that the number (e.g., the cardinality) of the set of sidelink feedback transmissions is smaller than or equal to the maximum number. In one embodiment, the device determines the set of sidelink feedback transmissions based on a second number of sidelink feedback transmissions in each carrier and/or each cell being smaller than or equal to a second maximum number. For example, the device may determine and/or select the set of sidelink feedback transmissions from among the plurality of sidelink feedback transmissions based on a determination that a number (e.g., a cardinality) of determined one or more sidelink feedback transmissions in each carrier and/or each cell is smaller than or equal to a carrier-specific and/or cell-specific maximum number. Different carriers and/or cells may be associated with the same or different carrier-specific maximum numbers or cell-specific maximum numbers.

Referring back to FIGS. 3 and 4, in one exemplary embodiment of a device configured with a set of carriers and/or cells comprising a first carrier and/or a first cell, the device 300 includes a program code 312 stored in the memory 310. The CPU 308 may execute program code 312 to enable a device (i) to determine a limited power value based on a maximum transmit power and a number of a set of sidelink feedback transmissions on the set of carriers and/or cells in a transmission time interval (TTI) and/or an occasion, (ii) to determine a first power value based on a first downlink (DL) pathloss in the first carrier and/or the first cell, (iii) to determine a first sidelink transmit power of a first sidelink feedback transmission based on the limited power value and the first power value, wherein the set of sidelink feedback transmissions comprises the first sidelink feedback transmission, and (iv) to perform the first sidelink feedback transmission, on the first carrier and/or the first cell, based on the first sidelink transmit power. Furthermore, the CPU 308 can execute the program code 312 to perform one, some and/or all of the above-described actions and steps and/or others described herein.

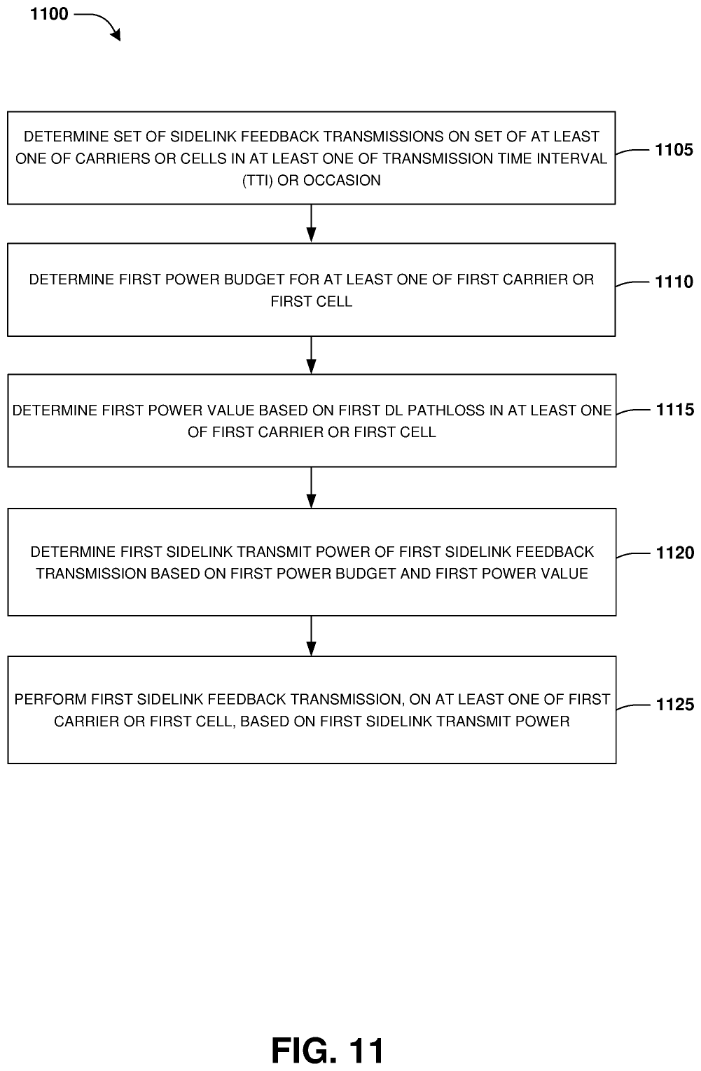

FIG. 11 is a flow chart 1100 according to one exemplary embodiment from the perspective of a device configured with a set of carriers and/or cells (e.g., the device has one or more configurations of the set of carriers and/or cells) comprising a first carrier and/or a first cell. The set of carriers and/or cells may be utilized for sidelink communication, for example. In step 1105, the device determines a set of sidelink feedback transmissions on the set of carriers and/or cells in a transmission time interval (TTI) and/or an occasion. In step 1110, the device determines a first power budget for the first carrier and/or the first cell. The first power budget may be specific to the first carrier and/or the first cell, and/or a second power budget may be specific to a second carrier and/or a second cell. In step 1115, the device determines a first power value based on a first downlink (DL) pathloss in the first carrier and/or the first cell. In step 1120, the device determines a first sidelink transmit power of a first sidelink feedback transmission based on the first power budget and the first power value (and/or based on other information in addition to the first power budget and the first power value). The first sidelink feedback transmission may be among the set of sidelink feedback transmissions. In step 1125, the device performs the first sidelink feedback transmission, on the first carrier and/or the first cell, based on the first sidelink transmit power. The first sidelink feedback transmission may be one of a set of sidelink feedback transmissions that the device performs on the set of carriers and/or cells in the TTI and/or the occasion, for example.

In one embodiment, a first set of sidelink feedback transmissions, on the first carrier and/or the first cell, comprises the first sidelink feedback transmission. The set of sidelink feedback transmissions may comprise the first set of sidelink feedback transmissions, for example. In one embodiment, the device determines a first limited power value based on the first power budget and a number (e.g., a cardinality) of the first set of sidelink feedback transmissions on the first carrier and/or the first cell. In one embodiment, the device determines the first sidelink transmit power based on the first limited power value and the first power value (and/or based on other information in addition to the first limited power value and the first power value). In one embodiment, the first power budget is determined based on a limit (e.g., an upper limit and/or an upper bound) corresponding to a first carrier-specific maximum transmit power and/or a first cell-specific maximum transmit power. For example, the first power budget may be upper bound and/or otherwise limited by the first carrier-specific maximum transmit power and/or the first cell-specific maximum transmit power such that the first power budget is determined based on a determination that the first power budget does not exceed the first carrier-specific maximum transmit power and/or the first cell-specific maximum transmit power. The first carrier-specific maximum transmit power and/or the first cell-specific maximum transmit power may be specific to the first carrier and/or the first cell, and/or a second carrier-specific maximum transmit power and/or a second cell-specific maximum transmit power may be specific to the second carrier and/or the second cell.

In one embodiment, the first sidelink transmit power is determined based on a limit (e.g., an upper limit and/or an upper bound) corresponding to the first limited power value. For example, the first sidelink transmit power may be upper bound and/or otherwise limited by the first limited power value such that the first sidelink transmit power is determined based on a determination that the first sidelink transmit power does not exceed the first limited power value. In one embodiment, summation of sidelink transmit powers of the first set of sidelink feedback transmissions is determined based on a limit (e.g., an upper limit and/or an upper bound) corresponding to the first power budget. For example, the summation of the sidelink transmit powers of the first set of sidelink feedback transmissions may be upper bound and/or otherwise limited by the first power budget such that the summation of the sidelink transmit powers of the first set of sidelink feedback transmissions is determined based on a determination that the summation of the sidelink transmit powers of the first set of sidelink feedback transmissions does not exceed the first power budget. The first power budget may be specific to the first carrier and/or the first cell. In one embodiment, summation of sidelink transmit powers of the first set of sidelink feedback transmissions is determined based on a limit (e.g., an upper limit or an upper bound) corresponding to the first carrier-specific maximum transmit power and/or the first cell-specific maximum transmit power. For example, the summation of the sidelink transmit powers of the first set of sidelink feedback transmissions may be upper bound and/or otherwise limited by the first carrier-specific maximum transmit power and/or the first cell-specific maximum transmit power such that the summation of the sidelink transmit powers of the first set of sidelink feedback transmissions is determined based on a determination that the summation of the sidelink transmit powers of the first set of sidelink feedback transmissions does not exceed the first carrier-specific maximum transmit power and/or the first cell-specific maximum transmit power. The first carrier-specific maximum transmit power and/or the first cell-specific maximum transmit power may be specific to the first carrier and/or the first cell.

In one embodiment, the first sidelink transmit power is determined based on a smaller value among values comprising the first limited power value and the first power value (and/or one of more other values). For example, the first sidelink transmit power may be determined as being a minimum and/or smallest value among one or more values comprising the first limited power value and/or the first power value. In one embodiment, the first limited power value is determined as an average power value, from the first power budget, for the first set of sidelink feedback transmissions. For example, the first limited power value may be determined based on an average of one or more power values associated with the first set of sidelink feedback transmissions. In one embodiment, the first limited power value is determined based on a value of the first power budget and/or the number (e.g., the cardinality) of the first set of sidelink feedback transmissions. In one embodiment, the first limited power value is determined based on the value of the first power budget divided by the number (e.g., the cardinality) of the first set of sidelink feedback transmissions. In one embodiment, the first limited power value (e.g., the first limited power value in unit of dBm) is determined based on the first power budget (e.g., the first power budget in unit of dBm) minus 10 log_10 (the number (e.g., the cardinality) of the first set of sidelink feedback transmissions), where the log_10 means base-10 Logarithm.

In one embodiment, the device determines a second power budget for a second carrier and/or a second cell of the set of carriers and/or cells. The device determines a second power value based on a second DL pathloss in the second carrier and/or the second cell. The device determines a second sidelink transmit power of a second sidelink feedback transmission based on the second power budget and the second power value (and/or based on other information in addition to the second power budget and the second power value). The second sidelink feedback transmission may be among the set of sidelink feedback transmissions. The device performs the second sidelink feedback transmission, on the second carrier and/or the second cell, based on the second sidelink transmit power. In one embodiment, the second power budget is determined based on a limit (e.g., an upper limit and/or an upper bound) corresponding to the second carrier-specific maximum transmit power and/or the second cell-specific maximum transmit power. For example, the second power budget may be upper bound and/or otherwise limited by the second carrier-specific maximum transmit power and/or the second cell-specific maximum transmit power such that the second power budget is determined based on a determination that the second power budget does not exceed the second carrier-specific maximum transmit power and/or the second cell-specific maximum transmit power. The second carrier-specific maximum transmit power and/or the second cell-specific maximum transmit power may be specific to the second carrier and/or the second cell.

In one embodiment, a second set of sidelink feedback transmissions, on the second carrier and/or the second cell, comprises the second sidelink feedback transmission. The second set of sidelink feedback transmissions may be among the set of sidelink feedback transmissions, for example. In one embodiment, the device determines a second limited power value based on the second power budget and a number (e.g., a cardinality) of the second set of sidelink feedback transmissions on the second carrier and/or the second cell. In one embodiment, the device determines the second sidelink transmit power based on the second limited power value and the second power value (and/or based on other information in addition to the second limited power value and the second power value). For example, the device may perform the second sidelink feedback transmission, on the second carrier and/or the second cell, based on the second sidelink transmit power.

In one embodiment, the second sidelink transmit power is determined based on a limit (e.g., an upper limit and/or an upper bound) corresponding to the second limited power value. For example, the second sidelink transmit power may be upper bound and/or otherwise limited by the second limited power value such that the second sidelink transmit power is determined based on a determination that the second sidelink transmit power does not exceed the second limited power value. In one embodiment, summation of sidelink transmit powers of the second set of sidelink feedback transmissions is determined based on a limit (e.g., an upper limit and/or an upper bound) corresponding to the second power budget. For example, the summation of the sidelink transmit powers of the second set of sidelink feedback transmissions may be upper bound and/or otherwise limited by the second power budget such that the summation of the sidelink transmit powers of the second set of sidelink feedback transmissions is determined based on a determination that the summation of the sidelink transmit powers of the second set of sidelink feedback transmissions does not exceed the second power budget. The second power budget may be specific to the second carrier and/or the second cell. In one embodiment, summation of sidelink transmit powers of the second set of sidelink feedback transmissions is determined based on a limit (e.g., an upper limit and/or an upper bound) corresponding to the second carrier-specific maximum transmit power and/or the second cell-specific maximum transmit power. For example, the summation of the sidelink transmit powers of the second set of sidelink feedback transmissions may be upper bound and/or otherwise limited by the second carrier-specific maximum transmit power and/or the second cell-specific maximum transmit power such that the summation of the sidelink transmit powers of the second set of sidelink feedback transmissions is determined based on a determination that the summation of the sidelink transmit powers of the second set of sidelink feedback transmissions does not exceed the second carrier-specific maximum transmit power and/or the second cell-specific maximum transmit power. The second carrier-specific maximum transmit power and/or the second cell-specific maximum transmit power may be specific to the second carrier and/or the second cell.

In one embodiment, the second sidelink transmit power is determined based on a smaller value among values comprising the second limited power value and the second power value (and/or one or more other values). For example, the second sidelink transmit power may be determined as being a minimum and/or smallest value among one or more values comprising the second limited power value and/or the second power value. In one embodiment, the second limited power value is determined as an average power value, from the second power budget, for the second set of sidelink feedback transmissions. For example, the second limited power value may be determined based on an average of one or more power values associated with the second set of sidelink feedback transmissions. In one embodiment, the second limited power value is determined based on a value of the second power budget and the number (e.g., the cardinality) of the second set of sidelink feedback transmissions. In one embodiment, the second limited power value is determined based on the value of the second power budget divided by the number (e.g., the cardinality) of the second set of sidelink feedback transmissions. In one embodiment, the second limited power value (e.g., the second limited power value in unit of dBm) is determined based on X-10 log_10 (Y), wherein X corresponds to the second power budget (e.g., the second power budget in unit of dBm) and Y corresponds to the number (e.g., the cardinality) of the second set of sidelink feedback transmissions, where the log_10 means base-10 Logarithm.

In one embodiment, the first power budget is determined based on a first ratio of the first carrier and/or the first cell and a maximum transmit power. The first ratio may be specific to the first carrier and/or the first cell. In one embodiment, a power budget of each carrier and/or each cell, of the set of carriers and/or cells, is determined based on the maximum transmit power and an associated ratio of the carrier and/or the cell. Each associated ratio may be specific to the corresponding carrier and/or the corresponding cell, such that a second ratio may be specific to the second carrier and/or the second cell, for example. Each power budget may be specific to the corresponding carrier and/or the corresponding cell. In one embodiment, summation of power budgets of the set of carriers and/or cells is less than or equal to the maximum transmit power. For example, the summation of the power budgets of the set of sidelink feedback transmissions may be upper bound and/or otherwise limited by the maximum transmit power such that the summation of the power budgets of the set of sidelink feedback transmissions is determined based on a determination that the summation of the power budgets of the set of sidelink feedback transmissions does not exceed the maximum transmit power. In one embodiment, the maximum transmit power may correspond to a device-specific maximum transmit power (e.g., specific to the device). For example, the specific device (and/or specific device type) may be associated with the maximum transmit power, while a second device (and/or second device type) may be associated with a second maximum transmit power.

In one embodiment, a corresponding ratio of each carrier or each cell, of the set of carriers and/or cells, is configured and/or determined based on a distribution of the set of carriers and/or cells and/or a distribution of the set of sidelink feedback transmissions. Each corresponding ratio may be specific to the corresponding carrier and/or the corresponding cell. In one embodiment, a corresponding power budget of each carrier and/or each cell, of the set of carriers and/or cells, is configured and/or determined based on the distribution of the set of carriers and/or cells and/or the distribution of the set of sidelink feedback transmissions. Each corresponding power budget may be specific to the corresponding carrier and/or the corresponding cell.

In one embodiment, the device is configured with a plurality of carriers and/or cells (e.g., the device has one or more configurations of the plurality of carriers and/or cells) comprising the set of carriers and/or cells. The plurality of carriers and/or cells may be utilized for sidelink communication, for example. In one embodiment, the device has a plurality of sidelink feedback transmissions on the plurality of carriers and/or cells in the transmission time interval (TTI) and/or the occasion. In one embodiment, the device determines the set of sidelink feedback transmissions from among the plurality of sidelink feedback transmissions. The device may perform the set of sidelink feedback transmissions on the set of carriers and/or cells in the TTI and/or the occasion.

In one embodiment, the device determines the set of sidelink feedback transmissions based on a number (e.g., a cardinality) of the set of sidelink feedback transmissions being smaller than or equal to a maximum number. For example, the device may determine and/or select the set of sidelink feedback transmissions from among the plurality of sidelink feedback transmissions based on a determination that the number (e.g., the cardinality) of the set of sidelink feedback transmissions is smaller than or equal to the maximum number. In one embodiment, the device determines the set of sidelink feedback transmissions based on a second number (e.g., cardinality) of sidelink feedback transmissions in each carrier and/or each cell being smaller than or equal to a second maximum number. For example, the device may determine and/or select the set of sidelink feedback transmissions from among the plurality of sidelink feedback transmissions based on a determination that a number (e.g., cardinality) of determined one or more sidelink feedback transmissions in each carrier and/or each cell is smaller than or equal to a carrier-specific and/or cell-specific maximum number. Different carriers and/or cells may be associated with the same or different carrier-specific maximum numbers or cell-specific maximum numbers.

Referring back to FIGS. 3 and 4, in one exemplary embodiment of a device configured with a set of carriers and/or cells comprising a first carrier and/or a first cell, the device 300 includes a program code 312 stored in the memory 310. The CPU 308 may execute program code 312 to enable a device (i) to determine a set of sidelink feedback transmissions on the set of carriers and/or cells in a transmission time interval (TTI) or an occasion, (ii) to determine a first power budget for the first carrier and/or the first cell, (iii) to determine a first power value based on a first downlink (DL) pathloss in the first carrier and/or the first cell, (iv) to determine a first sidelink transmit power of a first sidelink feedback transmission based on the first power budget and the first power value, wherein the set of sidelink feedback transmissions comprises the first sidelink feedback transmission, and (v) to perform the first sidelink feedback transmission, on the first carrier and/or the first cell, based on the first sidelink transmit power. Furthermore, the CPU 308 can execute the program code 312 to perform one, some and/or all of the above-described actions and steps and/or others described herein.

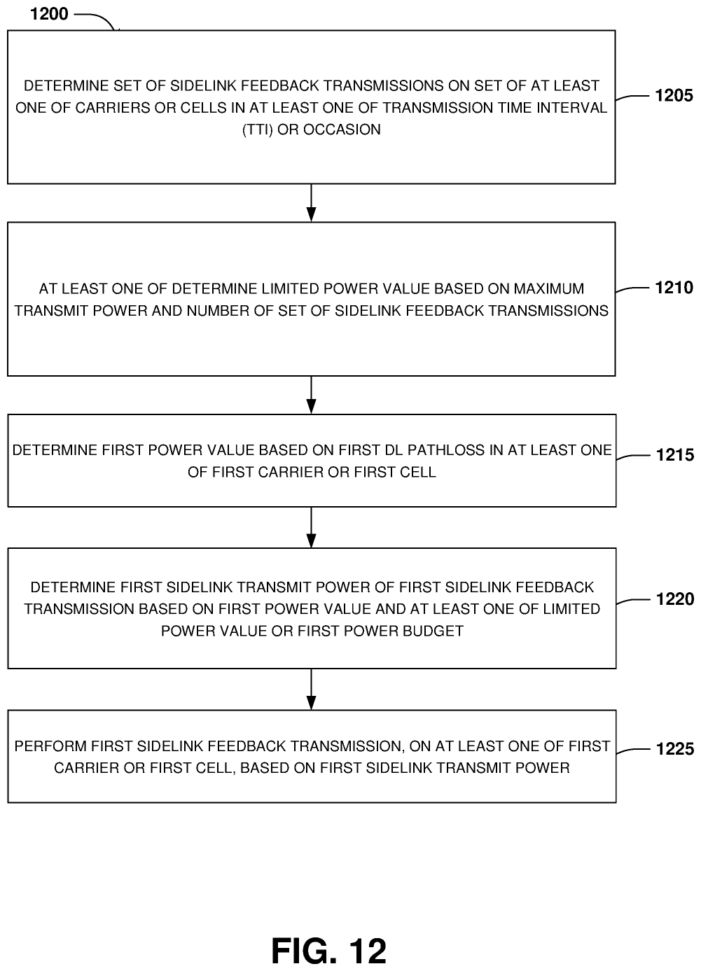

FIG. 12 is a flow chart 1200 according to one exemplary embodiment from the perspective of a device configured with a set of carriers and/or cells (e.g., the device has one or more configurations of the set of carriers and/or cells) comprising a first carrier and/or a first cell. The set of carriers and/or cells may be utilized for sidelink communication, for example. In step 1205, the device determines a set of sidelink feedback transmissions on the set of carriers and/or cells in a transmission time interval (TTI) and/or an occasion. In step 1210, the device determines a limited power value based on a maximum transmit power and a number (e.g., a cardinality) of the set of sidelink feedback transmissions, and/or determines a first power budget for the first carrier and/or the first cell. The first power budget may be specific to the first carrier and/or the first cell, and/or a second power budget may be specific to a second carrier and/or a second cell. In step 1215, the device determines a first power value based on a first downlink (DL) pathloss in the first carrier and/or the first cell. In step 1220, the device determines a first sidelink transmit power of a first sidelink feedback transmission based on the first power value and the limited power value and/or the first power budget (and/or based on other information in addition to the first power value and the limited power value and/or the first power budget). The first sidelink feedback transmission may be among the set of sidelink feedback transmissions. In step 1225, the device performs the first sidelink feedback transmission, on the first carrier and/or the first cell, based on the first sidelink transmit power. The first sidelink feedback transmission may be one of the set of sidelink feedback transmissions that the device performs on the set of carriers and/or cells in the TTI and/or the occasion, for example.

Referring back to FIGS. 3 and 4, in one exemplary embodiment of a device configured with a set of carriers and/or cells comprising a first carrier and/or a first cell, the device 300 includes a program code 312 stored in the memory 310. The CPU 308 may execute program code 312 to enable a device (i) to determine a set of sidelink feedback transmissions on the set of carriers and/or cells in a transmission time interval (TTI) or an occasion, (ii) to determine a limited power value based on a maximum transmit power and a number of the set of sidelink feedback transmissions, and/or to determine a first power budget for the first carrier and/or the first cell, (iii) to determine a first power value based on a first downlink (DL) pathloss in the first carrier and/or the first cell, (iv) to determine a first sidelink transmit power of a first sidelink feedback transmission based on at least the first power value and the limited power value and/or the first power budget, wherein the set of sidelink feedback transmissions comprises the first sidelink feedback transmission, and (v) to perform the first sidelink feedback transmission, on the first carrier and/or the first cell, based on the first sidelink transmit power. Furthermore, the CPU 308 can execute the program code 312 to perform one, some and/or all of the above-described actions and steps and/or others described herein.

A communication device (e.g., a UE, a base station, a network node, etc.) may be provided, wherein the communication device may comprise a control circuit, a processor installed in the control circuit and/or a memory installed in the control circuit and coupled to the processor. The processor may be configured to execute a program code stored in the memory to perform method steps illustrated in FIGS. 7-12. Furthermore, the processor may execute the program code to perform one, some and/or all of the above-described actions and steps and/or others described herein.

A computer-readable medium may be provided. The computer-readable medium may be a non-transitory computer-readable medium. The computer-readable medium may comprise a flash memory device, a hard disk drive, a disc (e.g., a magnetic disc and/or an optical disc, such as at least one of a digital versatile disc (DVD), a compact disc (CD), etc.), and/or a memory semiconductor, such as at least one of static random access memory (SRAM), dynamic random access memory (DRAM), synchronous dynamic random access memory (SDRAM), etc. The computer-readable medium may comprise processor-executable instructions, that when executed cause performance of one, some and/or all method steps illustrated in FIGS. 7-12, and/or one, some and/or all of the above-described actions and steps and/or others described herein.

It may be appreciated that applying one or more of the techniques presented herein may result in one or more benefits including, but not limited to, increased efficiency of communication between devices (e.g., UEs). The increased efficiency may be a result of enabling a device to handle prioritization, selection, and transmit power setting for sidelink feedback transmissions on a plurality of carriers/cells while satisfying one or more corresponding Quality of Service (QoS) requirements and/or restrictions on maximum transmit power and/or TX capability.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based on design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Alternatively and/or additionally, in some aspects any suitable computer-program product may comprise a computer-readable medium comprising codes relating to one or more of the aspects of the disclosure. In some aspects a computer program product may comprise packaging materials.

While the disclosed subject matter has been described in connection with various aspects, it will be understood that the disclosed subject matter is capable of further modifications. This application is intended to cover any variations, uses or adaptation of the disclosed subject matter following, in general, the principles of the disclosed subject matter, and including such departures from the present disclosure as come within the known and customary practice within the art to which the disclosed subject matter pertains.

1. A method of a device configured with a set of at least one of carriers or cells comprising at least one of a first carrier or a first cell, the method comprising:
determining a limited power value based on a maximum transmit power and a number of a set of sidelink feedback transmissions on the set of at least one of carriers or cells in at least one of a transmission time interval (TTI) or an occasion;
determining a first power value based on a first downlink (DL) pathloss in at least one of the first carrier or the first cell;
determining a first sidelink transmit power of a first sidelink feedback transmission based on the limited power value and the first power value, wherein the set of sidelink feedback transmissions comprises the first sidelink feedback transmission; and
performing the first sidelink feedback transmission, on at least one of the first carrier or the first cell, based on the first sidelink transmit power.

2. The method of claim 1, wherein at least one of:
the first sidelink transmit power is determined based on an upper limit corresponding to the limited power value; or
a sidelink transmit power of each sidelink feedback transmission of the set of sidelink feedback transmissions is determined based on an upper limit corresponding to the limited power value.

3. The method of claim 1, wherein at least one of:
the first sidelink transmit power is determined based on a smaller value among values comprising the limited power value and the first power value;
the limited power value is determined based on an average of one or more power values associated with the set of sidelink feedback transmissions;
the limited power value is determined based on a value of the maximum transmit power divided by the number of the set of sidelink feedback transmissions;
the limited power value is determined based on the maximum transmit power minus 10 log_10(the number of the set of sidelink feedback transmissions); or
the maximum transmit power comprises a device-specific maximum transmit power.

4. The method of claim 1, comprising:
determining a second power value based on a second DL pathloss in at least one of a second carrier or a second cell of the set of at least one of carriers or cells;
determining a second sidelink transmit power of a second sidelink feedback transmission based on the limited power value and the second power value, wherein the set of sidelink feedback transmissions comprises the second sidelink feedback transmission; and
performing the second sidelink feedback transmission, on at least one of the second carrier or the second cell, based on the second sidelink transmit power.

5. The method of claim 4, wherein:
the second sidelink transmit power is determined based on a smaller value among values comprising the limited power value and the second power value.

6. The method of claim 1, wherein at least one of:
the device is configured with a plurality of at least one of carriers or cells comprising the set of at least one of carriers or cells;
the device has a plurality of sidelink feedback transmissions on the plurality of at least one of carriers or cells in at least one of the TTI or the occasion, and the device determines the set of sidelink feedback transmissions from among the plurality of sidelink feedback transmissions; or
the device performs the set of sidelink feedback transmissions on the set of at least one of carriers or cells in at least one of the TTI or the occasion.

7. The method of claim 6, wherein at least one of:
the device determines the set of sidelink feedback transmissions based on the number of the set of sidelink feedback transmissions being smaller than or equal to a maximum number; or
the device determines the set of sidelink feedback transmissions based on a second number of sidelink feedback transmissions in at least one of each carrier or each cell being smaller than or equal to a second maximum number, wherein the second maximum number is at least one of carrier-specific or cell-specific.

8. A method of a device configured with a set of at least one of carriers or cells comprising at least one of a first carrier or a first cell, the method comprising:
determining a set of sidelink feedback transmissions on the set of at least one of carriers or cells in at least one of a transmission time interval (TTI) or an occasion;
determining a first power budget for at least one of the first carrier or the first cell;
determining a first power value based on a first downlink (DL) pathloss in at least one of the first carrier or the first cell;
determining a first sidelink transmit power of a first sidelink feedback transmission based on the first power budget and the first power value, wherein the set of sidelink feedback transmissions comprises the first sidelink feedback transmission; and
performing the first sidelink feedback transmission, on at least one of the first carrier or the first cell, based on the first sidelink transmit power.

9. The method of claim 8, wherein at least one of:
the set of sidelink feedback transmissions comprises a first set of sidelink feedback transmissions on at least one of the first carrier or the first cell;
the first set of sidelink feedback transmissions, on at least one of the first carrier or the first cell, comprises the first sidelink feedback transmission;
the device determines a first limited power value based on the first power budget and a number of the first set of sidelink feedback transmissions on at least one of the first carrier or the first cell;
the device determines the first sidelink transmit power based on the first limited power value and the first power value; or
the first power budget is determined based on an upper limit corresponding to at least one of a first carrier-specific maximum transmit power or a first cell-specific maximum transmit power.

10. The method of claim 9, wherein at least one of:
the first sidelink transmit power is determined based on an upper limit corresponding to the first limited power value;
summation of sidelink transmit powers of the first set of sidelink feedback transmissions is determined based on an upper limit corresponding to the first power budget; or
the summation of the sidelink transmit powers of the first set of sidelink feedback transmissions is determined based on an upper limit corresponding to at least one of the first carrier-specific maximum transmit power or the first cell-specific maximum transmit power.

11. The method of claim 9, wherein at least one of:
the first sidelink transmit power is determined based on a smaller value among values comprising the first limited power value and the first power value;
the first limited power value is determined as an average power value, from the first power budget, for the first set of sidelink feedback transmissions;
the first limited power value is determined based on a value of the first power budget divided by the number of the first set of sidelink feedback transmissions; or
the first limited power value is determined based on the first power budget minus 10 log_10(the number of the first set of sidelink feedback transmissions).

12. The method of claim 8, further comprising:
determining a second power budget for at least one of a second carrier or a second cell of the set of at least one of carriers or cells;
determining a second power value based on a second DL pathloss in at least one of the second carrier or the second cell;
determining a second sidelink transmit power of a second sidelink feedback transmission based on the second power budget and the second power value, wherein the set of sidelink feedback transmissions comprises the second sidelink feedback transmission; and
performing the second sidelink feedback transmission, on at least one of the second carrier or the second cell, based on the second sidelink transmit power.

13. The method of claim 12, wherein at least one of:
the set of sidelink feedback transmissions comprises a second set of sidelink feedback transmissions on at least one of the second carrier or the second cell;
the second set of sidelink feedback transmissions, on at least one of the second carrier or the second cell, comprises the second sidelink feedback transmission;
the device determines a second limited power value based on the second power budget and a number of the second set of sidelink feedback transmissions on at least one of the second carrier or the second cell;
the device determines the second sidelink transmit power based on the second limited power value and the second power value; or
the second power budget is determined based on an upper limit corresponding to at least one of a second carrier-specific maximum transmit power or a second cell-specific maximum transmit power.

14. The method of claim 13, wherein at least one of:
the second sidelink transmit power is determined based on a upper limit corresponding to the second limited power value;
summation of sidelink transmit powers of the second set of sidelink feedback transmissions is determined based on a upper limit corresponding to the second power budget; or
the summation of the sidelink transmit powers of the second set of sidelink feedback transmissions is determined based on a upper limit corresponding to at least one of the second carrier-specific maximum transmit power or the second cell-specific maximum transmit power.

15. The method of claim 13, wherein at least one of:
the second sidelink transmit power is determined based on a smaller value among values comprising the second limited power value and the second power value;
the second limited power value is determined as an average power value, from the second power budget, for the second set of sidelink feedback transmissions;
the second limited power value is determined based on a value of the second power budget divided by the number of the second set of sidelink feedback transmissions; or
the second limited power value is determined based on X−10 log₁₀(Y), wherein X corresponds to the second power budget and Y corresponds to the number of the second set of sidelink feedback transmissions.

16. The method of claim 8, wherein at least one of:
the first power budget is determined based on a first ratio of the at least one of the first carrier or the first cell and a maximum transmit power;
a power budget of each carrier or each cell, of the set of at least one of carriers or cells, is determined based on the maximum transmit power and an associated ratio of at least one of the carrier or the cell;
summation of power budgets of the set of at least one of carriers or cells is less than or equal to the maximum transmit power; or
the maximum transmit power corresponds to a device-specific maximum transmit power.

17. The method of claim 16, wherein at least one of:
a corresponding ratio of each carrier or each cell, of the set of at least one of carriers or cells, is determined based on at least one of a distribution of the set of at least one of carriers or cells or a distribution of the set of sidelink feedback transmissions; or
the power budget of each carrier or each cell, of the set of at least one of carriers or cells, is determined based on at least one of the distribution of the set of at least one of carriers or cells or the distribution of the set of sidelink feedback transmissions.

18. The method of claim 8, wherein at least one of:
the device is configured with a plurality of at least one of carriers or cells comprising the set of at least one of carriers or cells;
the device has a plurality of sidelink feedback transmissions on the plurality of at least one of carriers or cells in at least one of the TTI or the occasion, and the device determines a set of sidelink feedback transmissions from among the plurality of sidelink feedback transmissions; or
the device performs the set of sidelink feedback transmissions on the set of at least one of carriers or cells in at least one of the TTI or the occasion.

19. The method of claim 18, wherein at least one of:
the device determines the set of sidelink feedback transmissions based on a number of the set of sidelink feedback transmissions being smaller than or equal to a maximum number; or
the device determines the set of sidelink feedback transmissions based on a second number of sidelink feedback transmissions in at least one of each carrier or each cell being smaller than or equal to a second maximum number, wherein the second maximum number is at least one of carrier-specific or cell-specific.

20. A device comprising:
a control circuit;
a processor installed in the control circuit; and
a memory installed in the control circuit and coupled to the processor, wherein the processor is configured to execute a program code stored in the memory to perform operations, the operations comprising:
determining a set of sidelink feedback transmissions on a set of at least one of carriers or cells in at least one of a transmission time interval (TTI) or an occasion, wherein the set of at least one of carriers or cells comprises at least one of a first carrier or a first cell;
at least one of:
determining a limited power value based on a maximum transmit power and a number of the set of sidelink feedback transmissions; or
determining a first power budget for at least one of the first carrier or the first cell;
determining a first power value based on a first downlink (DL) pathloss in at least one of the first carrier or the first cell;
determining a first sidelink transmit power of a first sidelink feedback transmission based on the first power value and at least one of the limited power value or the first power budget, wherein the set of sidelink feedback transmissions comprises the first sidelink feedback transmission; and
performing the first sidelink feedback transmission, on at least one of the first carrier or the first cell, based on the first sidelink transmit power.
